(19) United States
(12) Patent Application Publication
(10) Pub. No.: US 2014/0130101 A1
(43) Pub. Date: May 8, 2014

(54) SYSTEM, TELEVISION RECEIVER, INFORMATION TERMINAL, CONTROL METHOD, PROGRAM, AND RECORDING MEDIUM

(71) Applicants: Hitoshi Yoshitani, Osaka-shi (JP); Kenji Komiyama, Osaka-shi (JP); Takatoshi Oishi, Osaka-shi (JP); Tsutomu Takahashi, Osaka-shi (JP); Masahiro Tai, Osaka-shi (JP)

(72) Inventors: Hitoshi Yoshitani, Osaka-shi (JP); Kenji Komiyama, Osaka-shi (JP); Takatoshi Oishi, Osaka-shi (JP); Tsutomu Takahashi, Osaka-shi (JP); Masahiro Tai, Osaka-shi (JP)

(73) Assignee: SHARP KABUSHIKI KAISHA, Osaka-shi, Osaka (JP)

(21) Appl. No.: 14/125,873

(22) PCT Filed: Apr. 4, 2012
(86) PCT No.: PCT/JP2012/059264

§ 371 Date: Jan. 16, 2014

(30) Foreign Application Priority Data
Jun. 14, 2011 (JP) 2011-132651
Mar. 30, 2012 (JP) 2012-081949

(51) Int. Cl. H04N 21/422; H04N 21/482

(52) U.S. Cl. CPC H04N 21/42224; H04N 21/482
USPC 725/52; 725/38

(57) ABSTRACT

The present invention provides a system for remote control of a television with use of an information terminal, wherein the system is easier to use and causes less erroneous operation than the conventional systems. A system (10) includes: a television (1); and a smartphone (2) for operating the television (1). The television (1) provides, with the smartphone (2), a notification of a state of the television (1). The smartphone (2) displays on a touch panel a GUI corresponding to the state having been notified from the television (1).

### TECHNICAL FIELD

The present invention relates to a system for remote control of a television receiver with use of an information terminal.

### BACKGROUND ART

Conventionally, an infrared remote controller has been widely used for remote control of a television receiver (abbreviated as “television” hereinafter). However, due to rapid spread in recent years of information terminals (in particular, mobile information terminals) such as smartphones, attention has focused on television remote control using these information terminals. Particularly, an information terminal equipped with a touch panel enables a person to remotely control a television with the same feeling as remotely controlling a television with use of a familiar infrared remote controller, by displaying a GUI (Graphical User Interface) which looks like an infrared remote controller on the touch panel.

Patent Literature 1 discloses a remote operation device for remotely operating a display device and a recording and reproducing apparatus. Such a remote control device includes a touch panel, on which a GUI specialized for operation of the display device, a GUI specialized for recording operation of the recording and reproducing apparatus, and a GUI specialized for reproduction operation of the recording and reproducing apparatus can be displayed. The remote operation device is configured to switch the GUI to be displayed on the touch panel to another GUI in response to a user operation.

Further, Patent Literature 2 discloses a device control system including a device and a controller for controlling the device. The device control system is configured such that, when any change occurs on the state of the device itself, the device notifies the controller of state information on the device, and the controller receives the state information notified from the device.

Further, Patent Literature 3 discloses displaying, on a bidirectional remote control device, a screen which is similar to an operation screen displayed on a control device. Still further, Non-Patent Literature 1 describes an application for utilizing a smartphone as a remote controller.

### CITATION LIST

### Patent Literatures

### Patent Literature 1

Japanese Patent Application Publication, Tokukai, No. 2009-152836 A (Publication Date: Jul. 9, 2009)

### Patent Literature 2

Japanese Patent Application Publication, Tokukai, No. 2002-215483 A (Publication Date: Aug. 2, 2002)

### Patent Literature 3

Japanese Patent Application Publication, Tokukai, No. 2009-312391 A (Publication Date: Nov. 7, 2000)

### Non-Patent Literature

### Non-Patent Literature 1

‘REVIEW: Change a Windows mobile phone into Wireless Mouse/Keyboard for PC “GRemote”’ [online], Windows Forest, (Searched on Feb. 23, 2012), Internet <http://www.forestimpress.co.jp/article/2008/12/25/gre mote.html>

### SUMMARY OF INVENTION

### Technical Problem

Recent televisions have various kinds of functions. For this reason, in a case where a television is to be remotely operated with use of an information terminal, it is impossible to control all the functions of the television with a single GUI. Hence, there has been a demand for switching a GUI to be displayed on the touch panel to another GUI according to a use scene of the television

Meanwhile, the adoption of the configuration described in Patent Literature 1, i.e. the configuration in which the GUI to be displayed on the touch panel is switched over to another GUI in accordance with a user operation, may cause the problem that a GUI displayed on the touch panel does not suit the state of the television. For example, the event where a GUI specialized for a channel selection operation is displayed on the touch panel of the information terminal can occur even under the circumstances where the television is reproducing a recorded content and accepts no channel selection operation. Such an event confuses the user and increases the risk of an erroneous operation.

Further, the controller described in the technique of Patent Literature 2, in response to a notification of the state information from the device, just displays a state corresponding to the state information on the screen thereof.

The present invention has been attained to solve the problems, and an object of the present invention is to realize a system for remote control of a television with use of an information terminal, wherein the system is easier to use and causes less erroneous operation than the conventional systems.

### Solution to Problem

In order to solve the above problems, a system according to the present invention is a system including: a television receiver; and an information terminal, the television receiver including: state switching means configured to switch a state of the television receiver to another state corresponding to a command having been transmitted from the information terminal; and state notifying means configured to provide, with the information terminal, one of (i) a notification of the state of the television receiver to which state the state switching means has switched over and (ii) an instruction to perform switching of a GUI (Graphical User Interface) to another GUI corresponding to the state of the television receiver to which state the state switching means has switched over, the information terminal including: command transmitting means configured to transmit, to the television receiver, a command corresponding to a user operation performed on the GUI, which is displayed on a touch panel provided in the information terminal; and GUI switching means configured to switch the GUI to be displayed on the touch panel to one of (a) another GUI corresponding to a state of the television receiver which state has been notified from the television receiver and (b) another GUI corresponding to the instruction having been provided by the television receiver.

Further, in order to solve the above problems, a control method according to the present invention is a control method for controlling a television receiver with use of an information terminal, the control method comprising: a command transmission step of the information terminal transmitting, to the television receiver, a command corresponding to a user operation performed on a GUI (Graphical User Interface), which is displayed on a touch panel provided in the information terminal; a state switching step of the television receiver switching a state of the television receiver to another state corresponding to a command having been transmitted from the information terminal; a state notifying step of the television receiver providing, with the information terminal, one of (i) a notification of the state of the television receiver to which state the state switching step has switched over and (ii) an instruction to perform switching of the GUI to another GUI corresponding to the state of the television receiver to which state the state switching step has switched over; and a GUI switching step of the information terminal switching the GUI to be displayed on the touch panel to one of (a) another GUI corresponding to a state of the television receiver which state has been notified from the television receiver and (b) another GUI corresponding to the instruction having been provided by the television receiver.

According to the above arrangement, the GUI to be displayed on the touch panel of the information terminal is automatically switched over to another GUI corresponding to the state of the television receiver. This makes it possible to obviate the trouble of switching, when there occurs a change in the state of the television receiver, the GUI to be displayed on the touch panel of the information terminal to another GUI corresponding to the post-change state of the television receiver. Alternatively, it is possible to reduce a risk of an erroneous operation resulting from the impossibility of grasping that the state of the information terminal has changed.

The present invention encompasses a television receiver (single unit) which is included in the system described above. The present invention also encompasses an information terminal (single unit) which is included in the system described above. Moreover, the present invention encompasses a program for operating such an information terminal and a storage medium having such a program stored thereon.

### Advantageous Effects of Invention

As described above, a system according to the present invention is a system including: a television receiver; and an information terminal, the television receiver including: state switching means configured to switch a state of the television receiver to another state corresponding to a command having been transmitted from the information terminal; and state notifying means configured to provide, with the information terminal, one of (i) a notification of the state of the television receiver to which state the state switching means has switched over and (ii) an instruction to perform switching of a GUI (Graphical User Interface) to another GUI corresponding to the state of the television receiver to which state the state switching means has switched over, the information terminal including: command transmitting means configured to transmit, to the television receiver, a command corresponding to a user operation performed on the GUI, which is displayed on a touch panel provided in the information terminal; and GUI switching means configured to switch the GUI to be displayed on the touch panel to one of (a) another GUI corresponding to a state of the television receiver which state has been notified from the television receiver and (b) another GUI corresponding to the instruction having been provided by the television receiver.

Further, a control method according to the present invention is a control method for controlling a television receiver with use of an information terminal, the control method comprising: a command transmission step of the information terminal transmitting, to the television receiver, a command corresponding to a user operation performed on a GUI (Graphical User Interface), which is displayed on a touch panel provided in the information terminal; a state switching step of the television receiver switching a state of the television receiver to another state corresponding to a command having been transmitted from the information terminal; a state notifying step of the television receiver providing, with the information terminal, one of (i) a notification of the state of the television receiver to which state the state switching step has switched over and (ii) an instruction to perform switching of the GUI to another GUI corresponding to the state of the television receiver to which state the state switching step has switched over; and a GUI switching step of the information terminal switching the GUI to be displayed on the touch panel to one of (a) another GUI corresponding to a state of the television receiver which state has been notified from the television receiver and (b) another GUI corresponding to the instruction having been provided by the television receiver.

This makes it possible to realize a system and an operation method both of which are easier to use and cause less erroneous operation than the conventional systems and the conventional operation methods.

### BRIEF DESCRIPTION OF DRAWINGS

FIG. 1 is a block diagram illustrating a configuration of a system.

FIG. 2 is a block diagram illustrating a hardware configuration of a television.

FIG. 3 is a block diagram illustrating a hardware configuration of a smartphone.

FIG. 4 is a functional block diagram illustrating functional configurations of the control section of the television and the control section of the smartphone.

FIG. 5 is a view illustrating a configuration of a remote control top screen (Note that AQUOS is a registered trademark).

FIG. 6 is a view illustrating a configuration of a fixed operation panel.

FIG. 7 is a view illustrating a configuration of a display switching tab.

FIG. 8 is a view illustrating all panels each displayed in response to a tap on a corresponding region of the display switching tab.

FIG. 9 is a screen transition diagram illustrating the screen transition from the remote control top screen.

FIG. 10 is a screen transition diagram illustrating the screen transition carried out when any operation target device could not be found.

FIG. 11 is a view illustrating a configuration of the numeric channel select panel in three modes.

FIG. 12 is a view illustrating an example screen of the smartphone displaying the numeric channel select panel when having obtained a channel list from the television.

FIG. 13 is a view illustrating a configuration of an up and down channel select panel in three modes.

FIG. 14 is a view illustrating an example screen of the smartphone displaying the up and down numeric channel select panel when having obtained a channel list from the television.

FIG. 15 is a screen transition diagram illustrating screen transition carried out in response to a tap on a page forward button or a page back button.

FIG. 16 is a screen transition diagram illustrating screen transition carried out in response to a drag or a flick in a vertical direction.

FIG. 17 is a screen transition diagram illustrating screen transition carried out when the remote control application is launched for the first time.

FIG. 18 is a screen transition diagram illustrating screen transition carried out when the remote control application is launched for the second or subsequent time.

FIG. 19 is a screen transition diagram illustrating screen transition carried out when a television is to be selected as an operation target device from a device selection screen.

FIG. 20 is a screen transition diagram illustrating screen transition carried out when the television authenticates the smartphone.

FIG. 21 is a screen transition diagram illustrating screen transition carried out when the search for a device is made again at the point in time when the user instructs to do so.

FIG. 22 is a screen transition diagram illustrating screen transition carried out when the smartphone performs automatic updating of a device(s) being connected with the smartphone.

FIG. 23 (a) is a screen transition diagram illustrating screen transition carried out when an edit is made to a device name of a television registered in a television list, and (b) of FIG. 23 is a view illustrating an example of how a pop-up menu is displayed on the device selection screen 23-b.

FIG. 24 is a screen transition diagram illustrating screen transition carried out when the device name is changed to a new device name.

FIG. 25 is a screen transition diagram illustrating screen transition carried out when a device name of a television registered in the television list is initialized.

FIG. 26 is a screen transition diagram illustrating screen transition carried out when the television is disconnected from the LAN during the edit to the device name.

FIG. 27 (a) is a screen transition diagram illustrating screen transition carried out when the television is deleted from the television list, and (b) of FIG. 27 is a view illustrating an example of a screen displayed when all the televisions are deleted from the television list.

FIG. 28 is a screen transition diagram illustrating screen transition carried out when the device selection screen is changed to a demonstration screen.

FIG. 29 is a screen transition diagram illustrating an example flow of a keyword search function of the smartphone.

FIG. 30 (a) through (d) is a view illustrating an example screen of the television indicating a search result determined by the keyword search function of the smartphone.

FIG. 31 is a screen transition diagram illustrating an example flow of entering a search character string by voice input in the smartphone.

FIG. 32 is a screen transition diagram illustrating an example flow of the keyword search function in a case where no search character string is entered on the smartphone.

FIG. 33 is a view schematically illustrating how source devices are switched with the use of the smartphone.

FIG. 34 is a view illustrating an example of a link operation panel.

FIG. 35 is a view illustrating examples of (i) screen transition of the smartphone and (ii) a screen of the television, in a FAMILINK operation of a source device.

FIG. 36 is a view illustrating examples of (i) screen transition of the smartphone and (ii) a screen of the television at the selection of a source device with use of the device selection screen displayed on the television.

FIG. 37 is a screen transition diagram illustrating screen transition of an input switching panel.

FIG. 38 is a screen transition diagram illustrating screen transition carried out when the input switching panel is scrolled with a flick or drag operation.

FIG. 39 is a view illustrating an example screen flow of a simple navigation function of the smartphone.

FIG. 40 (a) is a view illustrating an example of items which are displayed on a screen of the simple navigation function in the smartphone, and (b) of FIG. 40 is a view illustrating an example of screens on the television receiver and screens on the smartphone which screens are displayed in association with the items illustrated in (a) of FIG. 40.

FIG. 41 is a view illustrating an example display of the items for the simple navigation in the smartphone.

FIG. 42 is a view illustrating another example display of the items for the simple navigation in the smartphone.

FIG. 43 is a screen transition diagram illustrating an example flow of display of the operation panel on the smartphone.

FIG. 44 is a view illustrating an example of modes in which the operation panel of the smartphone can be displayed.

FIG. 45 is a view illustrating an example of how the screen displayed in the operation panel of the smartphone looks like in a “Flick” mode.

FIG. 46 is a view illustrating an example of an option menu in the smartphone.

FIG. 47 is a screen transition diagram illustrating an example flow of operating the option menu in the smartphone.

FIG. 48 is a view illustrating an example of display of items shown in an option menu on the device selection screen of the smartphone.

FIG. 49 is a screen transition diagram illustrating an example flow of operating the option menu on the device selection screen of the smartphone.

FIG. 50 (a) is a screen transition diagram illustrating an example flow of entering characters in the smartphone, and (b) of FIG. 50 is a view illustrating an example of display of a character string entry window on which no software keyboard is displayed.

FIG. 51 is a screen transition diagram illustrating a detailed example flow of entering characters in the smartphone.

FIG. 52 is a screen transition diagram illustrating another example flow of entering characters in the smartphone.

FIG. 53 is a view illustrating an example of a setting screen which is displayed on the television and on which a setting for several items is carried out.

FIG. 54 is a view schematically illustrating a method for causing a web browser operating in the television to access a web page which is being viewed with a web browser operating in the smartphone.

FIG. 55 is a view illustrating a cooperative operation between the television and the smartphone on a still image reproduction scene.

FIG. 56 is a view illustrating a cooperative operation between the television and the smartphone at the arrival of an incoming call.

FIG. 57 is a view illustrating a cooperative operation between the television and the smartphone at the arrival of an incoming e-mail.

FIG. 58 is a view schematically illustrating an example of a flashback function with use of the smartphone.

FIG. 59 is a flow chart illustrating an example of how the television manages view histories.

FIG. 60 is a view illustrating an example of a database that manages view histories (input histories).

FIG. 61 is a flow chart illustrating an example of how the smartphone manages view histories.

FIG. 62 is a view schematically illustrating another example of a flashback function with use of the smartphone.

FIG. 63 is a view schematically illustrating still another example of a flashback function with use of the smartphone.

FIG. 64 is a view schematically illustrating an example of a favorite channel function with use of the smartphone.

FIG. 65 is a view illustrating an example of a screen shown when an edit to a favorite channel is carried out on the smartphone.

FIG. 66 is a flow chart illustrating an example of how the television transmits favorite channels.

FIG. 67 is a view illustrating an example of a database that manages favorite channels.

FIG. 68 is a flow chart illustrating an example of how the smartphone receives favorite channels set in the television.

FIG. 69 is a flow chart illustrating an example of how the television transmits a list of channels, which can be received by the television, to the smartphone.

FIG. 70 is a view illustrating an example of a database that manages a list of channels which can be received by the television.

FIG. 71 is a flow chart illustrating an example of how the smartphone receives, from the television, a list of channels that can be received by the television.

FIG. 72 is a flow chart illustrating a flow of processes that are carried out by the smartphone when favorite channels set in the television are edited on the smartphone.

FIG. 73 is a flow chart illustrating a flow of processes that are carried out by the television when favorite channels set in the television are edited on the smartphone.

FIG. 74 is a view schematically illustrating another example of a favorite channel function using the smartphone.

FIG. 75 is a view illustrating another example of a screen displayed when favorite channels are edited on the smartphone.

FIG. 76 is a view schematically illustrating an example of a favorite application function using the smartphone.

FIG. 77 is a view illustrating an example of a screen displayed when favorite applications are edited on the smartphone.

FIG. 78 is a view schematically illustrating another example of a favorite application function using the smartphone.

FIG. 79 is a view illustrating another example of a screen displayed when favorite applications are edited on the smartphone.

FIG. 80 is a view schematically illustrating an example of a function of channel selection from a channel list, with use of the smartphone.

FIG. 81 is a view schematically illustrating an example of a function of application switching using an application list (DOCK), with use of the smartphone.

FIG. 82 is a view schematically illustrating another example of a function of application switching using an application list (DOCK), with use of the smartphone.

FIG. 83 is a view schematically illustrating an example of a service list function using the smartphone.

FIG. 84 is a flow chart illustrating an example of how the television transmits, to the smartphone, a list of data broadcast contents available for the television.

FIG. 85 is a flow chart illustrating an example of how the smartphone receives, from the television, the list of data broadcast contents available for the television.

FIG. 86 is a view illustrating another example of a database that manages view histories (input histories).

FIG. 87 is a view illustrating still another example of a database that manages view histories (input histories).

### DESCRIPTION OF EMBODIMENTS

### Configuration of System

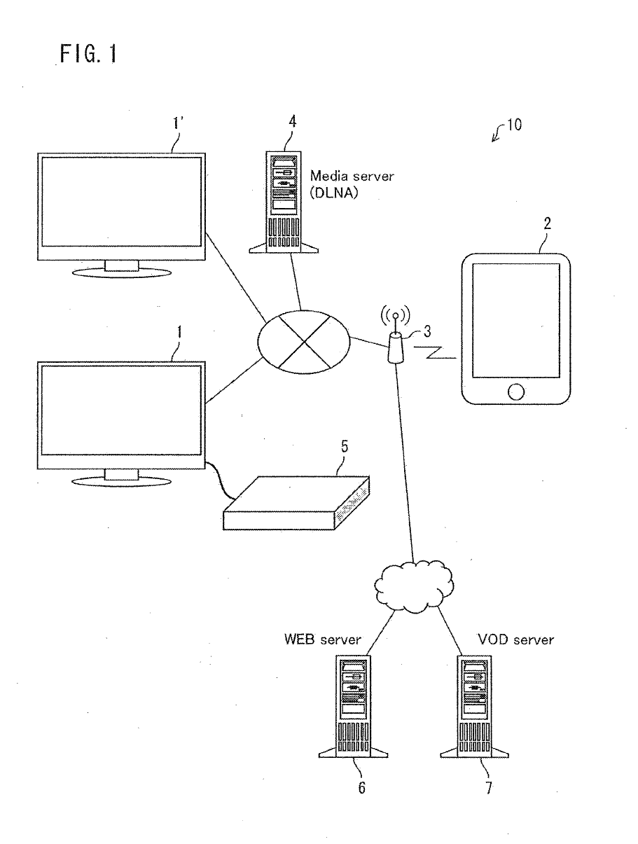

A system 10 of an embodiment of the present invention is described below with reference to FIG. 1. FIG. 1 is a block diagram illustrating a configuration of the system 10.

As illustrated in FIG. 1, the system 10 includes a television receiver (hereinafter abbreviated as a “television”) 1 and a smartphone (information terminal) 2. In the system 10, the smartphone 2 serves as a remote controller for operating the television 1.

As illustrated in FIG. 1, the smartphone 2, which is connected via a wireless router 3 with a LAN (Local Area Network), carries out IP (Internet Protocol) communication with the television 1 included in the LAN. The smartphone manipulates the television 1 through the IP communication. Note that a communication standard to support wireless communication between the smartphone 2 and the wireless router 3 is exemplified by an IEEE802.11 series.

The television 1 also carries out the IP communications with a media server 4 connected with the LAN, and with a WEB server 6 and a VOD server 7 each connected with the Internet. This allows the television 1 to reproduce not only a broadcast content broadcasted by terrestrial digital broadcasting, BS broadcasting, or CS broadcasting but also a media content supplied from the media server 4, a WEB content supplied from the WEB server 6, and a VOD content supplied from the VOD server 7.

The television 1 can also be HDMI-connected with a source device 5. This allows the television 1 to reproduce a content supplied from the source device 5. The source device 5 which is connectable with the television 1 is exemplified by, for example, a player, a recorder, and a mobile phone terminal. Further, the television 1 can have a recording device built in, such as a hard disk drive or an optical disk drive. In this case, the television 1 can reproduce a recorded content which has been recorded in the recording device built therein.

Note that the present embodiment discusses a configuration in which the smartphone 2 is used as a remote controller of the television 1. However, a configuration of the present invention is not limited to this. That is, any information terminal such as a tablet PC or an electronic book reader is usable as the remote controller of the television 1 provided that the information terminal has a touch panel provided therein.

The present embodiment also discusses a configuration in which wireless communications between the television 1 and the smartphone 2 are carried out via the wireless router 3. However, a configuration of the present invention is not limited to this. For example, in a case where the television 1 includes a wireless LAN communication interface, it is possible to apply, to the present invention, a configuration in which wireless communications between the television 1 and the smartphone 2 are carried out without the wireless router 3.

Further, the communication standard to support the wireless communication between the television 1 and the smartphone 2 is not limited to the IEEE802.11 series (which may also be referred to as “WiFi”). For example, it is also possible to use IEEE802.15.1 (which may also be referred to as “Bluetooth”®), IEEE802.15.4 (which may also be referred to as “ZigBee”), or the like. Alternatively, the wireless communication may be replaced with interactive infrared communication. Further, the communication standard may be replaced with a communication standard having unique specifications. That is, the present invention is irrespective of specific communication means and a specific communication standard.

(Hardware Configuration of Television)

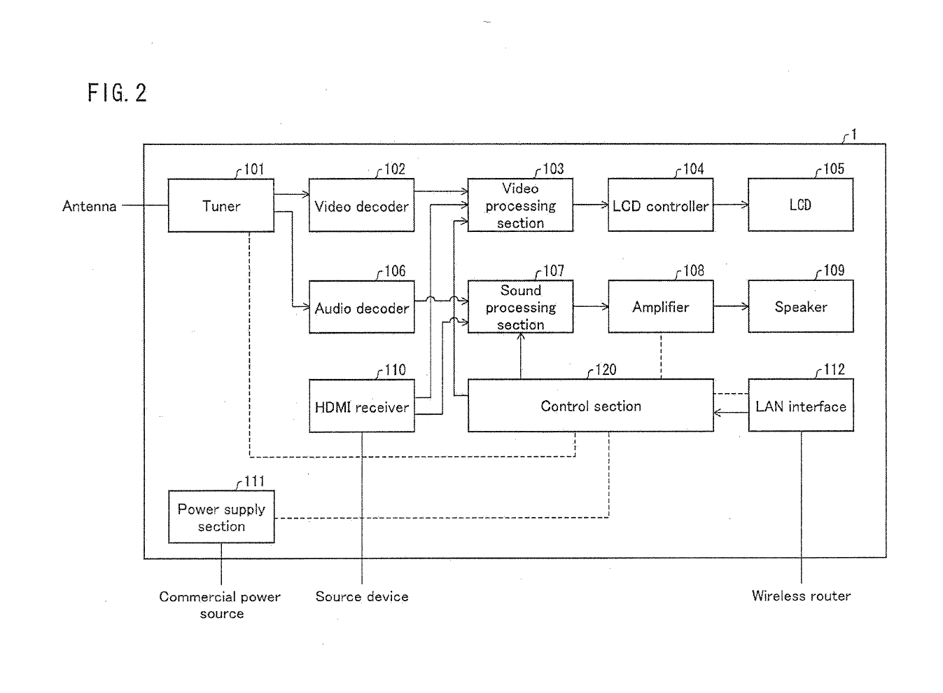

A configuration of the television 1 is described below with reference to FIG. 2. FIG. 2 is a block diagram illustrating a hardware configuration of the television 1.

As illustrated in FIG. 2, the television 1 includes a tuner 101, a video decoder 102, a video processing section 103, an LCD controller 104, an LCD 105, an audio decoder 106, a sound processing section 107, an amplifier 108, a speaker 109, an HDMI receiver 110, a power supply section 111, a LAN interface 112, and a control section 120.

The tuner 101 demodulates an encoded video signal and an encoded sound signal from a broadcast wave of terrestrial digital broadcasting, BS broadcasting, or CS broadcasting. The video decoder 102 decodes the encoded video signal demodulated by the tuner 101. The video signal decoded by the video decoder 102 is supplied via the video processing section 103 to the LCD controller 104. The LCD controller 104 controls the LCD 105 so that the LCD 105 displays a video image which is indicated by the video signal having been processed by the video processing section 103. The audio decoder 106 decodes the encoded sound signal demodulated by the tuner 101. The sound signal decoded by the audio decoder 106 is supplied via the sound processing section 107 to the amplifier 108. The amplifier 108 drives the speaker 109 to output a sound which is indicated by the sound signal having been processed by the sound processing section 107.

The HDMI receiver 110 receives the video signal and the sound signal each supplied from the source device 5. The video signal and the sound signal each received by the HDMI receiver 110 are supplied to the video processing section 103 and the sound processing section 107, respectively. Then, the video signal and the sound signal are outputted from the LCD 105 and the speaker 109, respectively, as in the case of the video signal and the sound signal each demodulated by the tuner 101.

The LAN interface 112 obtains a media content, a WEB content, and a VOD content from the media server 4, the WEB server 6, and the VOD server 7, respectively. These network contents are each decoded by the control section 120 by software. The video signal and the sound signal each decoded by the control section 120 are supplied to the video processing section 103 and the sound processing section 107, respectively. Then, the video signal and the sound signal are outputted from the LCD 105 and the speaker 109, respectively, as in the case of the video signal and the sound signal each demodulated by the tuner 101.

The LAN interface 112/the control section 120 have not only the functions described above but also a function of receiving/executing a control command transmitted from the smartphone 2 and a function of transmitting/generating state information to be notified to the smartphone 2. These functions serving as the core of the present embodiment are specifically described later with reference to another drawing replacing FIG. 2.

The control section 120 includes a CPU (Central Processing Unit), a ROM (Read Only Memory), a RAM (Random Access Memory), and the like, and realizes the functions described above by causing the CPU to execute programs recorded in the ROM, the RAM, and the like.

The power supply section 111 supplies electric power to the sections described above. The power supply section 111 operates in a normal mode or in a standby mode. Note here that the normal mode is an operational mode in which the power supply section 111 supplies electric power to all the blocks described above and that the standby mode is an operational mode in which the power supply section 111 supplies electric power only to the LAN interface 112 and the control section 120.

(Hardware Configuration of Smartphone)

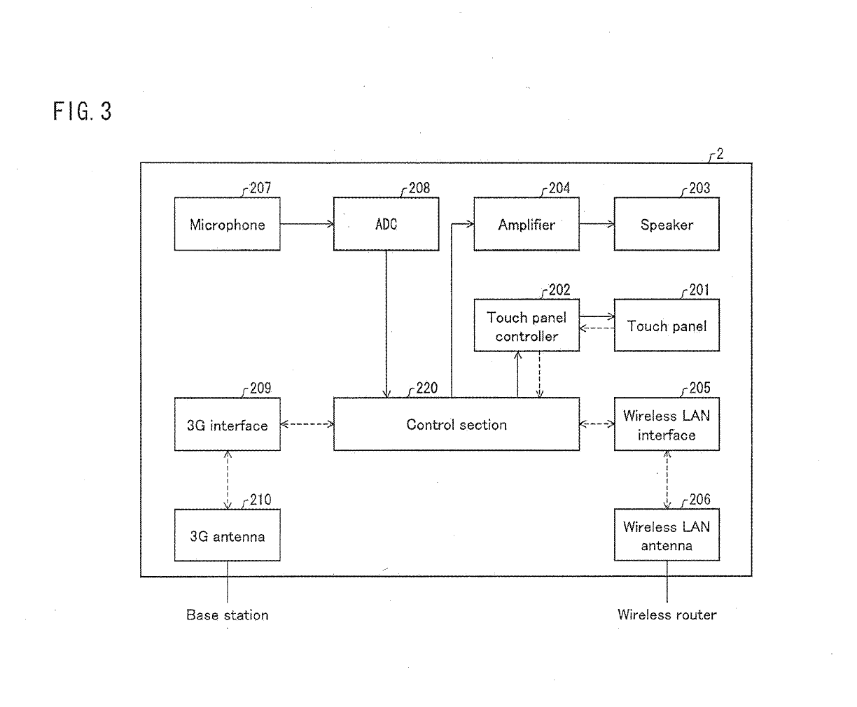

Next, a hardware configuration of the smartphone 2 is described below with reference to FIG. 3. FIG. 3 is a block diagram illustrating the hardware configuration of the smartphone 2.

As illustrated in FIG. 2, the smartphone 2 includes a touch panel 201, a touch panel controller 202, a speaker 203, an amplifier 204, a wireless LAN interface 205, a wireless LAN antenna 206, a microphone 207, an ADC 208, a 3G interface 209, a 3G antenna 210, and a control section 220.

The touch panel controller 202 controls the touch panel 201 so that the touch panel 201 displays a GUI (Graphical User Interface) generated by the control section 220. According to the present embodiment, the control section 220 generates the GUI which is constituted by GUI elements (may also be referred to as “widgets” or “controls”) for operating the television 1. Note here that the GUI elements refer to GUI components such as a switch, a slider, a button, a list, and a text field. Further, the touch panel controller 202 detects a user operation (a tap operation or a flick operation) carried out with respect to a GUI element displayed on the touch panel 201. Then, the touch panel controller 202 provides the control section 220 with operational information indicative of contents of the detected user operation (what user operation was carried out with respect to which of the GUI elements).

The amplifier 204 drives the speaker 203 to output a sound indicated by a sound signal which is supplied from the control section 220. Examples of the sound signal supplied from the control section 220 include signals indicating not only a voice during a call but also various sounds which are generated by an application executed by the control section 220. Other examples of the sound signal supplied from the control section 220 include a signal indicating a sound effect which is generated by a remote control application in response to the user operation carried out with respect to the GUI element displayed on the touch panel 201.

The wireless LAN interface 205 is a communication interface for carrying out communications in accordance with the IEEE802.11 series with the wireless router 3 via the wireless LAN antenna 206. The wireless LAN interface 205 establishes communication for performing remote control of the television 1, i.e., transmits the control command and receives the state information. The control section 220 switches, in accordance with the state information received by the wireless LAN interface 205, the GUI displayed on the touch panel 201. Further, the control section 220 uses the wireless LAN interface 205 to generate, in accordance with the user operation carried out with respect to the GUI displayed on the touch panel 201, a command to be transmitted to the television 1.

The microphone 207 and the ADC 208 are each configured to receive a voice input. The microphone 207 converts a user's voice into an electrical signal. Further, the ADC 208 converts the electrical signal into a digital signal. The control section 220 carries out a voice calling function and a text input function with reference to the digital signal.

The 3G interface 209 is a communication interface for carrying out communications in accordance with W-CDMA or CDMA2000 with a base station via the 3G antenna 210. The 3G interface 209 carries out data communications and communications for a voice call, both of which communications are services provided by a telecommunications carrier.

The control section 220 includes a CPU (Central Processing Unit), a ROM (Read Only Memory), a RAM (Random Access Memory), and the like, and controls the sections of the smartphone 2 by causing the CPU to execute programs recorded in the ROM, the RAM, and the like.

(Configuration of Control Section)

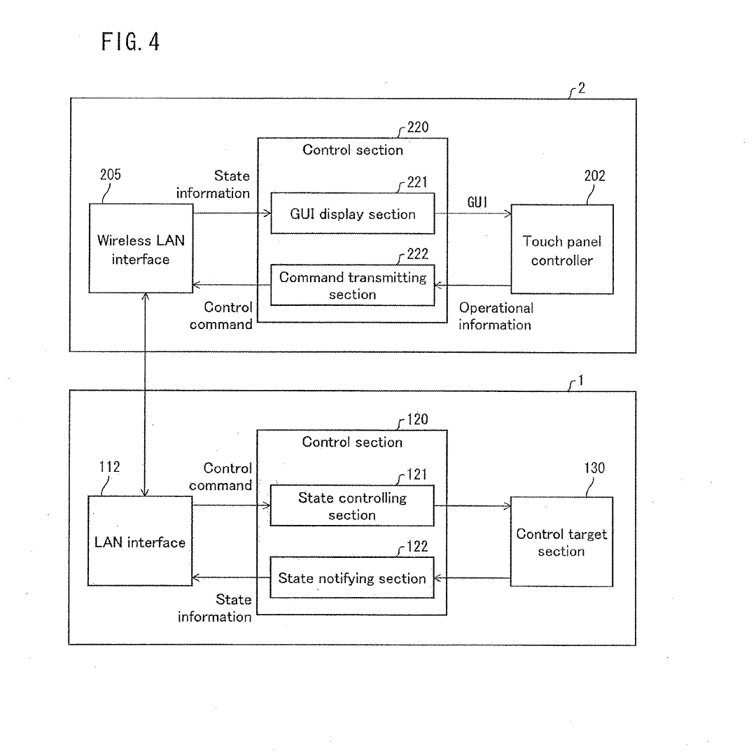

Next, the following description discusses, with reference to FIG. 4, the functions serving as the core of the present embodiment out of the functions of the control section 120 of the television 1 and the control section 220 of the smartphone 2. FIG. 4 is a block diagram illustrating functional configurations of the control section 120 and the control section 220.

As illustrated in FIG. 4, the control section 120 of the television 1 functions as a state controlling section (state switching means) 121 and a state notifying section (state notifying means) 122. The control section 220 of the smartphone 2 functions as a GUI display section (GUI switching means) 221 and a command transmitting section (command transmitting means) 222. These control sections repeat the following steps 1 through 5 so as to sequentially change the GUI displayed on the smartphone 2 to another GUI corresponding to the latest state of the television 1 while sequentially changing a state of the television 1 to another state corresponding to the user operation.

Step 1: In the smartphone 2, when the touch panel controller 202 detects a user operation which has been carried out with respect to a first GUI displayed on the touch panel 201, the touch panel controller 202 provides the command transmitting section 222 with operational information indicative of contents of the detected user operation (what user operation was carried out with respect to which of the GUI elements).

Step 2: In the smartphone 2, when the command transmitting section 222 obtains the operational information from the touch panel controller 202, the command transmitting section 222 transmits, via the wireless LAN interface 205 to the television 1, a control command corresponding to the obtained operational information.

Step 3: In the television 1, upon receipt of the control command via the LAN interface 112, the state controlling section 121 executes the control command thus received. That is, the state controlling section 121 causes a state of a control target section 130 specified by the control command to be changed to another state specified by the control command,

Step 4: In the television 1, when having detected that the state of the control target section 130 has been changed, the state notifying section 122 transmits, to the smartphone 2 via the LAN interface 112, state information indicative of the post-change state of the control target section 130.

Step 5: In the smartphone 2, upon receipt of the state information via the wireless LAN interface 205, the GUI display section 221 controls the touch panel controller 202 so that the touch panel controller 202 switches the GUI displayed on the touch panel 201 to another GUI corresponding to the state information thus received.

Note here that the control target section 130 refers to a block specified by the control command out of blocks included in the television 1. That is, for example, in a case where the control command is directed to switch a power status to a standby mode, the power supply section 111 corresponds to the control target section 130. In a case where the control command is directed to switch a display target channel, the tuner 101 corresponds to the control target section 130.

Note that the above step 2 can be easily carried out with the arrangement in which a lookup table indicating correspondences between the operational information items and the control commands is stored in the ROM or the like of the control section 220. With such an arrangement, the command transmitting section 222 can identify the control command to be transmitted, with reference to the lookup table.

Note also that the above step 5 can be easily carried out with the arrangement in which a lookup table indicating correspondences between the state information items and the GUIs is stored in the ROM or the like of the control section 220. With such an arrangement, the GUI display section 221 can identify the GUI to be displayed, with reference to the lookup table.

[Specific Example of Remote Control Function]

Functions of a remote control application which runs on the smartphone 2 are described below with reference to a specific example of the GUI displayed on the touch panel 201. The GUI displayed on the touch panel 201 may also be referred hereinafter to as a “screen”.

(Basic Function)

<Remote Control Top Screen>

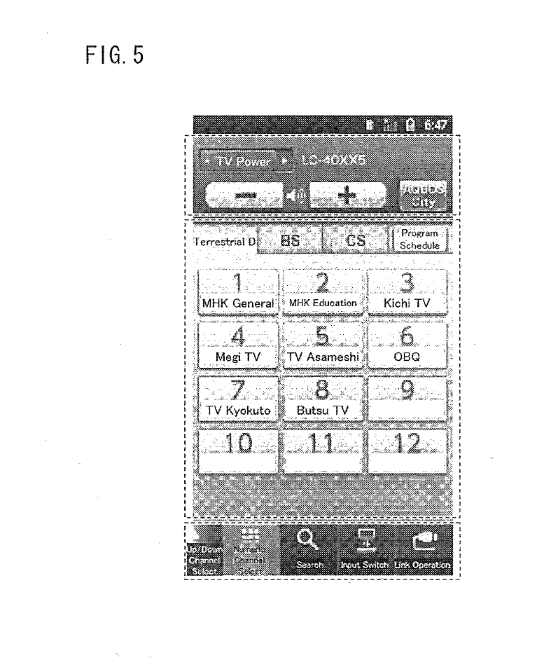

First, a remote control top screen displayed at the launch of the remote control application (at the second or subsequent launch) is described below with reference to FIG. 5. FIG. 5 illustrates a configuration of the remote control top screen.

As illustrated in FIG. 5, the remote control top screen is divided into three parts, i.e. upper, middle, and lower parts. In the upper part of the screen, a fixed operation panel is provided. In the lower part of the screen, a display switching tab is provided. The fixed operation panel and the display switching tab are fixed GUIs being displayed during a time in which the remote control application runs. On the other hand, in the middle part of the screen, there is provided a panel selected through the display switching tab from among the following panels: an operation panel, a simple navigation panel, an up and down channel select panel, a numeric channel select panel, a search panel, an input switching panel, and a link operation panel. Note that the panel provided in the middle part of the screen in FIG. 5 is a default numeric channel select panel.

<Fixed Operation Panel>

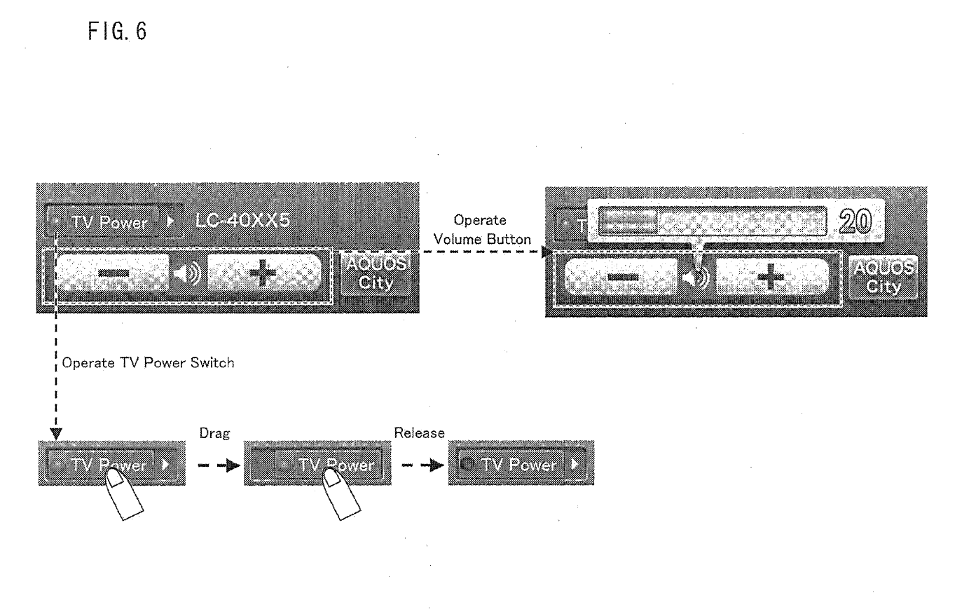

Next, a configuration of the fixed operation panel is described below with reference to FIG. 6. FIG. 6 illustrates the configuration of the fixed operation panel.

As illustrated in FIG. 6, the fixed operation panel includes a power switch, an operation target device name, a volume down button, a volume up button, and a home page button.

The power switch is a slider-type toggle switch for switching power of the television 1 from/to an on state to/from a standby state. A sliding part of the power switch is provided with an indicator indicative of the power status of the television 1 (green in the on state, and red in the standby state).

In a case where an operation of dragging the sliding part rightward and then releasing the sliding part is carried out when power of the television 1 is in the on state, the smartphone 2 transmits, to the television 1, a control command instructing to switch power of the television 1 to the standby state. Upon receipt of a notification from the television 1 that the power of the television 1 has been switched to the standby state, the smartphone 2 switches an indication color of the indicator from green to red.

Conversely, in a case where the operation of dragging the sliding part rightward and then releasing the sliding part is carried out when the power of the television 1 is in the standby state, the smartphone 2 transmits, to the television 1, a control command instructing to switch the power of the television 1 to the on state. Upon receipt of a notification from the television 1 that the power of the television 1 has been switched to the on state, the smartphone 2 switches the indication color of the indicator from red to green.

The operation target device name is a text indicative of a friendly name of the television 1 being selected as an operation target device. In response to a touchdown on the operation target device name (a touch of a finger on an indication area where the operation target device name is indicated), the smartphone 2 changes a character color of the operation target device name. Meanwhile, in response to a touchup (a release of a finger from the indication area where the operation target device name is indicated), the smartphone 2 changes the screen to a device name selection screen (described later).

The volume down button is a button for lowering a volume level of the television 1. The volume up button is a button for raising a volume level. When the volume down button is tapped, the smartphone 2 displays a volume gauge of a progress bar type, and transmits, to the television 1, a control command instructing to lower the volume level by one level. When the volume down button is held (an area in which the volume down button is displayed continues to be touched with a finger for a time equal to or longer than a predetermined time), the smartphone 2 transmits, to the television 1, a control command to instruct muting (instruct the volume level to be 0 (zero)). Meanwhile, when the volume up button is tapped, the smartphone 2 displays the volume gauge described above, and transmits, to the television 1, a control command to instruct the volume level to be raised by one level. Note that the volume gauge is displayed for a predetermined period (e.g., for three seconds) after the volume down button or the volume up button is tapped.

When the smartphone 2 is notified by the television 1, of a post-change volume level as a feedback on such a control command as described above, the smartphone 2 switches an indication position in the volume gauge (a rightmost position in a bar indicative of the volume level) to a position corresponding to the volume level thus notified. Further, the smartphone 2 switches a value of the volume level indicated at the right end of the volume gauge to a numerical value indicative of the volume level thus notified.

Note that an operation carried out in response to a tap operation on the home page button is described later with reference to another drawing replacing FIG. 6.

<Display Switching Tab>

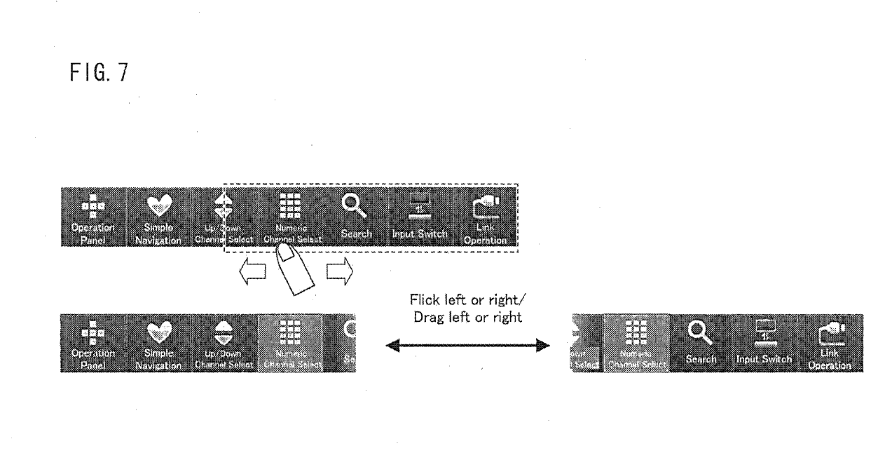

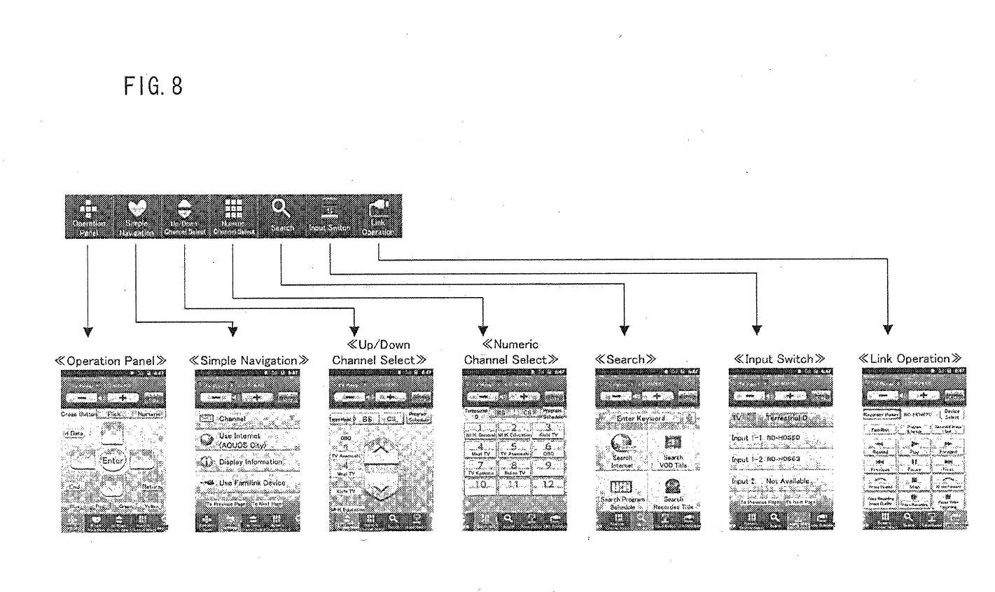

Next, the display switching tab is described below with reference to FIGS. 7 and 8.

FIG. 7 is a view illustrating a configuration of the display switching tab. FIG. 8 is a view illustrating all panels each displayed in response to a tap on a corresponding region of the display switching tab.

As described earlier, the display switching tab is a tab for switching the panel to be displayed in the middle part of the screen to another. As illustrated in FIG. 7, the display switching tab is divided into seven regions corresponding to the respective panels which can be displayed in the middle part of the screen. For example, when the leftmost region of the display switching tab is tapped, the leftmost region is highlighted, and the operation panel appears in the middle part of the screen. When the second leftmost region of the display switching tab is tapped, the second leftmost region is highlighted, and the simple navigation panel appears in the middle part of the screen. For the panels appearing in the middle part of the screen in response to taps on the other regions, see FIG. 8.

The entire display switching tab, which is longer in width than the touch panel 201, cannot be displayed on the touch panel 201. However, as illustrated in FIG. 7, the display switching tab can be scrolled rightward and leftward. When the display switching tab is dragged, a displayed part of the display switching tab is shifted by an amount of the drag in a direction in which the display switching tab is dragged. When the display switching tag is flicked, the displayed part of the display switching tab is shifted by one screen in a direction in which the display switching tag is flicked.

Note that, in displaying the display switching tab on the screen, blurring is applied to a region which is positioned at the edge of the screen and partly lies off the edge of the screen out of the regions of the display switching tab. This is contrived to clarify that there exists a region not being displayed in the display switching tag. Note that a selected region of the display switching tag is not changed even if the display switching tag is flicked. Note also that the display switching tag is not bounced back even if the display switching tag is flicked to its end. A default of the displayed part of the display switching tab in one screen of the touch panel 201 is a part corresponding to a region surrounded by a dotted line in FIG. 7.

<Screen Transition from Remote Control Top Screen>

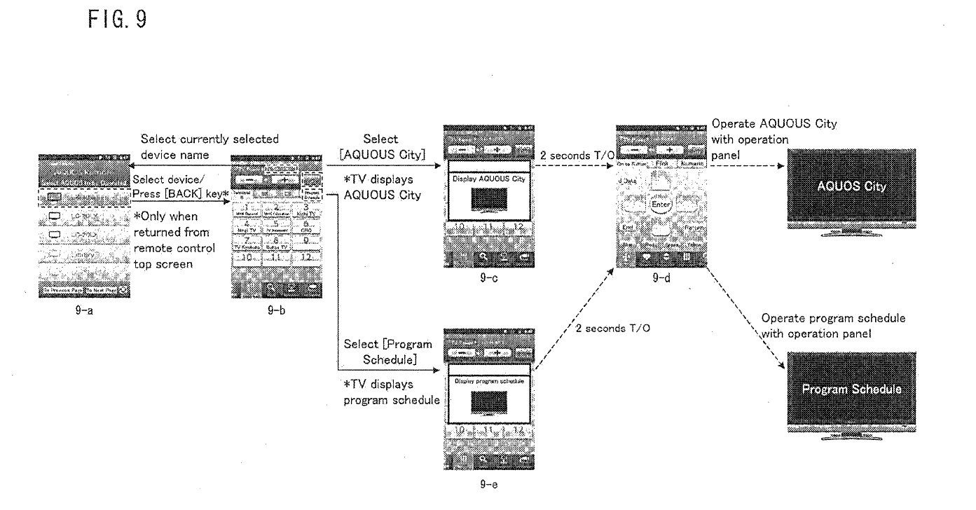

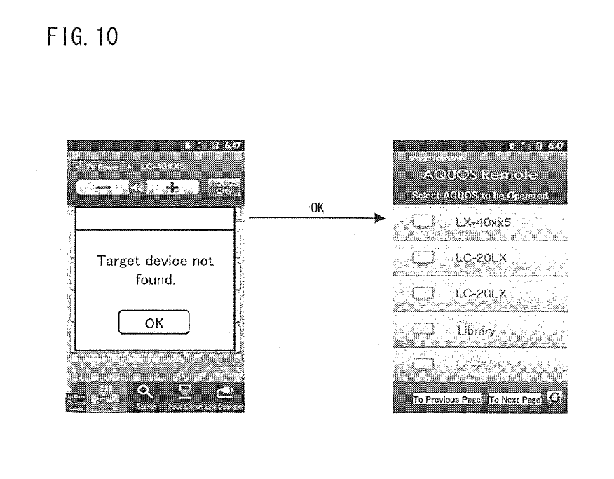

Next, a screen change from the remote control top screen is described below with reference to FIG. 9. FIG. 9 is a screen transition diagram illustrating the screen transition from the remote control top screen.

When a home button is tapped on a remote control top screen 9-b, the smartphone 2 transmits, to the television 1, a control command instructing to access a predetermined home page (“AQUOS City” in FIG. 9), and displays, on the remote control top screen, a dialog notifying that the home page is to be displayed on the television 1 soon (screen 9-c). Then, upon lapse of two seconds after the smartphone 2 has transmitted the control command, or upon receipt of a notification from the television 1 that the display of the home page has been completed, the smartphone 2 switches the panel displayed in the middle part of the screen to an operation panel in a cross button mode (screen 9-d). This allows a cursor movement operation to be carried out in the home page displayed on the television 1.

Note that the present embodiment assumes that a waiting time for which the smartphone 2 waits for a response from the television 1 to the control command (a notification that execution of a process specified by the control command has been completed) is 2 seconds. In a case where the smartphone 2 receives no response from the television 1 even after the waiting time has elapsed, the smartphone 2 advances the process (changes the GUI to another GUI). However, the waiting time is not limited to 2 seconds. That is, the waiting time may be any predetermined time, e.g. 1 second or 3 seconds. Also in the following description, limitation of “2 seconds” is merely an example, and the waiting time can be changed to any predetermined time.

When a program guide button provided in the numeric channel select panel is tapped on the remote control top screen 9-b, the smartphone 2 transmits, to the television 1, a control command instructing to display an electronic program guide, and displays, on the remote control top screen, a dialog notifying that the electronic program guide is to be displayed on the television 1 soon (screen 9-e). Then, upon lapse of two seconds after the smartphone 2 has transmitted the control command, or upon receipt of a notification from the television 1 that the display of the electronic program guide has been completed, the smartphone 2 switches the panel displayed in the middle part of the screen to the operation panel in the cross button mode (the screen 9-d). This allows a cursor movement operation to be carried out in the electronic program guide displayed on the television 1.

Note that the remote control top screen 9-b is displayed at the second or subsequent launch of the remote control application, whereas a device selection screen 9-a is displayed when the remote control application is launched for the first time. The device selection screen 9-a, on which a user selects a television to serve as an operation target device, includes a list of device names of televisions each connected to the LAN. When a device name of the television 1 is selected from the list, the smartphone 2 sets the television 1 as an operation target device, and then displays the device name of the television 1 as the operation target device name on the fixed operation panel of the remote control top screen 9-b to which the screen is switched from the device selection screen 9-a.

In response to a touchdown/touchup on the operation target device name shown on the fixed operation panel when the remote control top screen 9-b is being displayed, the smartphone 2 changes the screen from the remote control top screen 9-b to the device selection screen 9-a, as described previously. This allows the user to reselect the television 1 intended to be set as the operation target device. In this case, if the user taps a back button without reselecting the television 1, it is possible to return to the remote control top screen 9-b without changing the television 1 intended to be set as the operation target device.

Note that, in a case where the smartphone 2 cannot find the television 1 set as the operation target device in the LAN at the second or subsequent launch of the remote control application, the smartphone 2 displays, on the remote control top screen, a dialog notifying that the television 1 having been set as the operation target device could not be found. When the user taps “OK” in the dialog, the smartphone 2 switches the screen to the device selection screen 9-a.

<Numeric Channel Select Panel>

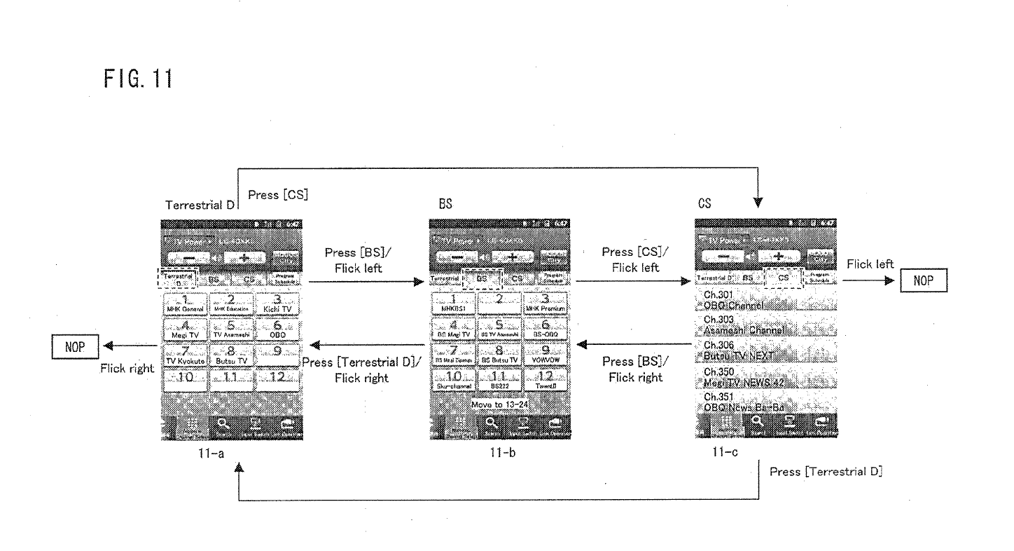

Next, the numeric channel select panel is described below with reference to FIGS. 11 and 12, and FIGS. 15 and 16.

FIG. 11 is a view illustrating a configuration of the numeric channel select panel in three modes. As illustrated in FIG. 11, switching among these three modes can be carried out by a tap on a tab or by a flick of the screen in a transverse direction.

A terrestrial D-mode numeric channel select panel 11-a, which is a panel for selecting a channel of terrestrial digital broadcasting, is composed of 12 channel buttons, as illustrated in FIG. 11. In response to a tap on a channel button, the smartphone 2 transmits, to the television 1, a control command instructing to select a channel corresponding to the channel button thus tapped.

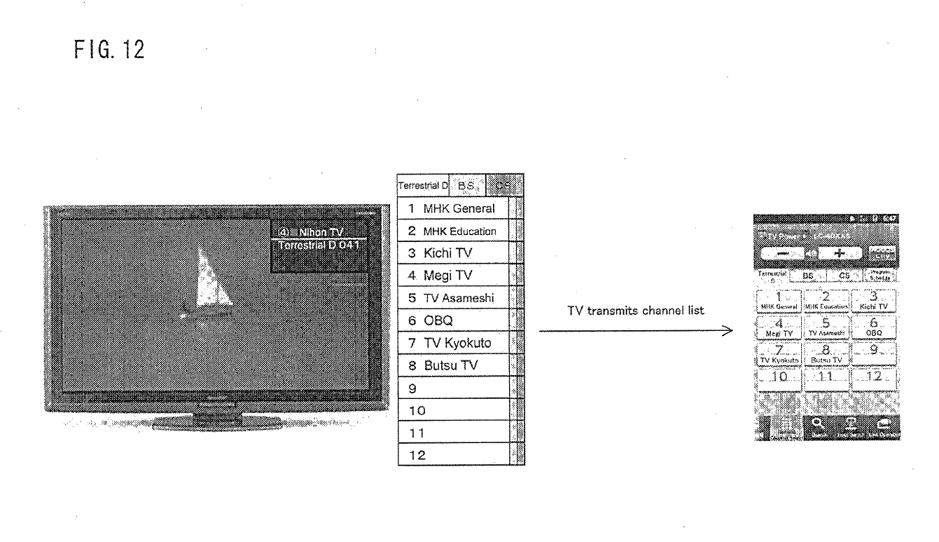

It should be noted in the terrestrial D-mode numeric channel select panel 11-a that broadcast station names corresponding to the respective channel buttons are displayed as illustrated in FIG. 11. As illustrated in FIG. 12, the smartphone 2 obtains a channel list from the television 1 every time the numeric channel select panel is selected. With reference to the channel list, in which correspondences between channels and broadcast station names are registered, the smartphone 2 identifies a broadcast station name corresponding to each of the channel buttons, and displays the identified broadcast station name on the corresponding channel button.

Note that the present embodiment employs an arrangement in which the smartphone 2 obtains a channel list from the television 1 every time the numeric channel select panel is selected. However, a timing at which the smartphone 2 obtains the channel list is not limited to this. That is, for example, the present embodiment may employ an arrangement in which the television 1 provides the smartphone 2 with a notification of an update of the channel list every time the channel list is updated for some reason, and the smartphone 2 obtains the channel list from the television 1 every time the smartphone 2 receives the notification.

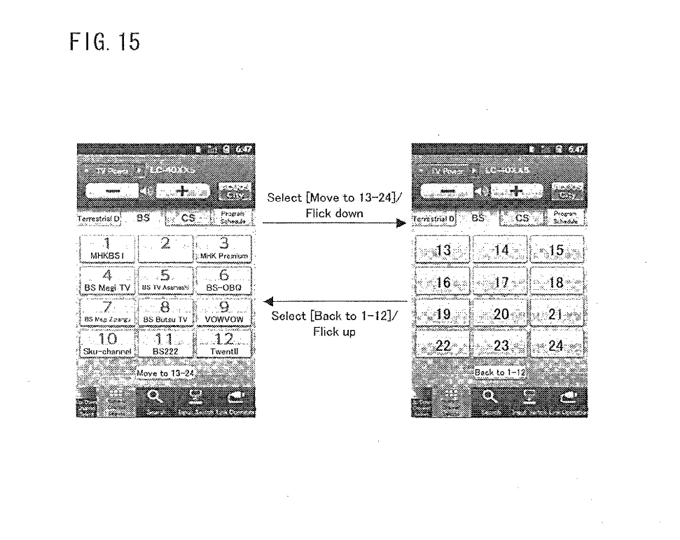

A BS-mode numeric channel select panel 11-b, which is a panel for selecting a channel of BS broadcasting, is composed of 24 channel buttons, and a page forward button and a page back button. The 24 channel buttons are arranged over two pages such that 12 buttons are arranged on the first page and that the 12 remaining buttons are arranged on the second page. On the first page, 12 buttons corresponding to respective channels Nos. 1 to 12 and the page forward button are arranged. On the second page, 12 buttons corresponding to respective channels Nos. 13 to 24 and the page back button are arranged. FIG. 11 illustrates a state in which the first page is displayed. As illustrated in FIG. 15, when the page forward button (“Move to 13-24” button in FIG. 15) is tapped in the state in which the first page is displayed, a display target page is switched from the first page to the second page. Meanwhile, when the page back button (“Back to 1-12” button in FIG. 15) is tapped in a state in which the second page is displayed, the display target page is switched from the second page to the first page. As illustrated in FIG. 15, switching between these pages can also be carried out by a flick operation in a vertical direction.

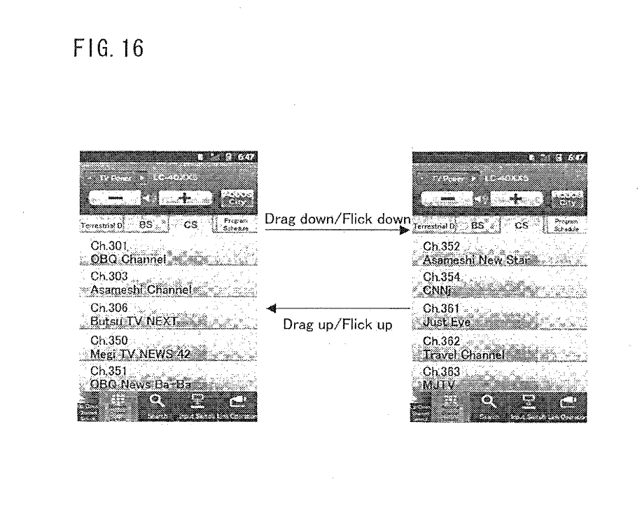

A CS-mode numeric channel select panel 11-c, which is a panel for selecting a channel of CS broadcasting, is composed of a list of list items corresponding to respective channels (see FIG. 11). When any of the list items is tapped, the smartphone 2 transmits, to the television 1, a control command instructing to select a channel corresponding to the list item thus tapped. The reason why the CS-mode numeric channel select panel 11-c is in a list form is that use of a scrollable list facilitates a channel selection operation since CS broadcasting is larger in number of channels than BS broadcasting and terrestrial digital broadcasting. As illustrated in FIG. 16, scrolling the list can be carried out by a flick operation or a drag operation in a vertical direction.

<Up and Down Channel Select Panel>

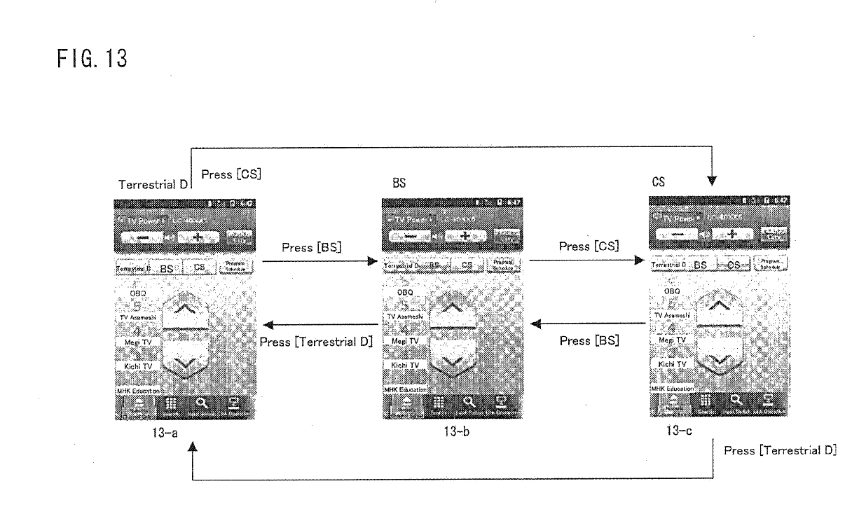

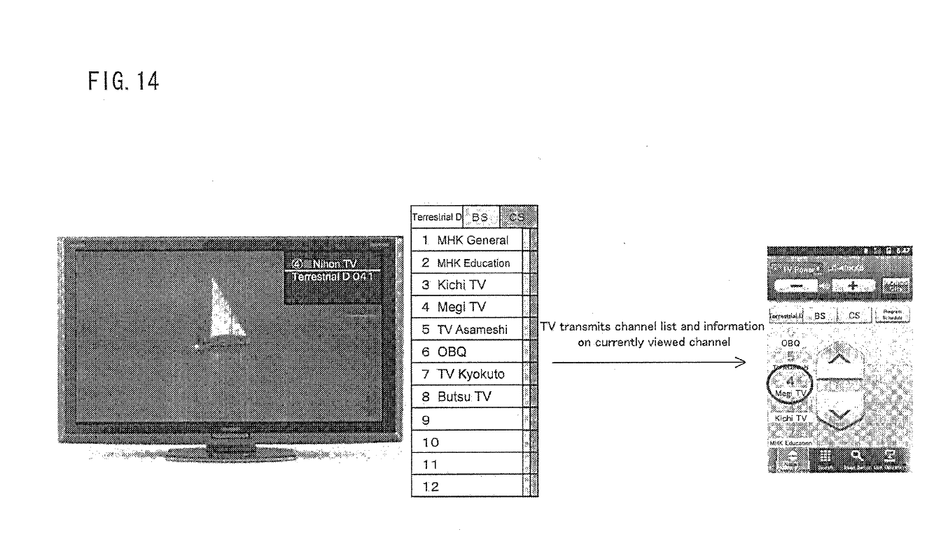

Next, an up and down channel select panel is described with reference to FIGS. 13 and 14.

FIG. 13 is a view illustrating a configuration of the up and down channel select panel in three modes. As illustrated in FIG. 13, switching among these three modes can be carried out by a tap on a tab or by a flick in a transverse direction.

Up and down channel select panels 13-a to 13-c in the respective three modes are each composed of a channel up button and a channel down button. In response to a tap on the channel up button, the smartphone 2 transmits, to the television 1, a control command instructing to select a channel which is located at an upper position by one channel than a currently selected channel. Meanwhile, in response to a tap on the channel down button, the smartphone 2 transmits, to the television 1, a control command instructing to select a channel which is located at a lower position by one channel than the currently selected channel.

It should be noted in the up and down channel select panels 13-a to 13-c that a broadcast station name corresponding to the currently selected channel is displayed as illustrated in FIG. 13. As illustrated in FIG. 14, the smartphone 2 obtains a currently selected channel and a channel list from the television 1 every time the channel selection operation is carried out. With reference to the channel list, the smartphone 2 identifies the broadcast station name corresponding to the currently selected channel, and displays the identified broadcast station name on each of the up and down channel select panels 13-a to 13-c. In this case, the present embodiment may employ an arrangement in which broadcast station names corresponding to respective channels in a vicinity of the currently selected channel are identified together, and these broadcast station names as well are displayed in each of the up and down channel select panels 13-a to 13-c, as illustrated in FIG. 14.

Note that the present embodiment employs an arrangement in which the smartphone 2 obtains the channel list and channel information (information indicative of the currently selected channel) from the television 1 every time the channel selection is carried out. However, a timing at which the smartphone 2 obtains the channel list and the channel information is not limited to this. That is, for example, the present embodiment may employ an arrangement in which the television 1 provides the smartphone 2 with a notification of an update of the channel list or the channel information every time the channel list is updated for some reason or the selected channel is changed and the smartphone 2 obtains the channel list and the channel information from the television 1 every time the smartphone 2 receives the notification.

The arrangement in which the smartphone 2 receives the channel information from the television 1 every time the channel select operation is carried out also allows the smartphone 2 to use the channel information for the purpose of preventing a repeated tap on the channel button. That is, for example, the smartphone 2 disables a tap operation performed with respect to the channel button corresponding to the notified channel information, in order to avoid the currently selected channel from being selected again. The present invention which employs such an arrangement makes it possible to avoid unnecessary transmission of a control command for switching a channel to another.

(Device Selection Function)

The remote control application can register a plurality of televisions in a television list and allows any television selected by the user from the television list to be set as the operation target device. This section describes a method for registering a television in the television list and a method for deleting a television from the television list. Note that the present section, which assumes that a plurality of televisions are connected to the LAN, gives no reference numeral to a television.

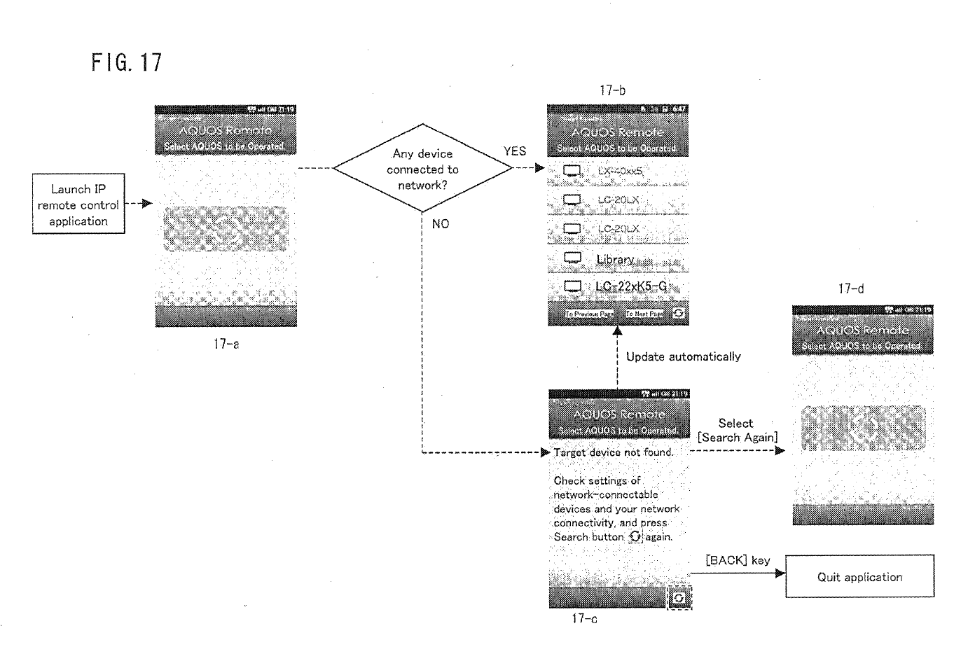

First, the following description discusses, with reference to FIG. 17, how the smartphone 2 operates when the remote control application is launched for the first time.

When the remote control application is launched, the smartphone 2 searches for a television connected to the LAN (especially a television including provisions for the remote control application). While searching for a television, the smartphone 2 displays a progress screen 17-a. In a case where it is possible to find a television connected to the LAN, the smartphone 2 registers the found television in the television list. Then, the smartphone 2 displays a device selection screen 17-b that is a list in which device names (or may be friendly names) of televisions registered in the television list are list items. In a case where it is impossible to find a television connected to the LAN, the smartphone 2 displays (i) a message indicating that it is impossible to find a television to be set as the operation target device and (ii) a dialog screen 17-c asking the user a question whether or not to carry out the search again. When the user gives the question an instruction to carry out the search again, the smartphone 2 searches again for a television connected to the LAN, and repeats the process described above. Meanwhile, when the user gives the question an instruction not to carry out the search again, the smartphone 2 ends the remote control application.

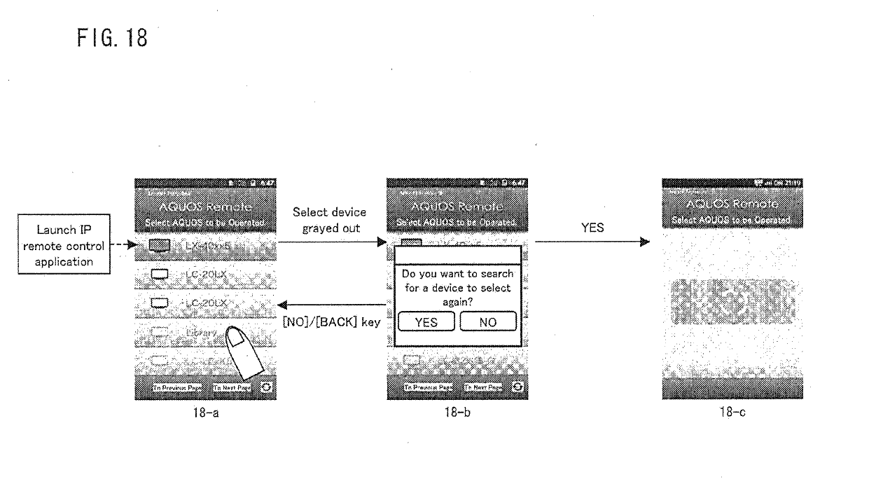

Next, the following description discusses, with reference to FIG. 18, how the smartphone 2 operates when the remote control application is launched for the second time or subsequent times.

When the remote control application is launched, the smartphone 2 displays a device selection screen 18-a containing a list in which device names of televisions already registered in the television list are list items. In this case, the smartphone 2 highlights a device name of the television that was previously selected as the operation target device. Further, in this case, the smartphone 2 grays out a device name of a television that is not connected to the LAN, out of the televisions already registered in the television list. Then, in response to a tap on a list item corresponding to the television that is not connected to the LAN on the device selection screen 18-a, the smartphone 2 displays, on a device selection screen 18-b, a pop-up dialog asking the user a question of whether or not to carry out the search again. When the user provides the smartphone 2, in response to such a question, with an instruction to carry out the search again, the smartphone 2 searches the LAN for a television corresponding to the selected list item, and repeats the process illustrated in FIG. 17.

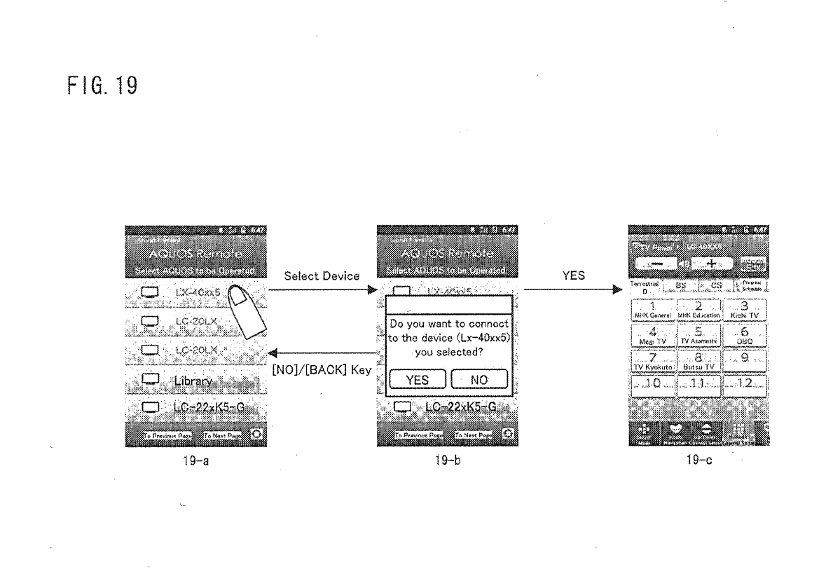

Next, the following description discusses, with reference to FIG. 19, how the smartphone 2 operates so as to select, from the device selection screen, a television to be set as the operation target device.

When any of the list items is tapped on a device selection screen 19-a, the smartphone 2 displays, on a device selection screen 19-b, a pop-up dialog asking the user a question of whether or not to give a permission for setting of a television corresponding to the tapped list item as the operation target device. When the user provides, with the smartphone 2, an instruction to give a permission in response to the question, the smartphone 2 sets, as the operation target device, the television corresponding to the tapped list item, and displays a remote control top screen 19-c.

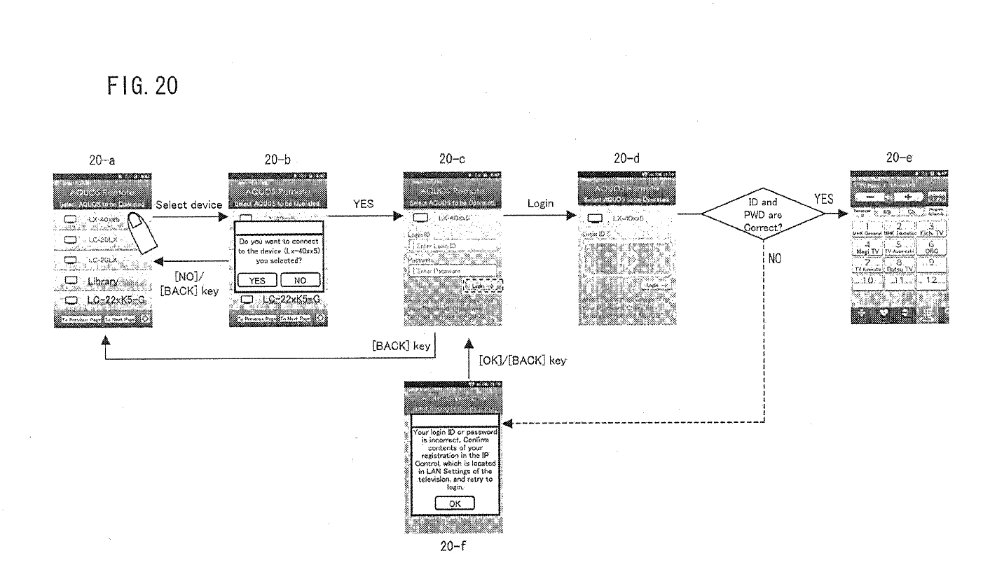

Note that in order to prevent an unintended operation from being carried out, the present embodiment may employ an arrangement in which a television authenticates the smartphone 2. FIG. 20 illustrates how the smartphone 2 operates in such an arrangement.

When any of the list items is tapped on a device selection screen 20-a, the smartphone 2 displays, on a device selection screen 20-b, a pop-up dialog asking the user a question of whether or not to give a permission for setting of a television corresponding to the tapped list item as the operation target device. When the user provides, with the smartphone 2, an instruction to give a permission in response to the question, the smartphone 2 displays an authentication screen 20-c. The authentication screen 20-c includes a text field to which a login ID is to be inputted and a text field to which a password is to be inputted. When a “Login” button on the authentication screen 20-c is tapped, the smartphone 2 notifies the television of an inputted login ID and an inputted password. Until the smartphone 2 receives from the television a notification of whether or not the login is permitted, the smartphone 2 displays a progress screen 20-d. When the smartphone 2 is notified by the television that the login is permitted, the smartphone 2 sets, as the operation target device, the television corresponding to the tapped list item, and displays a remote control top screen 20-e. Meanwhile, when the smartphone 2 is notified by the television that the login is not permitted, the smartphone 2 displays a dialog screen 20-f notifying that the login is not permitted.

The search can be carried out again as described above not only at the time of the launch of the remote control application but also at a desired point in time.

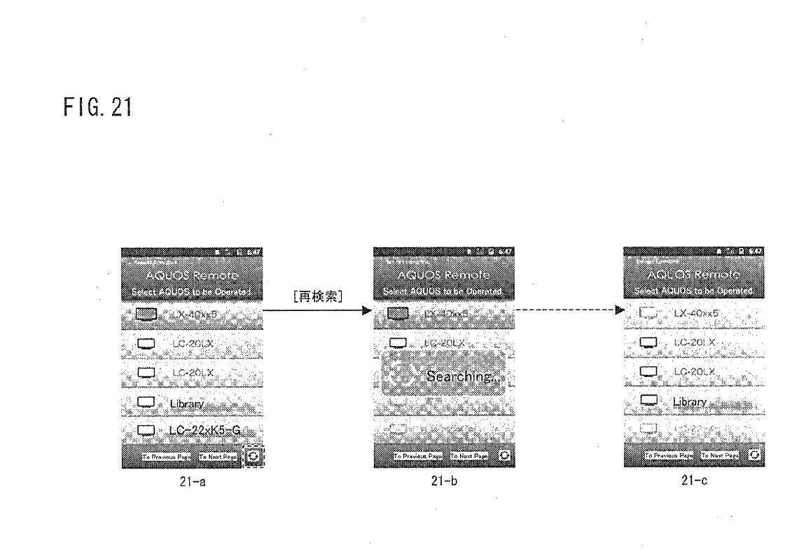

The following description discusses, with reference to FIG. 21, how the smartphone 2 carries out the search again when instructed to do so by the user.

At the bottom right of a device selection screen 21-a, there is provided a search again button, which is indicated by a dotted box. In response to a tap on the search again button, the smartphone 2 makes a new search of the LAN for a television included in the LAN. While making the search, the smartphone 2 displays, on a device selection screen 21-b, a pop-up dialog indicating that the search is being carried out. Upon completion of the search, the smartphone 2 compares a television already registered in the television list and a television found in the new search, and updates a list to be displayed. Specifically, the smartphone 2 (1) grays out a device name of a device that is registered in the television list and cannot not be found in the new search, (2) deselects a television which is selected as the operation target device and whose device name is grayed out, and (3) adds, to the end of the list, a device name of a television that is not registered in the television list and found in the new search.

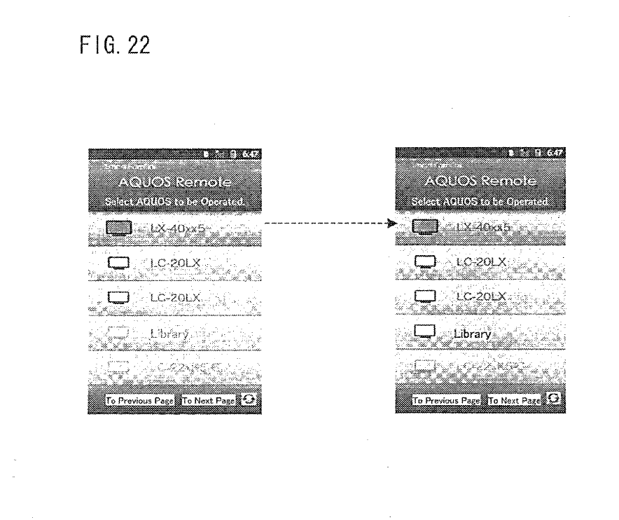

Note that, when the smartphone 2 detects that a television whose device name is indicated in a grayed-out state has established a connection to the LAN while displaying the device selection screen, the smartphone 2 cancels the grayed-out indication of the device name of the television so that the user is notified that the television of interest can be selected as the operation target device (see FIG. 22).

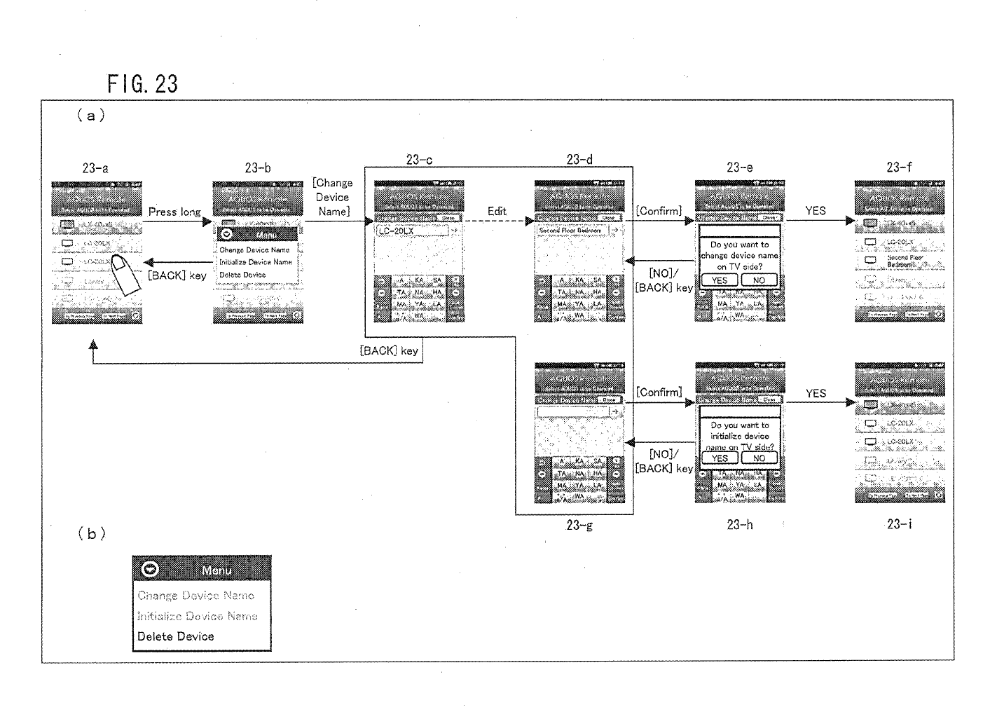

The following description discusses, with reference to FIGS. 23, 24, and 26, how the smartphone 2 operates so as to edit the device names of the respective televisions registered in the television list.

As illustrated in (a) of FIG. 23, when a list item is held on a device selection screen 23-a, the smartphone 2 displays a pop-up menu on a device selection screen 23-b. This pop-up menu includes the following menu items: Change Device Name, Initialize Device Name, and Delete Device. However, if a television corresponding to the held list item is not connected to the LAN, only Delete Device is selectable, and the remaining two unselectable menu items are grayed out as illustrated in (b) of FIG. 23.

When Change Device Name on the pop-up menu is tapped, the smartphone 2 displays a device name input screen 23-c. The device name edit screen 23-c includes a text field and a software keyboard (to the text field, a pre-edit device name is inputted as a default). The user can enter a desired device name to the text field by use of the software keyboard.

When a Confirm key on the software keyboard is tapped in a state in which a new device name is inputted to the text field (on a device name edit screen 23-d), the smartphone 2 displays, on a device name edit screen 23-e, a dialog asking yes or no to the change of the device name to the new device name.

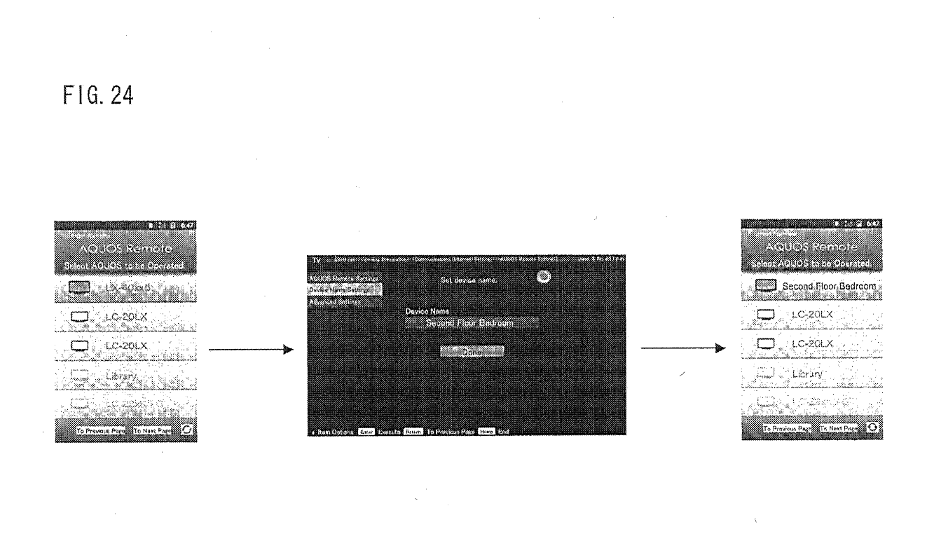

When yes is selected in the dialog, the smartphone 2 transmits, to the television, a control command instructing the television to change the device name to the new device name. The television changes the device name thereof to the new device name device in accordance with the control command, and provides the smartphone 2 with a notification that the device name of the television has been changed to the new device name. Upon receipt of this notification, the smartphone 2 changes, to the new device name, the device name to be displayed on a device name selection screen 23-f. FIG. 24 schematically shows a flow of such a change.

Meanwhile, when the Confirm key on the software keyboard is tapped in a state in which no device name is inputted to the text field (on a device name edit screen 23-g), the smartphone 2 displays, on a device name edit screen 23-h, a dialog asking yes or no to initialization of the device name.

When yes is selected in the dialog, the smart phone 2 transmits, to the television, a control command to initialize the device name. The television resets the device name thereof to a default (e.g., a friendly name of the television) in accordance with the control command, and provides, to the smartphone 2, a notification that the device name of the television has been reset to the default. Upon receipt of this notification, the smartphone 2 changes, to the initial value, the device name to be displayed on a device name selection screen 23-i.

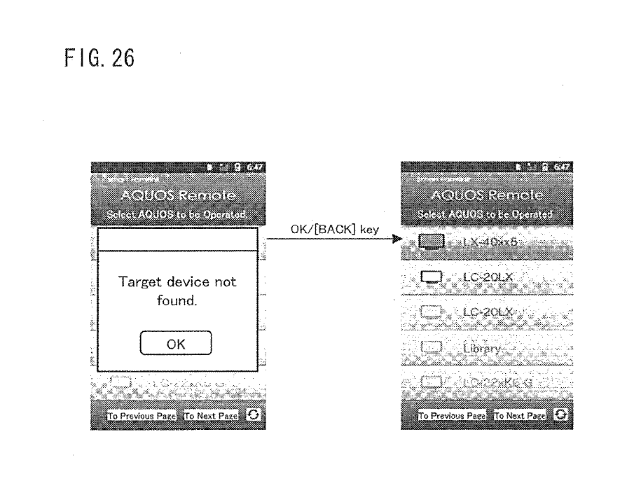

Note that, when the television is disconnected from the LAN during the progress of an edit to the device name, the smartphone 2 displays a pop-up dialog and then changes the device name to be indicated in a grayed-out state (see FIG. 26).

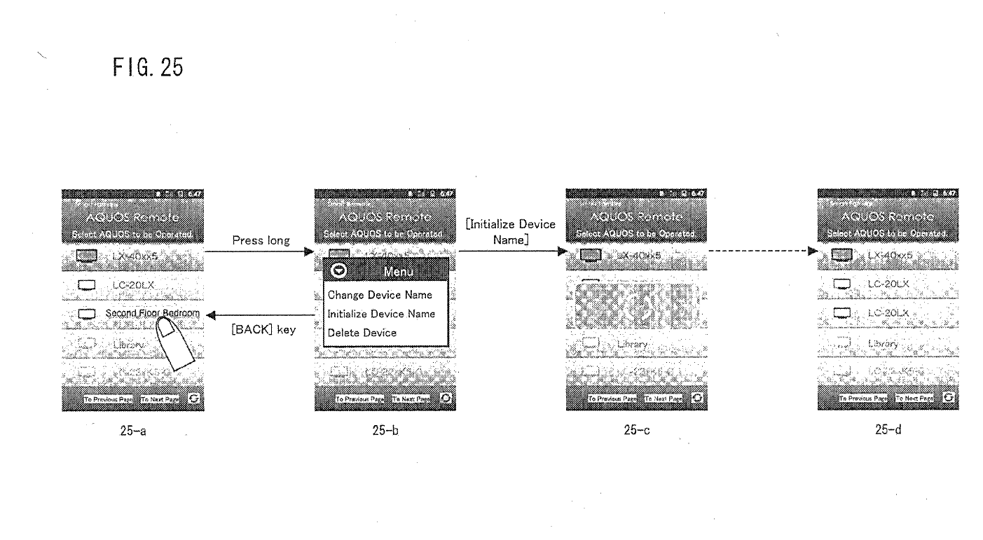

Next, the following description discusses, with reference to FIG. 25, how the smartphone 2 operates so as to initialize the device names of the televisions registered in the television list.

When a list item is held on a device selection screen 25-a, the smartphone 2 displays a pop-up menu on a device selection screen 25-b. As described above, this pop-up menu includes the following menu items: Change Device Name, Initialize Device Name, and Delete Device.

When Initialize Device Name is tapped on the pop-up menu, the smartphone 2 transmits, to the television, a control command instructing to initialize the device name, and displays, on a device selection screen 25-c, a pop-up dialog indicating that the device name is being initialized. The television resets the device name thereof to a default (e.g., a friendly name of the television) in accordance with the control command, and provides, to the smartphone 2, a notification that the device name of the television has been reset to the default. Upon receipt of this notification, the smartphone 2 changes, to the default, the device name to be displayed on a device name selection screen 25-d.

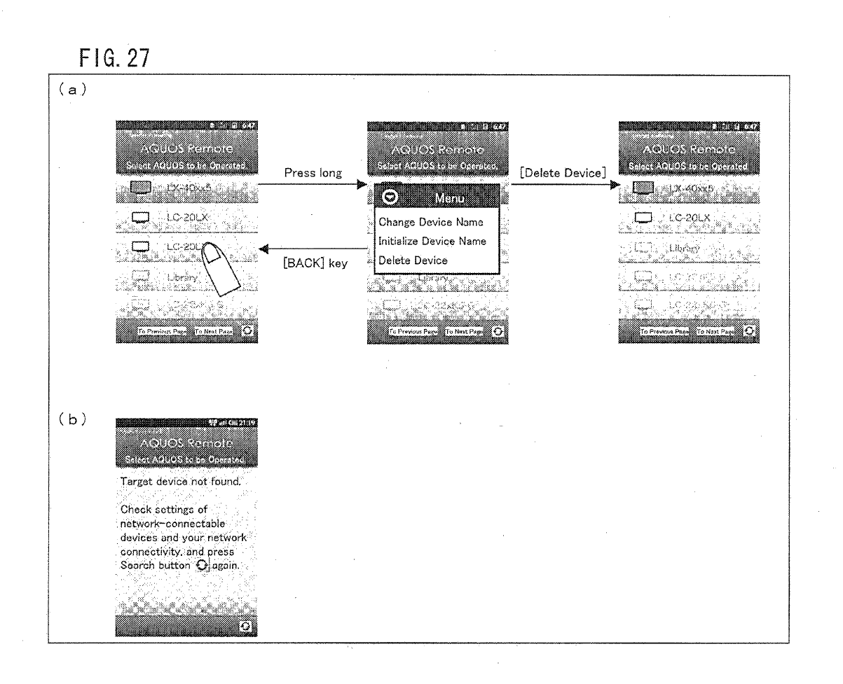

Next, the following description discusses, with reference to FIG. 27, how the smartphone 2 operates so as to delete a television from the television list.

As illustrated in (a) of FIG. 27, when a list item is held on a device selection screen, the smartphone 2 displays a pop-up menu on the device selection screen. When Delete Device of the pop-up menu is tapped, the smartphone 2 deletes, from the television list, a television corresponding to the held list item. Further, the smartphone 2 deletes the held list item from the device selection screen, and moves up a list item located below the deleted list item. Note that, when all the televisions are deleted from the television list, the smartphone 2 displays a dialog screen of (b) of FIG. 27 so as to prompt the search to be carried out again.

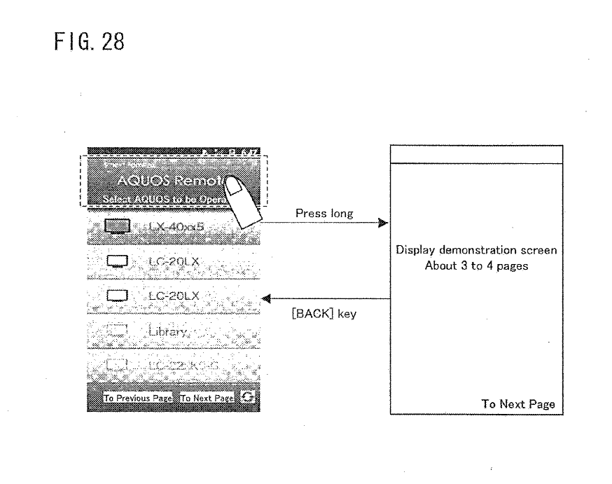

Note that, when a logo of “AQUOS Remote” is held on the device name selection screen, the smartphone 2 displays a demonstration screen as illustrated in FIG. 28.

(Keyword Search Function)

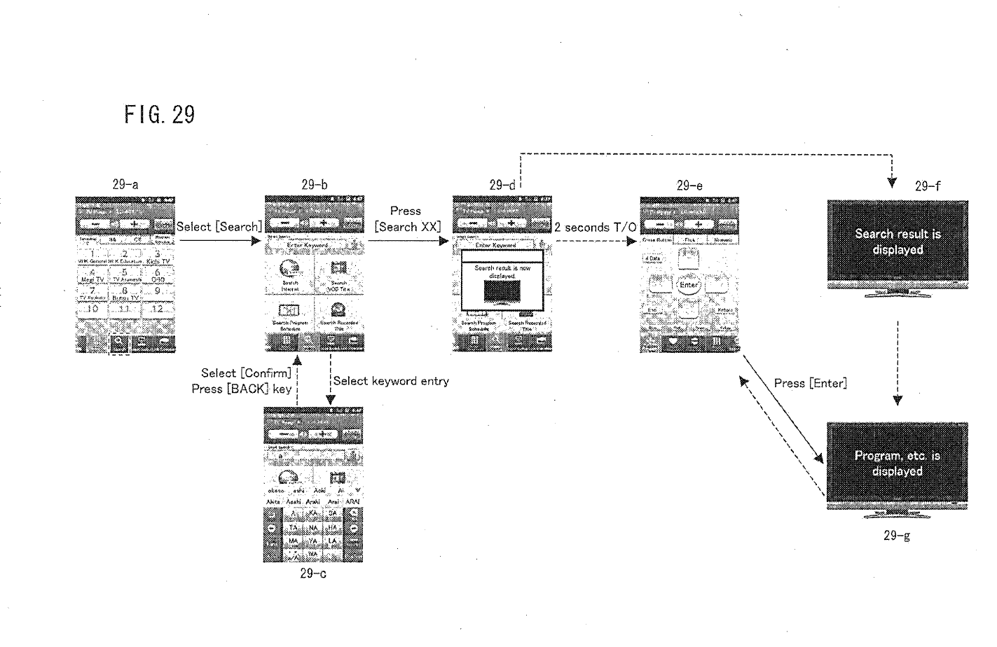

The following description will discuss a keyword search (seamless search) function of the smartphone 2 of the present invention, with reference to FIGS. 29 through 32. FIG. 29 is a screen transition diagram illustrating an example flow of the keyword search function of the smartphone 2.

As illustrated in FIG. 29, it is assumed that a screen 29-a (remote control top screen) for operating the television 1 is already displayed on the screen of the smartphone 2. When the user selects a “Search” tab in a lower part of the screen 29-a, the smartphone 2 switches the screen to a screen 29-b (search screen). When the user selects “Keyword Entry” on the screen 29-b, the smartphone 2 switches the screen to a screen 29-c. A method for entering characters on the screen 29-c will be described in detail in (How to Enter Characters) below.

When the user enters a character string to be searched for (search character string) and then selects “Confirm” on the screen 29-c, the smartphone 2 switches the screen to the screen 29-b. In this case, the character string thus confirmed is displayed in a character entry frame 301.

When the user presses a [BACK] key on the screen 29-c, the screen of the smartphone 2 returns to the screen 29-b.

When the user has confirmed the search character string and then presses any of four buttons (i.e., “Search Internet”, “Search VOD Title”, “Search Program Schedule”, and “Search Recorded Title”) on the screen 29-b, the smartphone 2 transmits, to the television 1, (i) the search character string and (ii) an instruction command on searching. Moreover, the smartphone 2 displays a screen (screen 29-d) including a message indicating that the search result is being displayed on the television 1. Here, “Search Internet” indicates a search for a content matching the search character string through a web content(s) stored in a web server. “Search VOD Title” indicates a search for a content matching the search character string through a VOD content(s) stored in a VOD server. “Search Program Schedule” indicates a search for a content matching the search character string through a broadcast program(s) listed on an electronic program schedule. “Search Recorded Title” indicates a search for a content matching the search character string through a recorded content(s) recorded on the television 1 or on a recorder connected with the television 1.

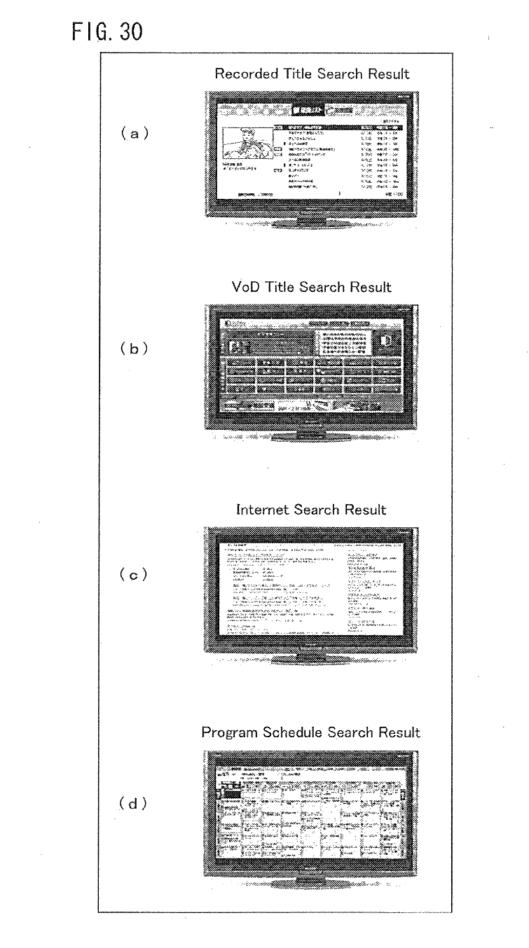

Upon receipt of a command from the smartphone 2, the television 1 searches a search character string through corresponding contents, and then displays a search result (screen 29-f). Here, examples of the screen 29-f are illustrated in FIG. 30.

Each of (a) through (d) of FIG. 30 illustrates an example screen of the television 1 indicating a search result obtained by the search of the character string. (a) of FIG. 30 is a screen example of the television 1 indicating a search result obtained when the user has selected “Search Recorded Title”. (b) of FIG. 30 is a screen example of the television 1 indicating a search result obtained when the user has selected “Search VOD Title”. (c) of FIG. 30 is a screen example of the television 1 indicating a search result obtained when the user has selected “Search Internet”. (d) of FIG. 30 is a screen example of the television 1 indicating a search result obtained when the user has selected “Search Program Schedule”. As such, the television 1 displays a search result obtained by a search of a search character string through the contents.

Subsequently, (i) upon receipt of a notification from the television 1 that the display of the search result is completed or (ii) upon lapse of two seconds after the smartphone 2 has displayed the screen 29-d illustrated in FIG. 29, the smartphone 2 ends the keyword search and switches the screen to a screen 29-e. The screen 29-e is an operation panel in a “Cross Button” mode.

Note that, subsequently, even in a case where the user selects any of tabs on the lower part of the screen and accordingly the smartphone 2 switches the screen to a screen other than the operation panel, the search result screen on the television 1 does not end.

When the user selects an intended content from the search result displayed on the television 1 and then presses “Enter” on the screen 29-e, the television 1 displays the selected content (screen 29-g). Subsequently, the smartphone 2 switches the screen in accordance with an instruction from the television 1.

Note that, in a case where no search character string is entered by the user, the four buttons are grayed out so as to indicate that the four buttons are not usable.

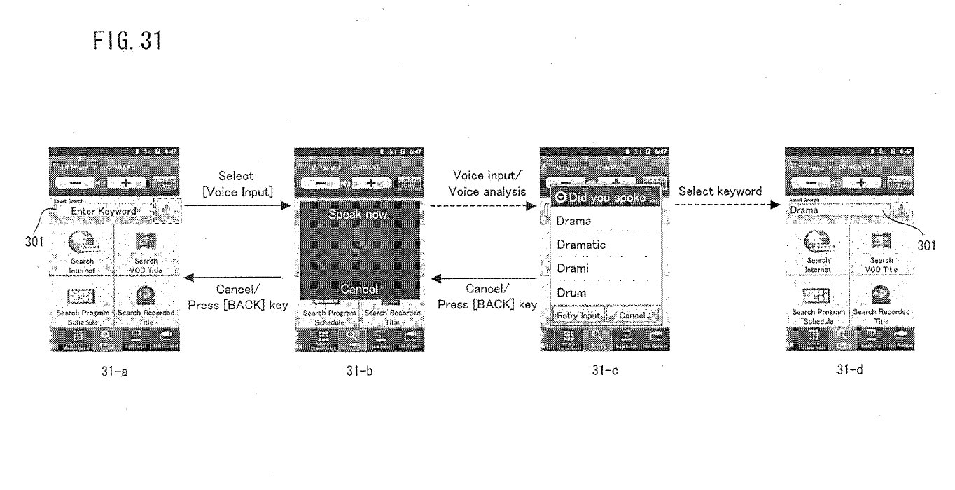

Note that a search character string can be entered by voice input. FIG. 31 is a screen transition diagram illustrating a flow of entering a search character string by voice input.

As illustrated in FIG. 31, when the user selects a voice input on a screen 31-a, the smartphone 2 switches the screen to a screen 31-b (voice input screen) for carrying out voice input. When the user inputs a voice to the smartphone 2, the smartphone 2 analyzes the voice and displays a screen (screen 31-c) including a list of candidates for character strings matching the voice inputted by the user. In a case where a character string matching the voice inputted by the user are not shown in the list on the screen 31-c, the screen of the smartphone 2 returns to the voice input screen when the user presses a re-input button.

When the user selects a character string on the screen 31-c, the smartphone 2 changes the screen 31-c to a screen 31-d in which the selected character string is displayed in the character entry frame 301. For example, in a case where the user has selected “Drama” on the screen 31-c, the character string “Drama” is displayed in the character entry frame 301 in the screen 31-d.

As such, the search character string can be entered by the voice input.

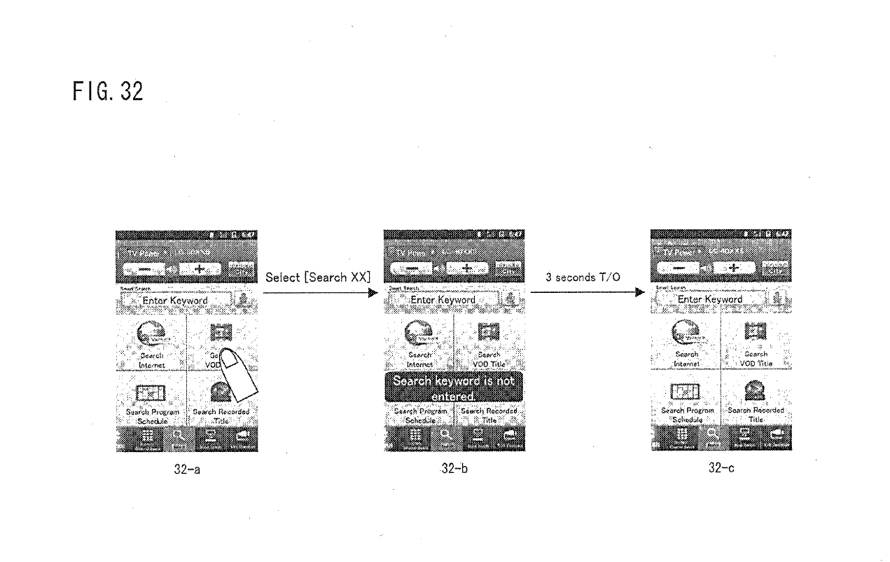

Next, the following description will discuss, with reference to FIG. 32, a flow in which the user has pressed any of the four buttons without entering a search character string. FIG. 32 is a screen transition diagram illustrating an example flow of the keyword search function in a case where no search character string is entered.

As illustrated in FIG. 32, when the user has pressed any of the four buttons on the screen 32-a without entering a search character string, the smartphone 2 displays a message indicating that no search character string is entered. For example, a message “Search keyword is not entered” is displayed as in a screen 32-b. Note that the message to be displayed is not limited to this.

Upon lapse of three seconds after the screen 32-b has been displayed, the smartphone 2 switches the screen 32-b to the screen 32-c.

(Input Switching Function)

The television 1 is connected with a plurality of source devices so that the television 1 can display video images supplied from the plurality of source devices. Moreover, the smartphone 2 instructs the television 1 to switch the plurality of source devices, any of which is to be selected as an input source, so that a source device which has been selected as the input source can be operated via the television 1.

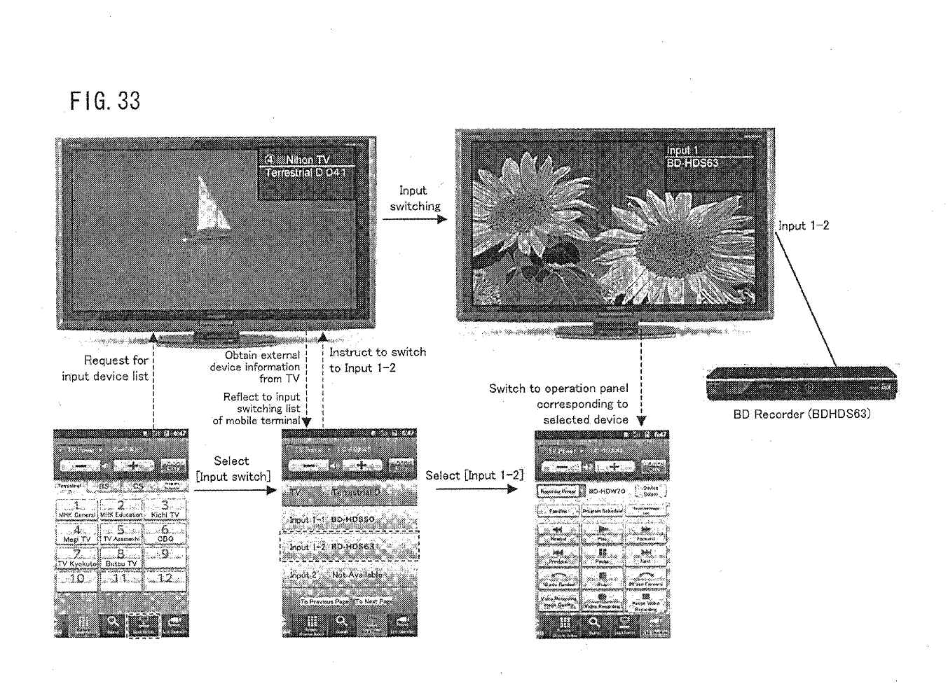

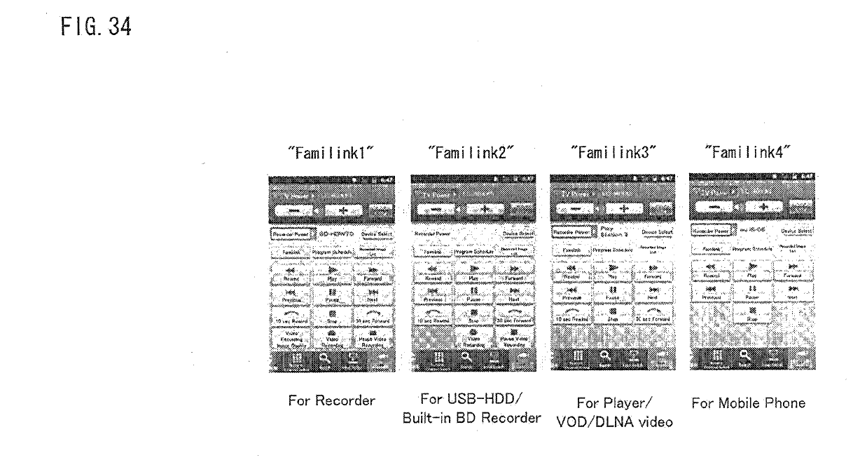

The following description will discuss how the plurality of source devices are switched with the use of the smartphone 2, with reference to FIGS. 33 and 34.

FIG. 33 is a view schematically illustrating how the plurality of source devices are switched with the use of the smartphone 2.

When an input switching area of the display switching tab is tapped, the smartphone 2 sends, to the television, a request for an input device list (data) which is a list of the plurality of source devices connected with the television 1. In response to the request, the television 1 generates an input device list (data), and supplies the input device list (data) to the smartphone 2.

Upon receipt of the input device list (data), the smartphone 2 switches a panel to be displayed on the screen to an input switching panel. The input switching panel is a list (GUI element) of list items which are device names of the respective source devices connected with the television 1. The smartphone 2 generates the input switching panel with reference to the input device list (data) obtained from the television 1.

When any of the list items included in the input switching panel is tapped, the smartphone 2 transmits, to the television 1, a control command instructing to select, as an input source, a source device which corresponds to the tapped list item. In accordance with the control command, the television 1 selects the source device and then notifies the smartphone 2 of the selected source device.

Upon receipt the notification from the television 1, the smartphone 2 switches the panel to be displayed on the screen from the input switching panel to a link operation panel. The link operation panel is an operation panel specialized for performing an operation of a source device which is notified from the television 1.

FIG. 34 is a view illustrating an example of the link operation panel. In FIG. 34, link operation panels for a recorder, for USB-HDD/built-in BD player, for player/VOD/DLNA video, and a mobile phone terminal, respectively, are illustrated from the left. For example, in a case where the television provides, to the smartphone 2, a notification that the recorder has been selected as the input source, the smartphone 2 displays the link operation panel for the recorder as a link operation panel specialized for performing an operation of the recorder.

The link operation panel has various kinds of buttons for operating a corresponding source device. For example, the link operation panel for the recorder has a video recording button. When the video recording button is tapped, the smartphone 2 transmits, to the television 1, a control command instructing to start recording a video. The television 1 converts the control command into a CEC command, and then transmits the CEC command to the recorder which is HDMI-connected with the television 1.

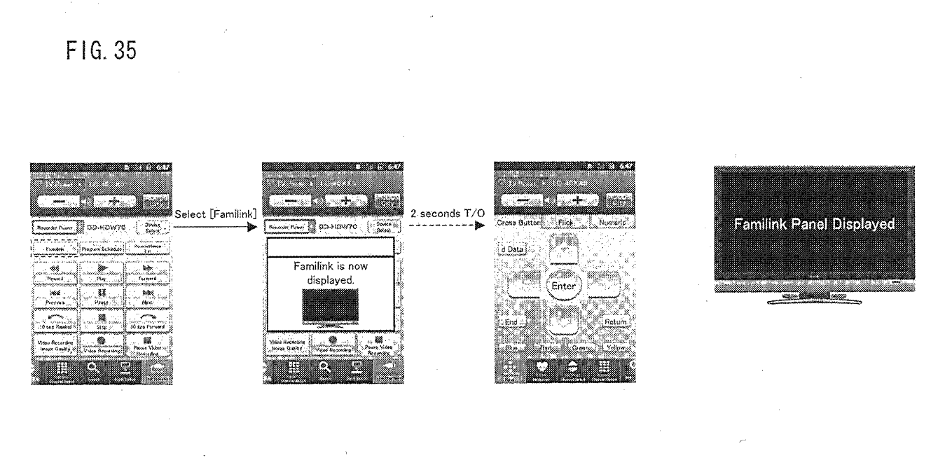

The following description will discuss a FAMILINK operation of a source device, with reference to FIG. 35. Here, the FAMILINK operation refers to an operation mode for controlling a source device by (i) controlling the television 1 to display an operation panel (hereinafter, referred to as “FAMILINK panel”) for operating the source device and (ii) operating the FAMILINK panel with a remote controller.

When a FAMILINK button provided in the link operation panel is tapped, the smartphone 2 (i) transmits, to the television 1, a control command instructing to display the FAMILINK panel and (ii) displays a pop-up message, which indicates a start of the FAMILINK operation, on the link operation panel. In accordance with the control command transmitted from the smartphone 2, the television 1 (i) starts displaying the FAMILINK panel and (ii) notifies the smartphone 2 of the start of displaying the FAMILINK panel. Upon receipt of the notification, the smartphone 2 switches the panel displayed on the screen to an operation panel in a cross button mode. This allows a person to operate the FAMILINK panel with the use of the smartphone 2 with the same feeling as operating the FAMILINK panel with the use of an infrared remote controller.

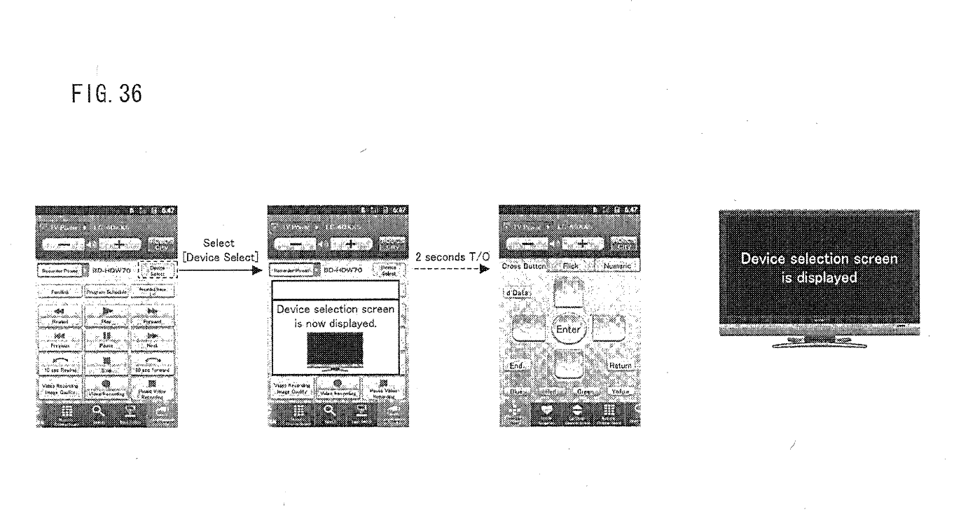

The following description will discuss how a source device is selected with the use of a device selection screen displayed on the television 1, with reference to FIG. 36.

When a device selection button provided in the link operation panel is tapped, the smartphone 2 (i) transmits, to the television 1, a control command instructing to display the device selection screen and (ii) displays a pop-up message, which indicates a start of a device selecting operation, on the link operation panel. In accordance with the control command transmitted from the smartphone 2, the television 1 (i) starts displaying the device selection screen and (ii) notifies the smartphone 2 of the start of displaying the device selection screen. Upon receipt of the notification, the smartphone 2 switches the panel to be displayed on the screen to the operation panel in the cross button mode. This allows a person to operate the device selection screen with the use of the smartphone 2 with the same feeling as operating the device selection screen with the use of an infrared remote controller.

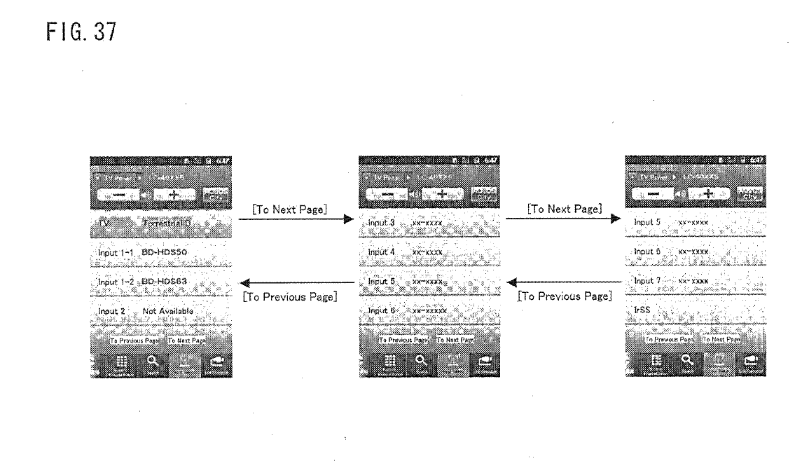

The following description will discuss the above-mentioned input switching panel with reference to FIG. 37.

The input switching panel is a list of multiple pages each of which includes four list items. By tapping a page forward button or a page back button provided below the list items, it is possible to switch a page to be displayed. Note that, whichever page is displayed, the smartphone 2 always displays four list items without a space so that unnecessary page switching does not occur as much as possible. For example, in a case where six list items exist, first through fourth list items are displayed on the first page, and third through sixth list items are displayed on the second page. In this case, the third and fourth list items can be accessed via both the pages, and it is therefore unnecessary to switch the page for selecting the third and fourth list items.

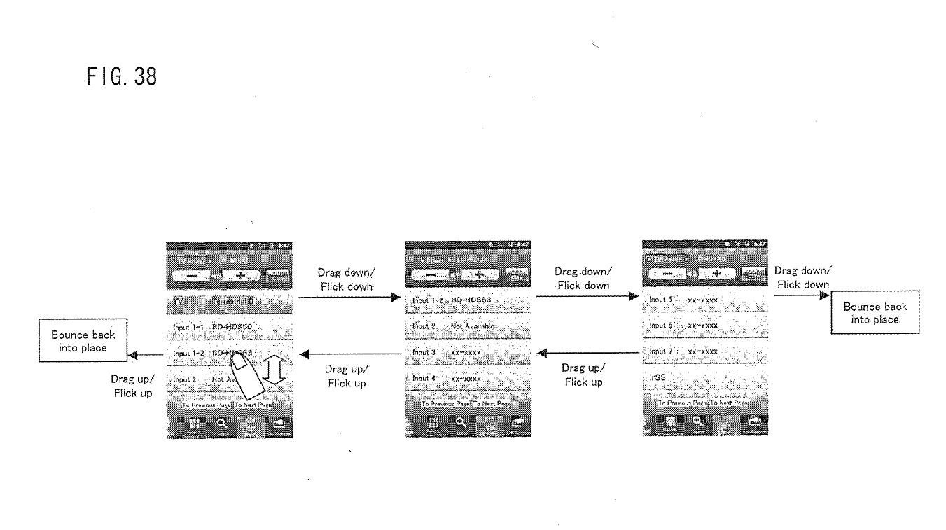

In this case, the input switching panel is the list of the multiple pages. Note, however, that the input switching panel is not limited to this. That is, as illustrated in FIG. 38, the input switching panel can be a list which can be scrolled by a flick or drag operation.

(Simple Navigation Function)

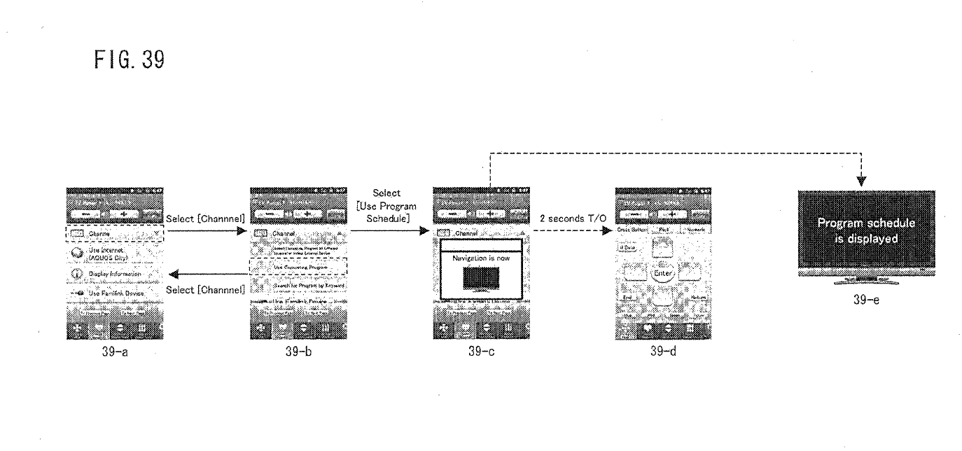

The following description will discuss a simple navigation function of the smartphone 2 of the present invention, with reference to FIGS. 39 through 42. FIG. 39 illustrates an example screen flow in the simple navigation function of the smartphone 2.

As illustrated in FIG. 39, when the user selects “Channel” on a screen 39-a (simple navigation) of the smartphone 2, the smartphone 2 displays detailed process contents (i.e., a second hierarchy level of simple navigation) of “Channel” (screen 39-b). When “Channel” is selected again on the screen 39-b, the smartphone 2 displays the screen 39-a again.

Here, in the screen 39-b, an upward triangle is displayed on a right side of “Channel”. The upward triangle indicates that a second hierarchy level of an item, for which the upward triangle is displayed, is not to be displayed (i.e., is to be closed). Meanwhile, in the screen 39-a, a downward triangle displayed on the right side of “Channel” indicates that a second hierarchy level of an item, for which the downward triangle is displayed, is to be displayed (i.e., is to be opened).

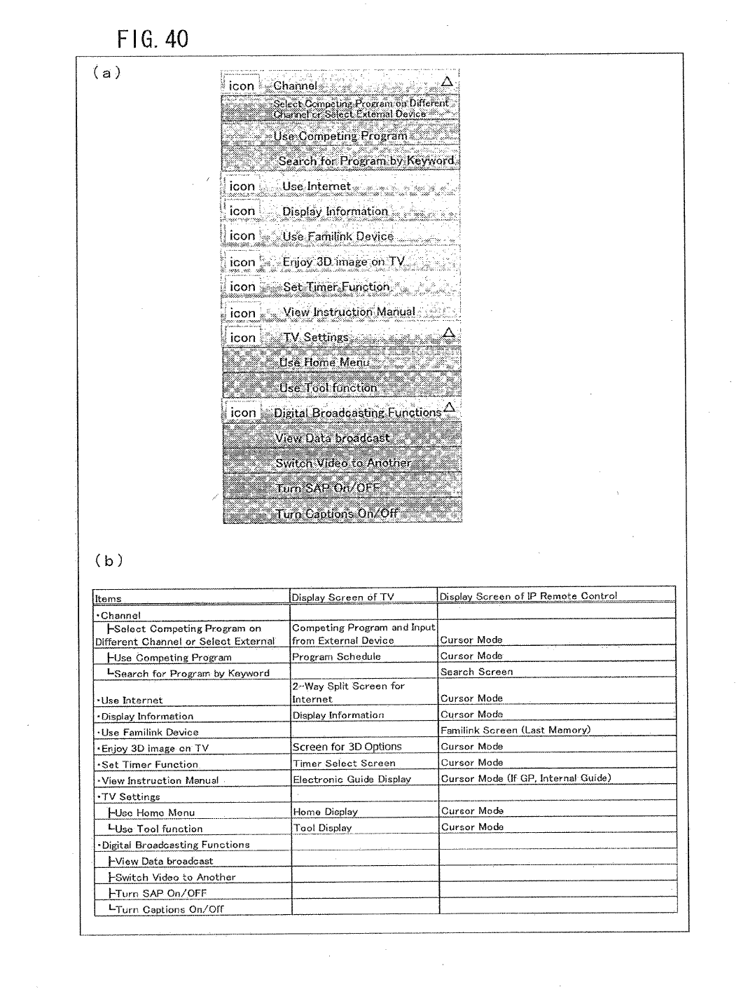

(a) of FIG. 40 illustrates example items which are displayed on a screen of the simple navigation function. Hereinafter, each of items displayed on an initial screen of the simple navigation is referred to as “first hierarchy level item”, and each of items displayed when the first hierarchy level item is selected is referred to as “second hierarchy level item”. (a) of FIG. 40 illustrates the items which are displayed on the screen for the simple navigation. Note that icons are displayed on the left side of the respective first hierarchy level items, while no icons are displayed for the second hierarchy level items.

When (i) the user selects a tab on the lower part of the screen 39-b, then (ii) the smartphone 2 thereby switches the screen 39-b to another screen (e.g., the operation panel), and then (iii) the user selects the simple navigation again, the smartphone 2 displays a screen in a previous state. That is, the smartphone 2 displays the screen 39-b instead of the screen 39-a.

Next, when the user selects “Use Program Schedule” on the screen 39-b, the smartphone 2 transmits, to the television 1, a command instructing to display the program schedule. Moreover, the smartphone 2 displays, on the screen (screen 39-c), a message indicating that the simple navigation is displayed on the television 1.

After that, the television 1 displays the program schedule as in a screen 39-e. Upon receipt of a notification from the television 1 that the program schedule has been displayed, or upon lapse of two seconds after the smartphone 2 has displayed the screen 39-c, the smartphone 2 ends the simple navigation and displays a screen 39-d (i.e., an operation panel in the “Cross Button” mode).

(b) of FIG. 40 illustrates an example of screens on the television 1 and screens on the smartphone 2 which screens are displayed in association with the items displayed for the simple navigation.

As illustrated in (b) of FIG. 40, the television 1 displays a list of contents (e.g., the program schedule) corresponding to an item. Moreover, when the list of contents is displayed on the television 1, the smartphone 2 displays the operation panel in the “Cross Button” mode. Alternatively, when “Search Program by Keyword” is selected, the smartphone 2 displays a search screen. Alternatively, when “Use FAMILINK function” is selected, the smartphone 2 displays a FAMILINK screen. Note that the items displayed for the simple navigation are not limited to those above described.

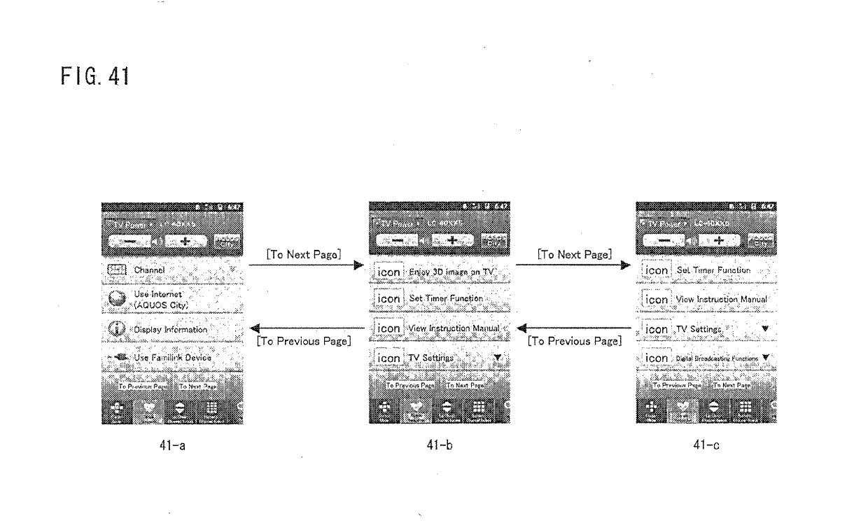

Note that not all the items for the simple navigation are displayed in one (1) screen of the smartphone 2. In view of this, FIG. 41 illustrates a plurality of examples of items displayed for the simple navigation.

As illustrated in FIG. 41, the smartphone 2 displays a list which is a GUI element for use in selecting an item for the simple navigation. The items for the simple navigation which items are shown in the list are split across a plurality of pages so that each of the pages displays some of the items (screen 41-a). In the screen 41-a, four items for the simple navigation are displayed in a list form. Note, however, that the number of items to be displayed is not limited to this. Below the items, a “Previous Page” button for displaying a previous page and a “Next Page” button for displaying a next page are displayed. In a case where a displayed screen is the initial page as the screen 41-a, the “Previous Page” button is grayed out so as to indicate that the “Previous Page” button is not usable.

When the user selects the “Next Page” on the screen 41-a, the smartphone 2 displays subsequent four items (screen 41-b). When the user selects the “Previous Page” on the screen 41-b, the smartphone 2 displays the previous page, i.e., the screen 41-a.

When the user selects “Next Page” on the screen 41-b, the smartphone 2 displays further subsequent four items. In a case where a displayed screen is the last page as the screen 41-c, the “Next Page” button is grayed out so as to indicate that the “Next Page” button is not usable.

Note that, in displaying the initial page, the smartphone 2 displays the items such that an initial item is displayed on top of the list. Alternatively, in displaying the last page, the smartphone 2 displays the items such that a last item is displayed on bottom of the list. That is, the smartphone 2 displays the items on the screen such that no space appears above and below the list.

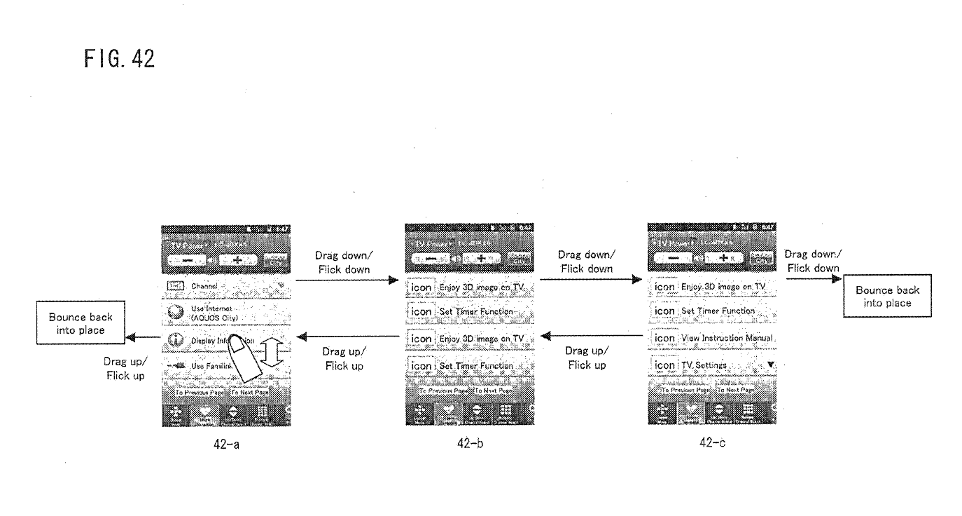

The plurality of items for the simple navigation can be scrolled by an upward/downward drag or a flick. FIG. 42 illustrates another example display of the plurality of items for the simple navigation.

When the user drags or flicks downwards the screen 42-a in which four items are displayed, the smartphone 2 displays the screen 42-b which is the page including subsequent items. The items displayed on the screen 42-b vary depending on whether a drag or a flick is carried out. On the smartphone 2, the items can be scrolled row by row by dragging. Moreover, on the smartphone 2, a scrolling amount can be adjusted by strength of flicking.

When the user drags or flicks upwards the screen 42-b, the smartphone 2 displays a screen (e.g., the screen 42-a) which is obtained by scrolling upwards.

When the user drags or flicks downwards the screen 42-b, the smartphone 2 displays a screen (e.g., the screen 42-c) which is obtained by further scrolling downwards.

In a case where the screen 42-a is the initial page and the user drags or flicks upwards, the screen 42-a bounces back into place. In a case where the screen 42-c is the last page and the user drags or flicks downwards, the screen 42-c bounces back into place.

In a case where a displayed screen is the initial page as the screen 42-a, the “Previous Page” button is grayed out. Similarly, in a case where a displayed screen is the last page as the screen 42-c, the “Next Page” button is grayed out.

(Operation Panel)

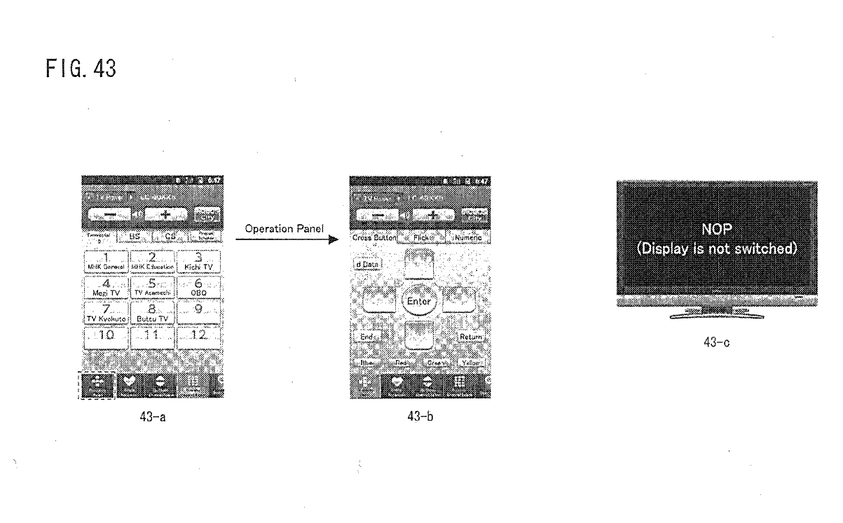

The following description will discuss the operation panel displayed on the smartphone 2 of the present invention, with reference to FIGS. 43 through 45. FIG. 43 is a screen transition diagram illustrating an example flow of display of the operation panel on the smartphone 2.

As illustrated in FIG. 43, it is assumed that a screen 43-a (remote control top screen) for operating the television 1 is already displayed on the screen of the smartphone 2. When the user selects an “Operation Panel” tab in a lower part of the screen 43-a, the smartphone 2 switches the screen to the screen 43-b (operation panel). In this case, a display on the television is not switched as in a screen 43-c.

In this case, on the screen 43-b, the “Cross Button” mode is shown. Note, however, that a mode to be shown in the operation panel is not limited to this. For example, the present embodiment may employ an arrangement in which the screen like the screen 43-b of the “Cross Button” mode is displayed only at the initial launch, and a screen of a mode which was previously displayed is displayed at the second or subsequent launch.

In the screen 43-b, buttons such as [d-Data], [End], [Return], and four color (i.e., red, blue, yellow, and green) buttons are displayed. These buttons depend on information notified from the television 1. That is, in a case where switching to another channel has been carried out, buttons usable for the channel are notified from the television 1 to the smartphone 2, and the smartphone 2 displays the buttons thus notified. Moreover, an action made by pressing these buttons depends on actions of the television 1.

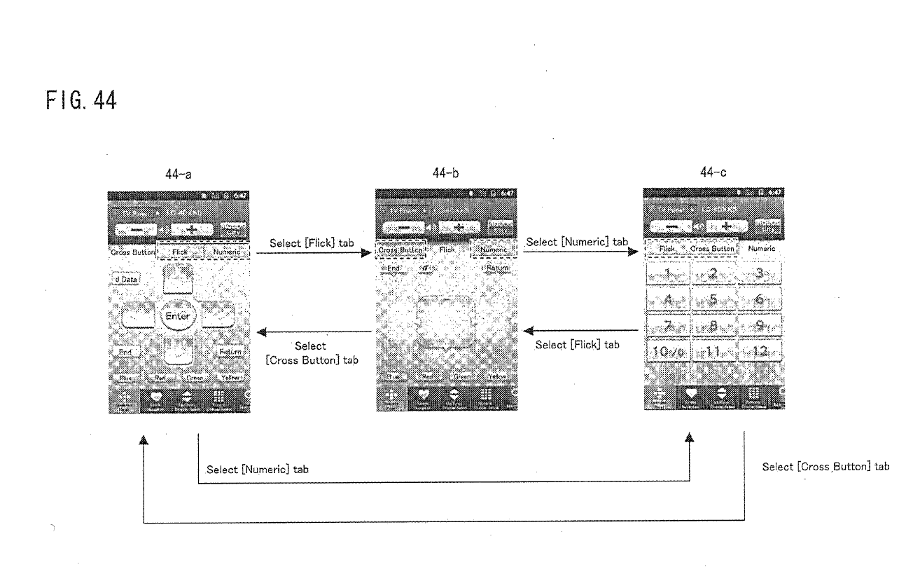

Next, the following description will discuss modes in which the operation panel can be displayed, with reference to FIG. 44. FIG. 44 illustrates an example of modes in which the operation panel of the smartphone 2 can be displayed.

As illustrated in FIG. 44, the operation panel can be displayed in three modes, i.e., a “Cross Button” mode, a “Flick” mode, and a “Numeral” mode. At the initial launch (i.e., a default), a screen like a screen 44-a in the “Cross Button” mode is displayed on the smartphone 2. Here, the operation panel in the “Cross Button” mode indicates a GUI specialized for moving a cursor.

When a “Flick” tab on the screen 44-a is selected, a screen like a screen 44-b in the “Flick” mode is displayed on the smartphone 2. How the screen of the operation panel in the “Flick” mode moves will be described later.

Alternatively, when a “Numeral” tab on the screen 44-a is selected, the smartphone 2 displays a screen like a screen 44-c in the “Numeral” mode. Here, the operation panel in the “Numeral” mode indicates a GUI in which numerals are displayed together with buttons.

Similarly, when a “Cross Button” tab on the screen 44-b is selected, the smartphone 2 displays a screen in the “Cross Button” mode. When the “Numeral” tab on the screen 44-a is selected, the smartphone 2 displays the screen in the “Numeral” mode.

When the “Flick” tab on the screen 44-c is selected, the smartphone 2 displays the screen in the “Flick” mode. When the “Cross Button” tab on the screen 44-c is selected, the smartphone 2 displays the screen in the “Cross Button” mode.

In a case where (i) the user selects a tab in a lower part of the screen in any of the modes of the operation panel, then (ii) the screen of the smartphone 2 is thereby switched to another screen (e.g., the simple navigation), and then (iii) the user selects the operation panel again, the smartphone 2 displays a screen of a previous state. That is, in a case where (i) the screen shown in the “Flick” mode on the smartphone 2 is switched to the screen for the simple navigation, and then (ii) the screen is switched back to the screen of the operation panel, the smartphone 2 displays the operation panel in the “Flick” mode.

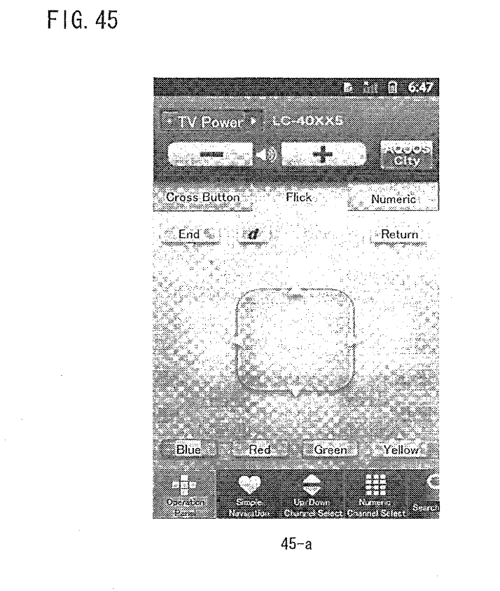

Next, the following description will discuss how the operation panel is operated in the “Flick” mode, with reference to FIG. 45.

When a flick area is flicked upwards on a screen 45-a in the “Flick” mode, an operation, which is carried out by an up-button in the “Cross Button” mode, can be carried out. Similarly, when the flick area is flicked downwards, rightwards, and leftwards, operations, which are carried out by pressing a down-button, a right-button, and a left-button, respectively, can be carried out. In a case where there exists a location which can be focused, the focus is determined when the user touches twice (i.e., double tap) the flick area. Note that, here, the flick area indicates a rounded quadrangular area provided in a center of the screen 45-a.

When the user flicks the [d-Data] button rightwards, the [d-Data] button is selected. Similarly, when the user flicks the [Return] button rightwards, the [Return] button is selected.

When the user flicks the [End] button downwards, the [End] button is selected. Moreover, when the user flicks any one of the four color (red, blue, yellow, green) buttons (e.g., red) upwards, the one of the four color buttons (in this example, red) is selected.

(Option Menu)

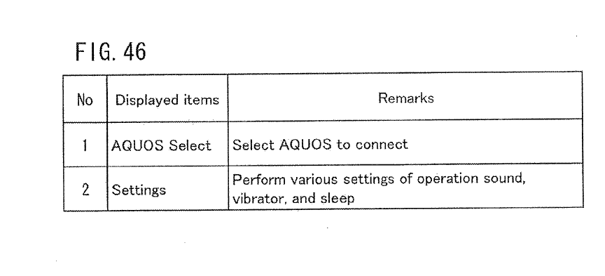

The following description will discuss an option menu of the smartphone 2 of the present invention, with reference to FIGS. 46 through 49. FIG. 46 illustrates an example of the option menu in the smartphone 2.

As illustrated in FIG. 46, the smartphone 2 has (i) an option of “AQUOS Select” for selecting an AQUOS to be connected and (ii) an option of “Settings” for setting various functions such as an operation sound, a vibrator, and a sleep. Note that the options that the smartphone 2 has are not limited to those above described.

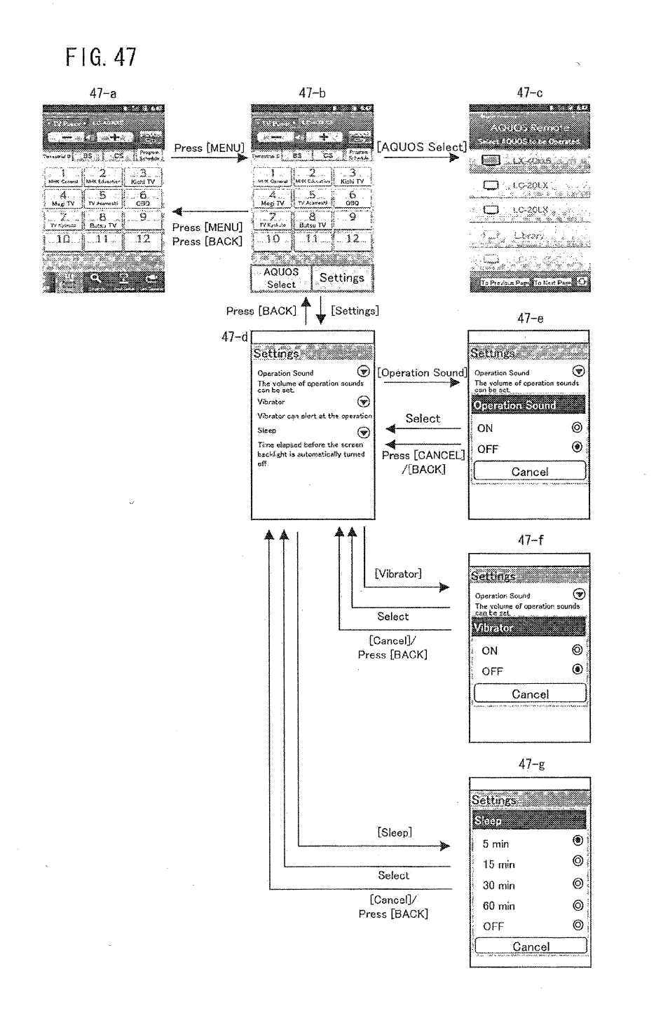

Next, a flow of operating the option menu will be described with reference to FIG. 47. FIG. 47 is a screen transition diagram illustrating an example flow of operating the option menu.

As illustrated in FIG. 47, it is assumed that a screen 47-a (remote control top screen) for operating the television 1 is already displayed on the screen of the smartphone 2.

When the user presses a [MENU] key on the screen 47-a, the smartphone 2 displays the option menu (screen 47-b). When the user presses the [MENU] key again or presses a [BACK] key on the screen 47-b, the screen of the smartphone 2 returns to the screen 47-a.

When the user selects [AQUOS Select] on the screen 47-b, the smartphone 2 switches the screen to a screen 47-c (device selection screen) for selecting an AQUOS to be connected. When the user presses a [BACK] key or selects a device which has already been selected on the screen 47-c, the smartphone 2 displays the screen 47-a without carrying out any operation. Note that an operation on the screen 47-c will be described in detail in “Select Device”

When the user selects [Setting] on the screen 47-b, the smartphone 2 switches the screen to the screen 47-d. On the screen 47-d, operation sound, vibrator, and sleep are displayed as setting items. Moreover, explanatory texts for the respective setting items are displayed in up to two rows. In the screen 47-d, the operation sound, the vibrator, and the sleep are displayed as the setting items. Note, however, that the items that can be set in the smartphone 2 are not limited to those. Moreover, contents of the explanatory texts for the respective setting items and lengths of the explanatory texts are not limited to those above described.

When the user selects [Operation Sound] on the screen 47-d, the smartphone 2 switches the screen to a screen 47-e for setting operation sound. When the user selects the operation sound on the screen 47-e, the smartphone 2 sets the operation sound. Specifically, when the user sets the operation sound to ON, the smartphone 2 can make a sound in accordance with a touch operation (i.e., a touchdown). After the setting, the smartphone 2 switches the screen to the previous screen, i.e., the screen 47-d.

When the user presses a [Cancel] key or a [BACK] key on the screen 47-e, the smartphone 2 switches the screen to the previous screen, i.e., the screen 47-d without making any setting.

When the user selects [Vibration] on the screen 47-d, the smartphone 2 switches the screen to a screen 47-f for setting the vibrator. When the user selects the vibrator on the screen 47-f, the smartphone 2 makes a setting for the vibrator. Specifically, when the user sets the vibrator to ON, the smartphone 2 can vibrate when buttons other than the display switching tab are pressed (i.e., touch-down). Note that the smartphone 2 does not vibrate in accordance with list operations (such as dragging, flicking, and touching) and in a cursor mode (only in the “Flick” mode). After the setting, the smartphone 2 switches the screen to the previous screen, i.e., the screen 47-d.

When the user presses a [Cancel] key or a [BACK] key on the screen 47-f, the smartphone 2 switches the screen to the previous screen, i.e., the screen 47-d without making any setting.

When the user selects [Sleep] on the screen 47-d, the smartphone 2 switches the screen to the screen 47-g for setting the sleep. When the user selects a time for the sleep on the screen 47-g, the smartphone 2 sets the sleep to the selected time. Note that the time until the sleep starts when the smartphone 2 is last operated. When the user presses a [HOME] key or the like and therefore the smartphone 2 switches the screen to a screen for another application, the smartphone 2 resets a timer for the sleep after returning to the remote controller application. After the setting, the smartphone 2 switches the screen to the previous screen, i.e., the screen 47-d.

When the user presses a [Cancel] key or a [BACK] key on the screen 47-g, the smartphone 2 switches the screen to the previous screen, i.e., the screen 47-d without making any setting.

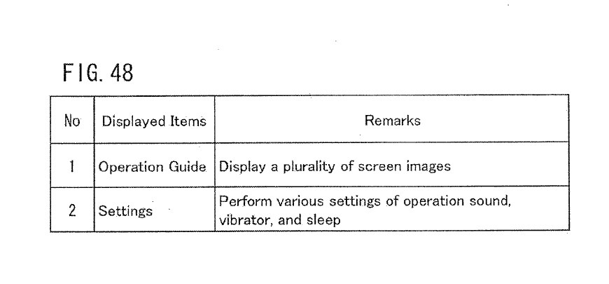

Next, FIG. 48 illustrates an example of an option menu on the device selection screen of the smartphone 2.

As illustrated in FIG. 48, the smartphone 2 has, as options on the device selection screen, (i) “Operation Guide” in which a plurality of screen images are displayed and (ii) “Setting” for setting various functions such as the operation sound, the vibrator, and the sleep. Note that the options on the device selection screen which the smartphone 2 has are not limited to those.

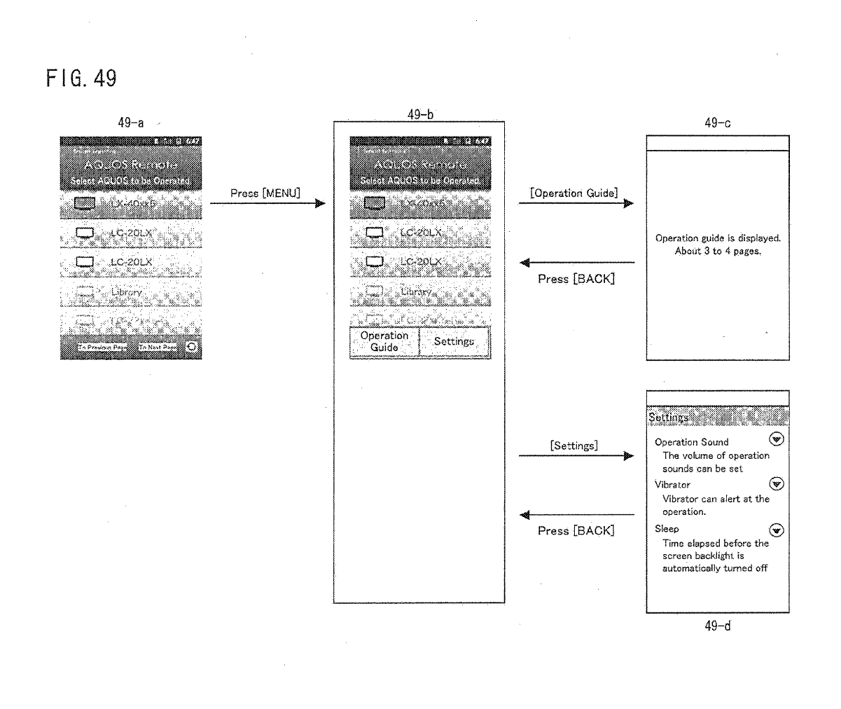

Next, the following description will discuss a flow of operating the option menu on the device selection screen, with reference to FIG. 49. FIG. 49 is a screen transition diagram illustrating an example flow of operating the option menu on the device selection screen.

As illustrated in FIG. 49, it is assumed that a screen 49-a (device selection screen) for selecting a device to be connected is already displayed on the screen of the smartphone 2.

When the user presses a [MENU] key on the screen 49-a, the smartphone 2 displays the option menu on the device selection screen (screen 49-b). When the user presses the [MENU] key again or presses a [BACK] key on the screen 49-b, the screen of the smartphone 2 returns to the screen 49-a.

When the user selects [Operation Guide] on the screen 49-b, the smartphone 2 displays an operation guide on the screen (screen 49-c). When the user presses a [BACK] key on the screen 49-c, the smartphone 2 switches the screen to the previous screen, i.e., the screen 49-b.

When the user selects [Setting] on the screen 49-b, the smartphone 2 switches the screen to a screen 49-d. Note that the screen 49-d is similar to the screen 47-d above described, and it is possible to make similar settings via the screen 49-d. Therefore, descriptions for the setting items are omitted here.

(How to Input Characters)

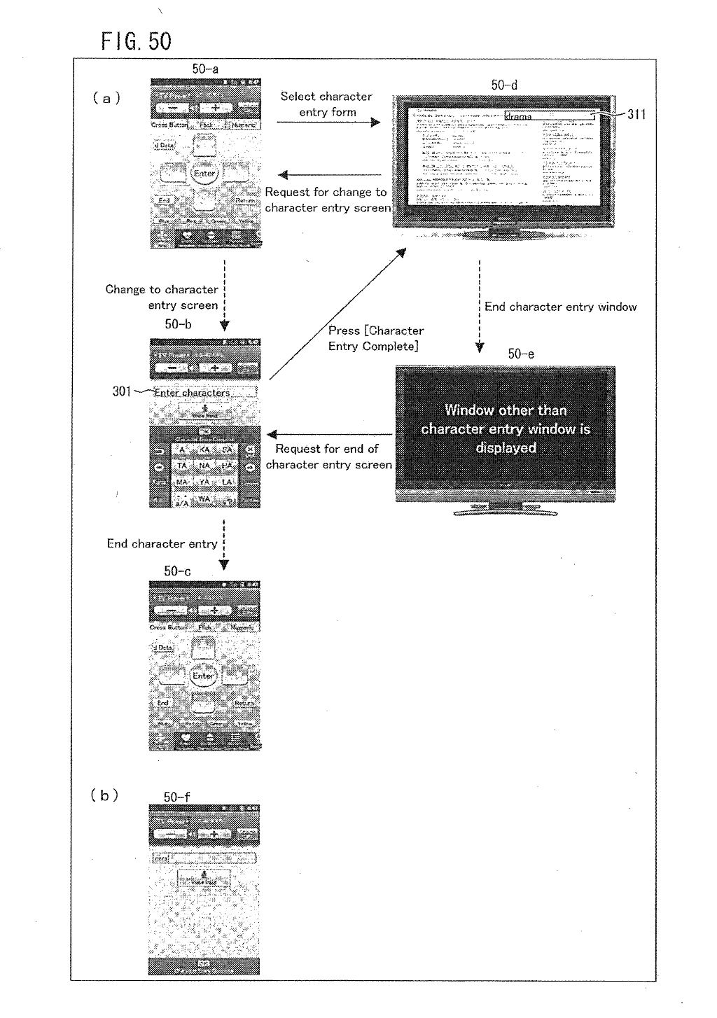

The following description will discuss a flow of entering characters in the smartphone 2 of the present invention, with reference to FIGS. 50 through 52. FIG. 50 is a screen transition diagram illustrating an example flow of entering characters in the smartphone 2.

When it is necessary to enter a character string, the television 1 displays a screen 50-d (character entry window screen) and transmits, to the smartphone 2, a transition request (i.e., request for change to a character entry screen) for switching (changing) a screen of the smartphone 2 to a screen (character entry screen) for entering a character string (see (a) of FIG. 50). The case in which it is necessary to enter a character string in the television 1 is, for example, when the user selects a character entry frame (text field) 311 on a web page, which is displayed on the television 1, with the use of an operation panel (screen 50-a) displayed on the smartphone 2 (see (a) of FIG. 50).

Upon receipt, from the television 1, of the request for changing to the character entry screen, the smartphone 2 switches the screen to the screen 50-b (character entry screen) (i.e., the screen is changed to the character entry screen). In the screen 50-b, for example, a character string (initial character string) “Enter Characters” can be initially displayed in a gray font in a character entry frame (text field) 301 which is a GUI element for entering a character string. Note that the initial character string displayed on the character entry frame 301 is not limited to this. For example, in a case where a character string exists in the character entry frame (text field) 311 in the screen 50-d of the television 1, the smartphone 2 can display that character string in the character entry frame 301 as an initial character string. In a case where the television 1 notifies the smartphone 2 of an initial character string, the smartphone 2 can display the initial character string in the character entry frame 301.

When the user carries out, on a character entry screen (screen 50-b) of the smartphone 2, a character entry operation and then presses a character entry complete button for indicating that a character entry has been completed, the smartphone 2 notifies the television 1 of the entered character string. The television 1 overwrites the character string in the character entry frame 311 with the character string notified from the smartphone 2.

Note that, when the television 1 closes the character string entry window (screen 50-d), the television 1 notifies the smartphone 2 of the end of displaying the character string entry window. The television 1 transmits, to the smartphone 2, a character entry screen end request for ending the character entry screen. Upon receipt of the character entry screen end request from the television 1, the smartphone 2 switches the screen to a screen 50-c (operation panel). Note that the screen 50-c is identical with the screen 50-a which is a screen (i.e., an original screen) displayed when the character entry screen is activated.

Note that, in a case where the smartphone 2 is a terminal having hardware keys, the smartphone 2 can display a screen 50-f on which no software keyboard is displayed (see (b) of FIG. 50), instead of the screen 50-b on which a software keyboard is displayed.

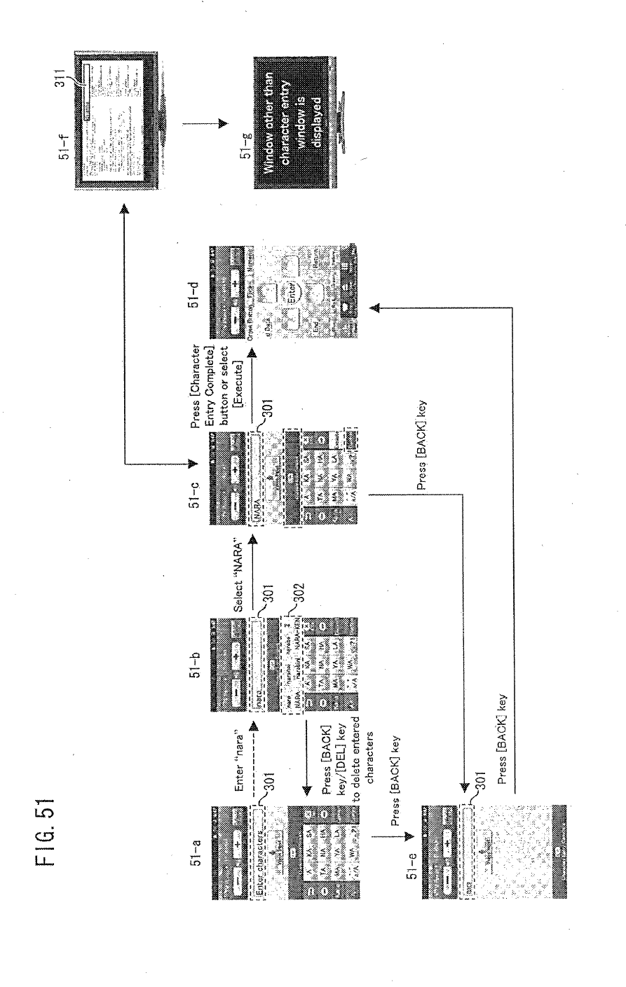

Next, the following description will discuss a detailed example flow of a screen of the smartphone 2 displayed when the user carries out a character entry operation on the screen 50-c, with reference to FIG. 51.

As illustrated in FIG. 51, in a case where the user enters a character string “nara” on the screen 51-a (character entry screen), the smartphone 2 displays on the screen (i.e., a screen 51-b) a list (i.e., a conversion candidate list) 302 of conversion candidates for the character string “nara”. In this example, it is assumed that the conversion candidate list 302 is displayed in accordance with operation of an application (e.g., a remote controller application) with which characters can be entered. Moreover, on the screen 51-b, a character entry complete button is displayed above the conversion candidate list 302. Note, however, that the location in which the character entry complete button is displayed is not limited to this.

When the user selects “NARA” from the conversion candidate list 302, the smartphone 2 switches the screen to a screen (i.e., a screen 51-c) in which (i) “NARA”, which has been selected by the user, is displayed in the character entry frame 301 and (ii) the conversion candidate list 302 is not displayed.

When the user (i) presses a [BACK] key for returning to a previous screen or (ii) presses a [Del] key for deleting the entered character string so as to erase the entered character string on the screen 51-b, the smartphone 2 switches the screen to the screen 51-a.

When the user presses the character entry complete button on the screen 51-b or the screen 51-c so as to confirm “NARA” as an entry character string, the smartphone 2 transmits the entered character string (entry character string) to the television 1. When the television 1 receives the character string, the screen of the television 1 is changed from a character entry window (screen 51-f) to a screen (screen 51-g) which is not a character entry window. Meanwhile, the smartphone 2 switches the screen to a screen 51-d which is a screen displayed when the character entry screen is activated.

Note that, on the screen 51-c, the smartphone 2 can operate in a manner similar to a case, in which the character entry complete button is pressed, in accordance with a display such as “Execute Button” of an application used so as to enter characters, instead of pressing the character entry complete button.

When the user presses a [BACK] key on the screen 51-a or the screen 51-c, the smartphone 2 switches the screen to a screen 51-e on which no software keyboard is displayed. Note that, in a case where the screen 51-e is a screen switched from the screen 51-c, the smartphone 2 can display a character string (in this example, “nara”) which has been entered by the user in the character entry frame 301 on the screen 51-e.

When the user presses a [BACK] key on the screen 51-e, the smartphone 2 switches the screen to the screen 51-d which is the screen displayed when the character entry screen is activated.

Note that the character string displayed on the character entry screen of the television 1 is synchronized, in real time, with the character string whose entry has been completed in the smartphone 2. That is, when a character string is entered in the smartphone 2 and then the character entry complete button is pressed, the entered character string is displayed in the character entry frame 311 of the television 1. When the user confirms, as an entry character string, the character string entered in the character entry frame 311 in the character entry window of the television 1, the television 1 notifies the smartphone 2 of the character string. The smartphone 2 displays, in the character entry frame 301, the character string notified from the television 1. That is, when a character string is confirmed in one of the character entry frames, the confirmed character string is transmitted to the other of the character entry frames. At the time, the character entry frame, which has received the character string, is overwritten with the received character string.

In a case where a character string is transmitted from the television 1 to the smartphone 2 while conversion candidates for an entered character string are displayed, the smartphone 2 ignores the character string which has been transmitted from the television 1. That is, in a case where a character string is transmitted from the television 1 to the smartphone 2 before the user enters a character string and then presses the character entry complete button, the smartphone 2 displays, in the character entry frame 301, the character string which is being entered by the user.

Note that, in this example, the character entry frame 301 is restricted to one (1) row. That is, a character string which can be entered in the character entry frame 301 is one (1) row, and no line feed is available. Moreover, operations (e.g., copy, paste, and range specification) with respect to the character entry frame 301 conform to standard operations of the smartphone 2.

Character types which can be entered in the character entry frame 301 are character types (e.g., numerals (single-byte characters and multi-byte characters), alphabets (single-byte characters and multi-byte characters), hiragana characters, and daily-use kanji characters) which can be entered in the character entry frame 311 of the television 1. The number of characters which can be entered in the character entry frame 301 is equal to the number of characters which can be entered in the character entry frame 311 of the television 1. Note that the restrictions on characters, such as the character types which can be entered and the number of characters which can be entered, are notified to the smartphone 2 from the television 1.

With regard to the character entry described with reference to FIG. 50 and FIG. 51, characters are entered with the keyboard. Note, however, that the present invention is not limited to this. Characters can be entered with voice.

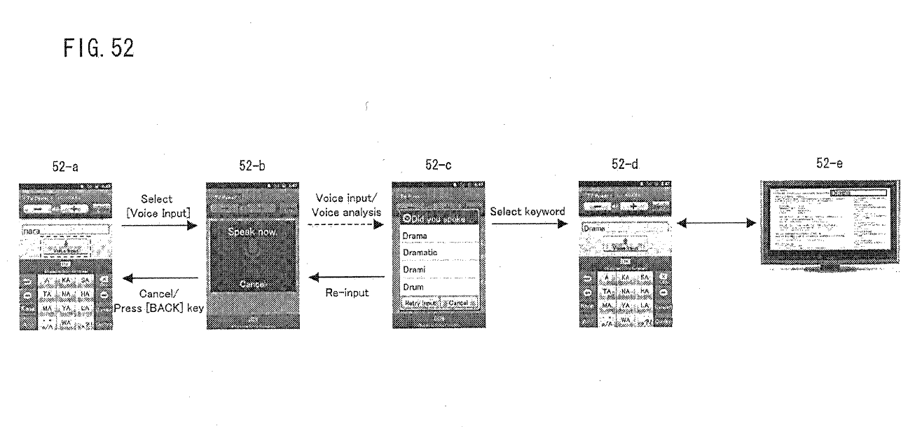

The following description will discuss a flow of entering characters with the use of voice, with reference to FIG. 52. FIG. 52 is a screen transition diagram illustrating another example flow of entering characters in the smartphone 2.

As illustrated in FIG. 52, when the user selects, on a screen 52-a, a voice input button for starting a voice input, the smartphone 2 switches the screen to a screen (voice input screen) (screen 52-b) for carrying out voice input. When the user enters a voice with respect to the smartphone 2, the smartphone 2 analyzes the voice and displays a screen (screen 52-c) including a list of candidates for the voice inputted by the user. In a case where the voice inputted by the user is not displayed on the screen 52-c, the screen of the smartphone 2 returns to the voice input screen when the user presses a re-input button.

When the user selects a character string on the screen 52-c, the smartphone 2 switches the screen to a screen 52-d in which the selected character string is displayed in the character entry frame 301. For example, in a case where the user selects “Drama” on the screen 52-c, “Drama” is displayed in the character entry frame 301 as in the screen 52-d.

When the user presses a character entry complete button on the screen 52-d or the user selects a character string on the screen 52-c, the smartphone 2 transmits the character string to the television 1.

Note that, in a case where a character string is transmitted from the television 1 to the smartphone 2 during a voice input, the smartphone 2 ignores the character string transmitted from the television 1. After that, the smartphone 2 transmits the character string, which has been entered by the user, to the television 1. Then, the television 1 displays the character string which has been transmitted from the smartphone 2.

In a case where a voice input is carried out while a character string is being entered as illustrated in FIG. 50 and FIG. 51, the character string entered with the use of the keyboard is overwritten with the character string entered by the voice input. That is, on the character entry frame 301, the character string entered by voice input is displayed instead of the character string which is being entered.

(Setting Screen)

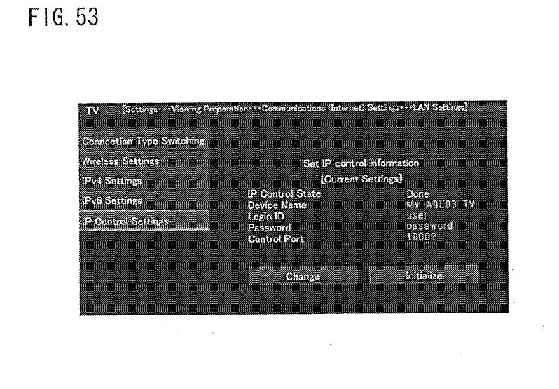

With regard to a remote control with the use of the smartphone 2, some items can be set in the television 1. FIG. 53 illustrates a setting screen displayed on the television 1 for carrying out the setting.

As illustrated in FIG. 53, for example, it is possible to set in the television (1) whether or not to accept a remote control (IP control) with the use of the smartphone 2, (2) a device name, (3) a login ID, and (4) a password.

(Flashback Function)

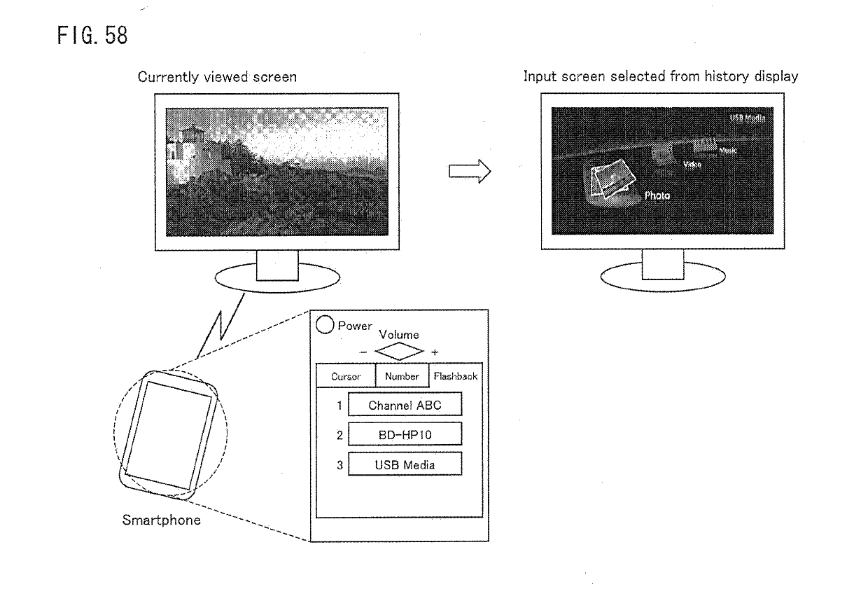

The following description will discuss a flashback function of the smartphone 2 of the present invention, with reference to FIGS. 58 through 63. The flashback function is a function to cause the smartphone 2 to display, on the screen, a view history such as channels which were displayed on the television 1 in the past and devices.

FIG. 58 is a view schematically illustrating an example of the flashback function using the smartphone 2. As illustrated in FIG. 58, when a Flashback tab is selected for carrying out the flashback function, the smartphone 2 displays a list of view histories (input histories).

In the smartphone 2 illustrated in FIG. 58, three view histories are displayed. Note, however, that the number of view histories is not limited to this. The view history displayed on the smartphone 2 is, for example, a channel name or a device name from which data was inputted to the television 1.

When the user selects a channel name or an input device name from the view histories, the screen of the television 1 is switched from a screen, which is currently viewed, to a screen for the selected channel or input device.

As such, the smartphone 2 can display (i) what channel was displayed on the television 1 previously or (ii) from what device data was inputted to the television 1 previously. This makes it possible to let the user easily know a previous input.

<Method for Managing View histories in Television 1>

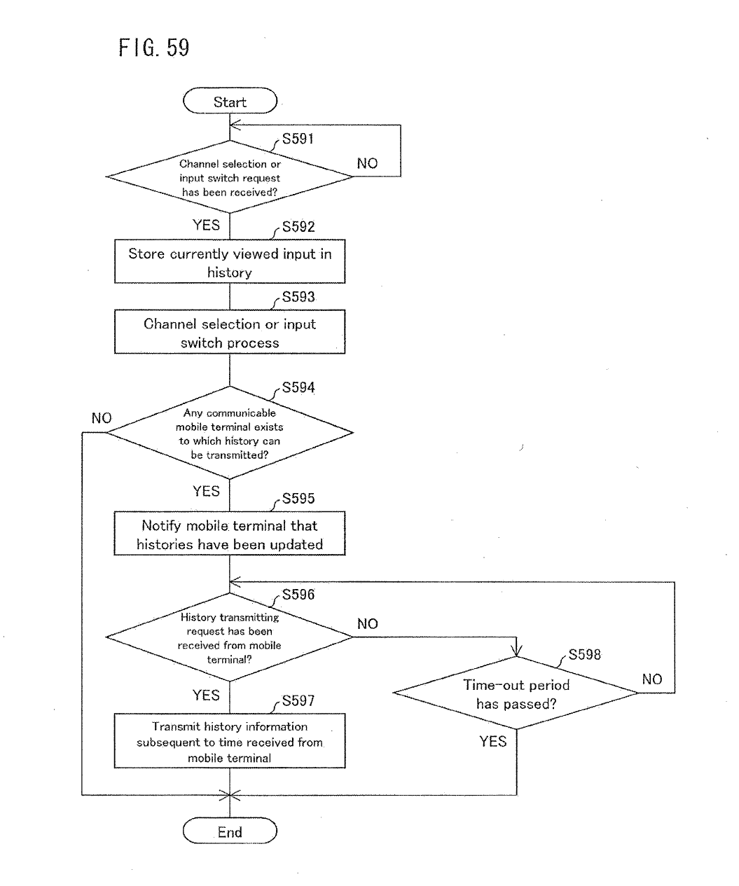

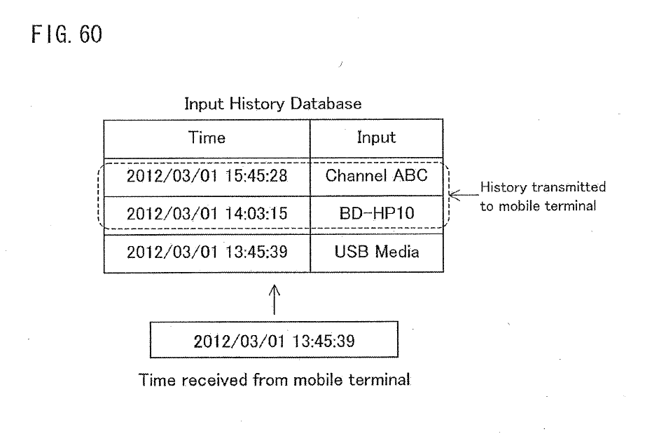

FIG. 59 is a flow chart indicating an example of a method for managing view histories in the television 1. As illustrated in FIG. 59, a control section 120 of the television 1 judges whether or not a channel selection or input switch request has been received from the smartphone 2 (step S591, hereinafter simply referred to as S591). In a case where a channel selection or input switch request has not been received (NO in S591), the control section 120 repeats S591. On the other hand, in a case where a channel selection or input switch request has been received (YES in S591), the control section 120 controls an input history DB to store an input (e.g., a channel, a device name), which is currently viewed, together with a current time (S592) (see FIG. 60).

Here, the input history DB is a database which is managed by the control section 120 (history information managing means) as illustrated in FIG. 60. Note that the input history DB can be managed by a member other than the control section 120.

After S592, the control section 120 carries out a channel selection or input switch process in accordance with the received channel selection or input switch request (S593).

Then, the control section 120 of the television 1 searches whether or not a communicable mobile terminal exists to which the input history can be transmitted (S594). In a case where no communicable mobile terminal exists (NO in S594), the television 1 ends the process. In a case where a communicable mobile terminal exists (YES in S594), a state notifying section 122 of the control section 120 notifies, to the communicable mobile terminal, that the input histories have been updated (i.e., transmits a history update notification) (S595). Note that, in this case, the communicable mobile terminal is the smartphone 2.

Subsequently, the control section 120 of the television 1 judges whether or not a history transmitting request (view history obtaining request) has been received from the communicable mobile terminal (S596). In a case where the history transmitting request has been received (YES in S596), the state notifying section 122 of the control section 120 transmits (notifies), to the mobile terminal, history information subsequent to a time indicated by (i) the time information received together with the history transmitting request and (ii) last update time information of history information managed by the mobile terminal (S597), and then the process is ended.

As illustrated in FIG. 60, in a case where a last update time received from the smartphone 2 is Mar. 1, 2012, 45 minutes and 39 seconds past 13 o'clock, the control section 120 refers to the input history DB and transmits, to the smartphone 2, input histories subsequent to the last update time. Alternatively, in a case where a last update time received from the smartphone 2 is a predetermined default time (e.g., Jan. 1, 2001, 0 minute and 0 second past 0 o'clock), the control section 120 transmits, to the smartphone 2, all input histories stored in the input history DB.

On the other hand, in a case where no history transmitting request has been received (NO in S596), the control section 120 judges whether or not a time-out period has passed (S598). In a case where the time-out period has not been passed (NO in S598), the control section 120 returns the process to S596. In a case where the time-out period has passed (YES in S598), the television 1 ends the process.

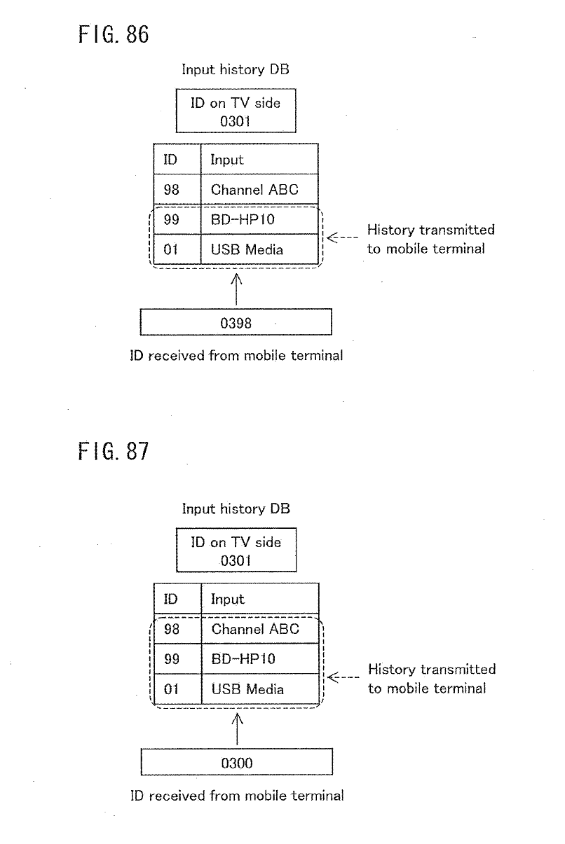

Note that the input history DB may be a database that can manage view histories with specific identification symbols (such as character string) given to the view histories, instead of managing times. This case will be described below with reference to FIGS. 86 and 87. Each of FIGS. 86 and 87 is a view illustrating an example of a database used to manage view histories (input histories).

In the input history DB illustrated in FIG. 86 and FIG. 87, an input which is currently viewed is managed in association with an ID. The IDs are numeric values that rotate from 01 to 99. Note that the values of the IDs are merely an example, and the IDs are not limited to this example.

The control section 120 of the television 1 manages, as an ID on a television 1 side, a number obtained by combining (i) the number of connections with the smartphone 2 and (ii) an ID of a latest history in the input history DB. Specifically, in a case where the number of connections with the smartphone 2 is three and an ID of a latest history in the input history DB is “01”, the television 1 manages “0301” as an ID on the television 1 side (see FIG. 86).

Similarly, the smartphone 2 manages, as an ID on a smartphone 2 side, a number obtained by combining (i) the number of connections with the television 1 and (ii) an ID of a latest history managed in the smartphone 2. Specifically, in a case where the number of connections with the television 1 is three and an ID of a latest history managed in the smartphone 2 is “98”, the smartphone 2 manages “0398” as an ID on the smartphone 2 side (see FIG. 86).

The numbers of connections between the television 1 and the smartphone 2 are expressed by the numerals rotating from 01 to 99. Note, however, that the present invention is not limited to this.

As illustrated in FIG. 86, in a case where the ID on the smartphone 2 received from the smartphone 2 is “0398”, the control section 120 of the television 1 refers to the input history DB and transmits, to the smartphone 2, input histories (in FIG. 86, input histories having IDs of 99 and 01) having IDs subsequent to the latest history ID of the smartphone 2.

When the smartphone 2 intends to receive, from the television 1, all input histories DB managed by the television 1, the smartphone 2 transmits, to the television 1, an ID of the smartphone 2 side which ID is obtained by assuming that an ID of a latest history managed in the smartphone 2 is “00”. Specifically, in a case where the number of connections with the television 1 is three and the smartphone 2 intends to receive all input histories DB managed by the television 1, a control section 220 of the smartphone 2 sets the ID to “0300” on the smartphone 2 side and transmits the ID to the television 1 (see FIG. 87). Upon receipt, from the smartphone 2, of the ID “0300”, the control section 120 of the television 1 transmits, to the smartphone 2, all input histories stored in the input history DB.

In a case where the smartphone 2 is not registered in the television 1, the smartphone 2 can set the number of connections between the smartphone 2 and the television 1 to “00” so as to indicate that the smartphone 2 is not registered in the television 1.

Note that the ID managed on the television 1 side and the ID managed on the smartphone 2 side are merely an example, and are not limited to the combination of the number of connections and the history ID. For example, alphabetic letters and the like can be used instead of numerals.

As such, the television 1 can manage input histories even in a case where a time cannot be obtained. It is therefore possible to cause the smartphone 2 to display input histories.

<Method for Managing View History in Smartphone 2>

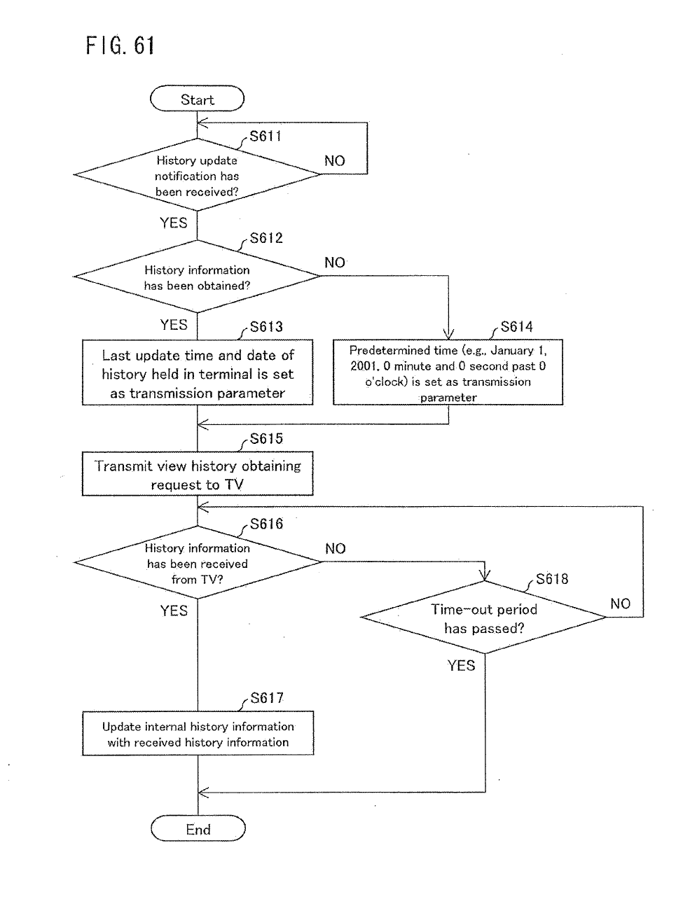

The following description will discuss a method for managing view histories in the smartphone 2, with reference to FIG. 61. The control section 220 of the smartphone 2 checks whether or not a history update notification, which was transmitted by the television 1 in S595, has been received (S611). In a case where no history update notification has been received (NO in S611), the control section 220 repeats S611. In a case where a history update notification has been received (YES in S611), the control section 220 checks whether or not history information has been obtained from the television 1 before (S612).

In a case where history information has been obtained (YES in S612), the control section 220 sets, as a transmission parameter, a last update time and date of the history information held in the smartphone 2 (S613). On the other hand, in a case where no history information has been obtained (NO in S612), the control section 220 sets, as a transmission parameter, a predetermined time (e.g., Jan. 1, 2001, 0 minute and 0 second past 0 o'clock) (S614).

Subsequently, the command transmitting section 222 of the control section 220 transmits a view history obtaining request to the television 1 with the use of the transmission parameter set in S613 or S614 (S615).

Then, the smartphone 2 checks whether or not history information has been received, which was transmitted from the television 1 in S597 (S616). In a case where history information has been received (YES in S616), the control section 220 updates history information, which is managed in the smartphone 2, with the received history information (S617), and the process is ended. On the other hand, in a case where no history information has been received (NO in S616), the control section 220 judges whether or not a time-out period has passed (S618). In a case where the time-out period has not passed (NO in S618), the control section 220 returns to the process of S616. On the other hand, in a case where the time-out period has passed (YES in S618), the smartphone 2 ends the process. Note that, even in a case where the time-out period has passed in S618, it is possible to return to S616 so as to check again whether or not history information has been received from the television 1.

By receiving the history information from the television 1 with the above described receiving method, the GUI display section 221 of the smartphone 2 can cause the history information to be displayed on the screen of the smartphone 2 as illustrated in FIG. 58.

<Modification Example of View History Screen>

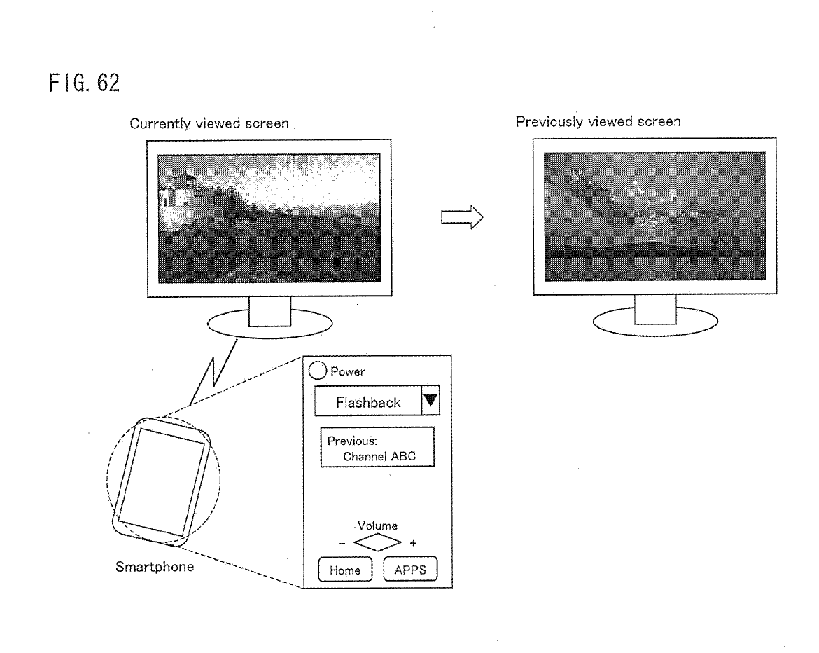

Note that the screen showing history information is not limited to FIG. 58, and, for example, history information can be displayed as illustrated in FIG. 62. As with a Flashback key included in a remote controller or the like, it is possible to select a Flashback key on the smartphone 2 (see FIG. 62). In this case, when the user selects the Flashback key, a channel name or a device name, which was previously displayed on the television 1, is displayed. Further, the television 1 displays an input screen of a channel or a device which input screen was previously displayed on the television 1. In this case, the previous channel name or device name to be displayed can be obtained from history information managed in the smartphone 2 or from history information transmitted from the television 1.

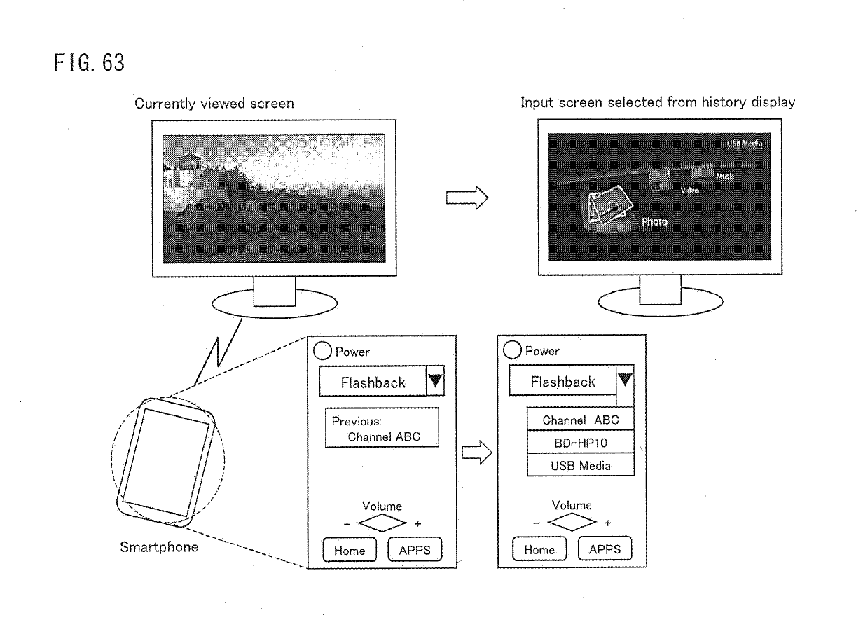

Moreover, when a pull-down key (downward triangle) beside the Flashback key is selected, a list of histories is displayed as illustrated in FIG. 63. In FIG. 63, three histories are displayed. Note, however, that the number of histories displayed on the smartphone 2 is not limited to this. The histories displayed on the smartphone 2 are selectable. When the user selects any of the histories, the television 1 switches a currently viewed screen to a screen of the selected channel or device.

When the television 1 displays history information, the television 1 can reduce, by the history information, a size of a screen which is currently viewed by the user or can superimpose the history information on the screen which is currently viewed by the user. Note, however, that the screen which is currently viewed by the user may become difficult to view. In such a case, by the use of the flashback function, the smartphone 2 can display (i) a channel selected in the television 1 or (ii) history information of the input source. Therefore, while maintaining a screen which the user is currently viewing, the user can easily check, on the smartphone 2, a channel or an input source which was previously displayed, without remembering the channel or device which was displayed on the television 1 before the currently viewed screen.

(Favorite Channel Function)

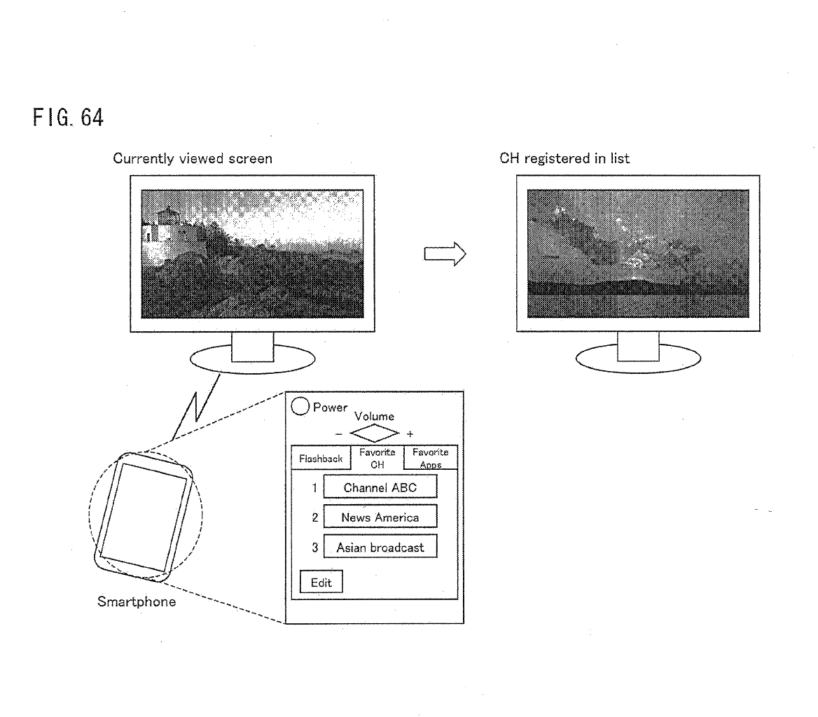

The following description will discuss a favorite channel function of the smartphone (mobile terminal) 2 of the present invention, with reference to FIGS. 64 through 75. The favorite channel function is a function to cause the smartphone 2 to display on the screen a channel which has been set as a favorite channel by the user in advance.

FIG. 64 is a view schematically illustrating an example of the favorite channel function with the use of the smartphone 2. As illustrated in FIG. 64, the smartphone 2 displays a list of favorite channels when a favorite channel (Favorite CH) tab for executing the favorite channel function is selected. The smartphone 2 illustrated in FIG. 64 displays three favorite channels. Note, however, that the number of favorite channels is not limited to this. When the user selects any channel from the favorite channels, a currently viewed screen on the television 1 is switched to a screen of the selected channel.

As such, the smartphone 2 can display any of favorite channels which are set in the television 1 by the user. Therefore, the user can easily select a channel which is registered as the favorite channel.

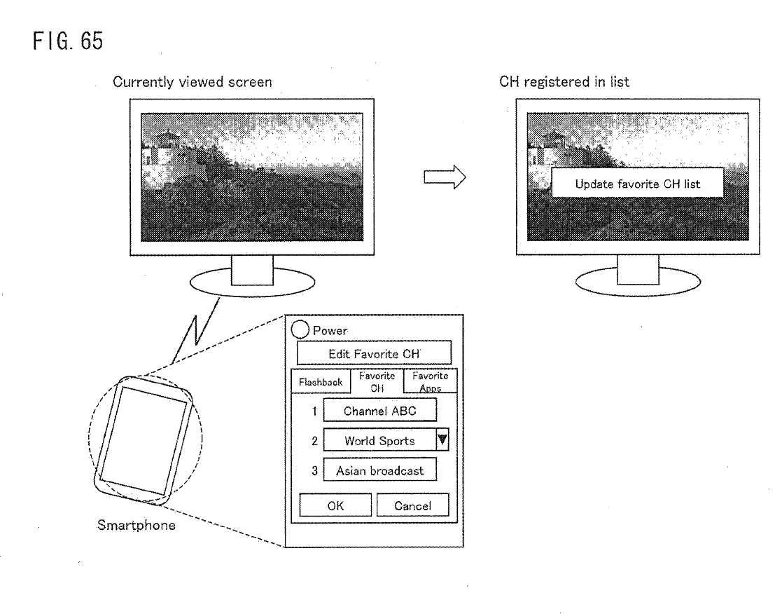

Moreover, the smartphone 2 can edit the favorite channels which are set by the user in the television 1. As illustrated in FIG. 64, an “Edit” key for editing the favorite channels is displayed on the screen of the smartphone 2. When the user selects the “Edit” key, the smartphone 2 changes to a screen (Edit Favorite CH screen) for editing favorite channels (see FIG. 65).

When the user selects any (e.g., “World Sports”) of the registered favorite channels, a list of channels is displayed in a pull-down menu of the smartphone 2. The user can select a new favorite channel from the pull-down menu. When the user selects the new favorite channel and then presses an OK button, update information on favorite channels is transmitted from the smartphone 2 to the television 1. Upon receipt of the update information on the favorite channels, the television 1 updates, based on the received update information, the favorite channels which are set in the television 1. Then, the television 1 displays, on its display, a message indicating that the favorite channels have been updated.

When the favorite channels are edited, the television 1 can reduce, by an editing screen, a size of a screen which is currently viewed by the user or can superimpose the editing screen on the screen which is currently viewed by the user. Note, however, that the screen which is currently viewed by the user may become difficult to view. In such a case, by the use of the above described configuration, it is possible to set favorite channels, which are set in the television 1, on the screen of the smartphone 2. Therefore, the user can easily edit, on the smartphone 2, the favorite channels while maintaining the screen of the television 1 which the user is currently viewing.

Note that, while the favorite channels are edited on the smartphone 2, a message indicating that the editing is being carried out can be displayed on the display of the television 1. This makes it possible to prevent another user from concurrently editing favorite channels.

<Method for Transmitting Favorite Channel>

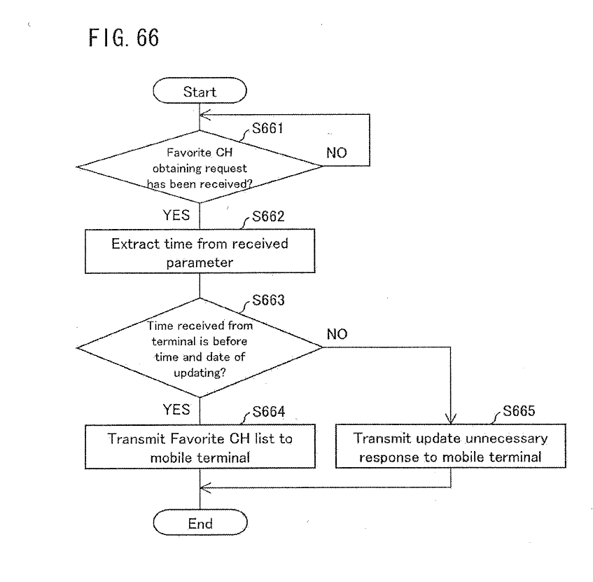

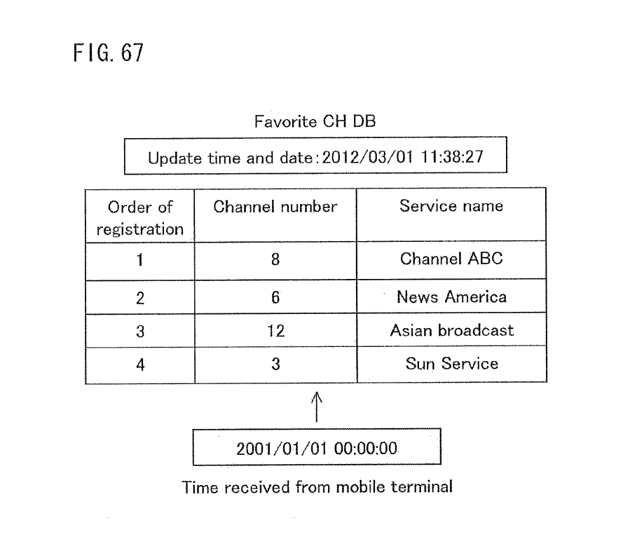

The following description will discuss how the television 1 transmits favorite channels, which have been set in the television 1, to the smartphone 2, with reference to FIG. 66 and FIG. 67. FIG. 66 is a flow chart illustrating an example of how the television 1 transmits favorite channels.

As illustrated in FIG. 66, the control section 120 of the television 1 checks whether or not to have received a favorite channel (Favorite CH) obtaining request (S661) transmitted from the smartphone 2 in S685 (later described). In a case where no favorite channel obtaining request has been received (NO in S661), the control section 120 repeats S661. On the other hand, in a case where a favorite channel obtaining request has been received (YES in S661), the control section 120 extracts a time from a transmission parameter included in the favorite channel obtaining request (S662).

The control section 120 checks whether or not the extracted time is before a time and date of updating a favorite channel DB (S663). Here, the favorite channel DB is a database (see FIG. 67) managed by the control section 120 (favorite channel managing means). Note that the favorite channel DB can be managed by a member other than the control section 120.

In a case where the extracted time is before the time and date of updating the favorite channel. DB (YES in S663), the state notifying section 122 of the control section 120 transmits a favorite channel list to the smartphone 2 (S664), and the process is ended. For example, in a case where an extracted time (i.e., a time received from the smartphone 2) in S662 is Jan. 1, 2001, 0 minute and 0 second past 0 o'clock and the time and date of updating the favorite channel DB is Mar. 1, 2012, 38 minutes and seconds past 11 o'clock (see FIG. 67), the control section 120 transmits, to the smartphone 2, a favorite channel list which has been prepared based on the favorite channel DB.

In a case where an extracted time is on or later than the time and date of updating the favorite channel DB (NO in S663), the state notifying section 122 of the control section 120 transmits, to the smartphone 2, a response indicating that the favorite channels do not need to be updated (update unnecessary response) (S665), and the process is ended.

<Method for Receiving Favorite Channel>

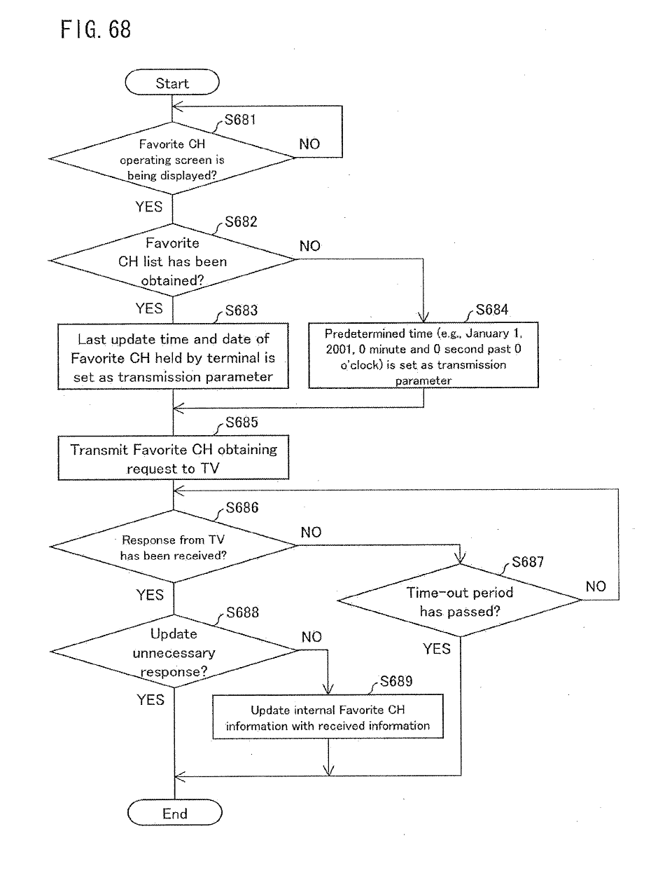

The following description will discuss how the smartphone 2 receives favorite channels set in the television 1, with reference to FIG. 68. As illustrated in FIG. 68, the control section 220 of the smartphone 2 checks whether or not a favorite channel operating screen is being displayed (S681). In a case where the favorite channel operating screen is not being displayed (NO in S681), the control section 220 repeats S681. On the other hand, in a case where the favorite channel operating screen is being displayed (YES in S681), the control section 220 checks whether or not a favorite channel list has been obtained from the television 1 before (S682).

In a case where a favorite channel list has been obtained (YES in S682), the control section 220 sets, as a transmission parameter, last update time and date of information on favorite channels which is held by the smartphone 2 (S683). On the other hand, in a case where no favorite channel list has been obtained (NO in S682), the control section 220 sets the transmission parameter to a predetermined time (e.g., Jan. 1, 2001, 0 minute and 0 second past 0 o'clock) (S684).

Next, the command transmitting section 222 of the control section 220 transmits, together with the transmission parameter set in S683 or S684, a favorite channel obtaining request to the television 1 for obtaining favorite channel information (S685).

Subsequently, the control section 220 checks whether or not to have received a response from the television 1 (S686). In a case where no response has been received from the television 1 (NO in S686), the control section 220 judges whether or not a time-out period has passed (S687). In a case where the time-out period has not passed (NO in S687), the control section 220 returns to the process of S686. On the other hand, in a case where the time-out period has passed (YES in S687), the smartphone 2 ends the process. Note that, even in the case where the time-out period has passed in S687, it is possible that the process returns to S686 so as to check again whether or not to have received a response from the television.

In a case where a response has been received from the television 1 (YES in S686), the control section 220 checks whether or not the response is an update unnecessary response (S688) transmitted from the television 1 in S665. In a case where the response is an update unnecessary response (YES in S688), the process is ended. On the other hand, in a case where the received response is not an update unnecessary response (NO in S688), the control section 220 updates, based on the received favorite channel list, the favorite channel information managed in the smartphone 2 (S689), and the process is ended.

By receiving the favorite channel list from the television 1 with the method above described, the GUI display section 221 of the smartphone 2 can control the screen of the smartphone 2 to display a list of favorite channels as illustrated in FIG. 64.

<Method for Transmitting Channel List>

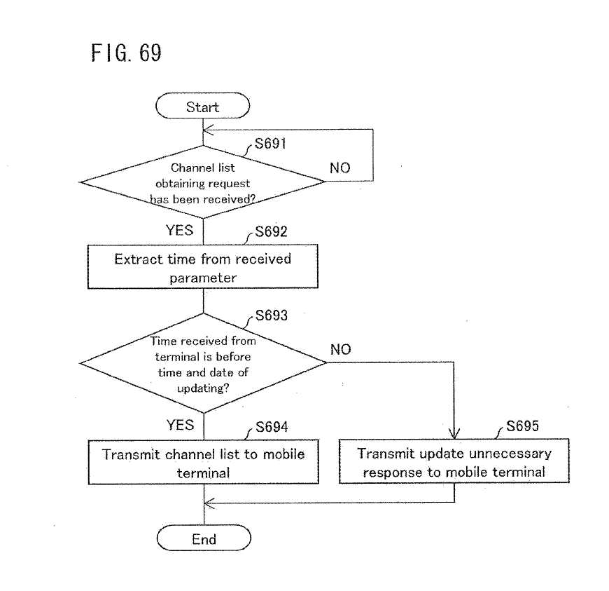

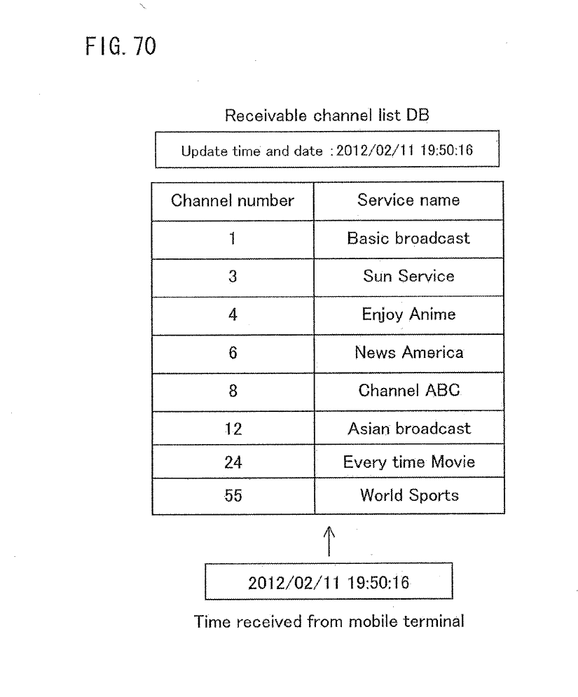

The following description will discuss how a list of channels, which can be received by the television 1, is transmitted to the smartphone 2, with reference to FIG. 69 and FIG. 70. FIG. 69 is a flow chart illustrating an example of how the television 1 transmits a list of channels, which can be received by the television 1, to the smartphone 2.

As illustrated in FIG. 69, the control section 120 of the television 1 checks whether or not to have received a channel list obtaining request (S691) which has been transmitted from the smartphone 2 in S715 (later described). In a case where a channel list obtaining request has not been received (NO in S691), the control section 120 repeats S691. On the other hand, in a case where a channel list obtaining request has been received (YES in S691), the control section 120 extracts a time from a transmission parameter included in the channel list obtaining request (S692).

The control section 120 checks whether or not the extracted time is before a time and date of updating a receivable channel list DB (S693). Here, the receivable channel list DB is a database (see FIG. 70) of channels that can be received by the television 1 and is managed by the control section 120. Note that the receivable channel list DB can be managed by a member other than the control section 120.

In a case where an extracted time is before the time and date of updating the receivable channel list DB (YES in S693), the state notifying section 122 of the control section 120 transmits the receivable channel list to the smartphone 2 (S694), and the process is ended.

In a case where an extracted time is on or later than the time and date of updating the receivable channel list DB (NO in S693), the state notifying section 122 of the control section 120 transmits, to the smartphone 2, a response indicating that the receivable channel list does not need to be updated (update unnecessary response) (S695), and the process is ended. For example, in a case where an extracted time in S692 is Feb. 11, 2012, 50 minutes and 16 seconds past 19 o'clock and the time and date of updating the receivable channel list DB is Feb. 11, 2012, 50 minutes and 16 seconds past 19 o'clock (see FIG. 70), the extracted time is identical with the time and date of update, and therefore the television 1 transmits an update unnecessary response to the smartphone 2.

<Method for Receiving Channel List>

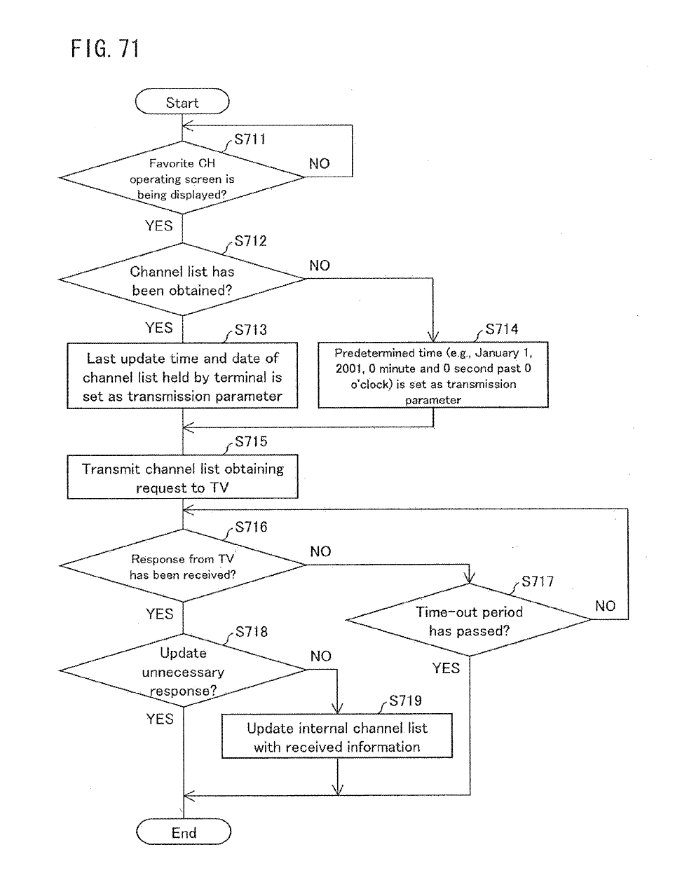

Next, with reference to FIG. 71, the following describes how the smartphone 2 receives, from the television 1, a list of channels that can be received by the television 1. As illustrated in FIG. 71, the control section 220 of the smartphone 2 checks whether or not a favorite channel edit screen is being displayed (S711). In a case where the favorite channel edit screen is not being displayed (NO in S711), the control section 220 repeats S711. In a case where the favorite channel edit screen is being displayed (YES in S711), the control section 220 checks whether or not a list of channels that can be received by the television 1 has been obtained from the television 1 before (S712).

In a case where the channel list has been obtained before (YES in S712), the control section 220 sets, as a transmission parameter, a last update time and date of the channel list which is held by the smartphone 2 (S713). On the other hand, in a case where the channel list has not been obtained before (NO in S712), the control section 220 sets the transmission parameter to a predetermined time (e.g., Jan. 1, 2001, 0 minute and 0 second past 0 o'clock) (S714).

Next, the command transmitting section 222 of the control section 220 transmits, together with the transmission parameter set in S713 or S714, a channel list obtaining request to the television 1 (S715).

Subsequently, the control section 220 checks whether or not to have received a response from the television 1 (S716). In a case where no response has been received from the television 1 (NO in S716), the control section 220 judges whether or not a time-out period has passed (S717). In a case where the time-out period has not passed (NO in S717), the control section 220 returns to the process of S716. In a case where the time-out period has passed (YES in S717), the smartphone 2 ends the process. Note that such an arrangement is also possible in which even in a case where the time-out period has passed in S717, the control section 220 returns to S716 again so as to check whether or not to have received a response from the television 1.

In a case where a response has been received from the television 1 (YES in S716), the control section 220 checks whether or not the response is the update unnecessary response (S718) transmitted from the television 1 in S695. In a case where the response is the update unnecessary response (YES in S718), the process is ended. In a case where the response is not the update unnecessary response (NO in S718), the control section 220 updates, based on the received channel list, the channel list managed in the smartphone 2 (S719), and the process is ended.

By receiving, from the television 1, a list of channels that can be received by the television 1 with the method above described, the GUI display section 221 of the smartphone 2 can cause the list of channels that can be received by the television 1 to be displayed on a favorite channel edit screen.

<Method for Editing Favorite Channel>

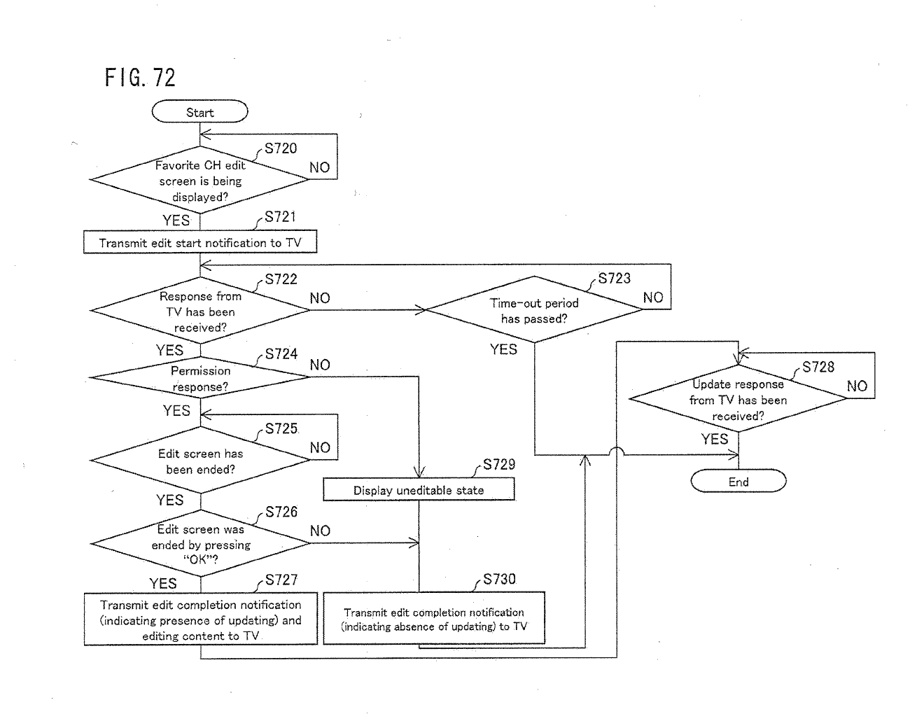

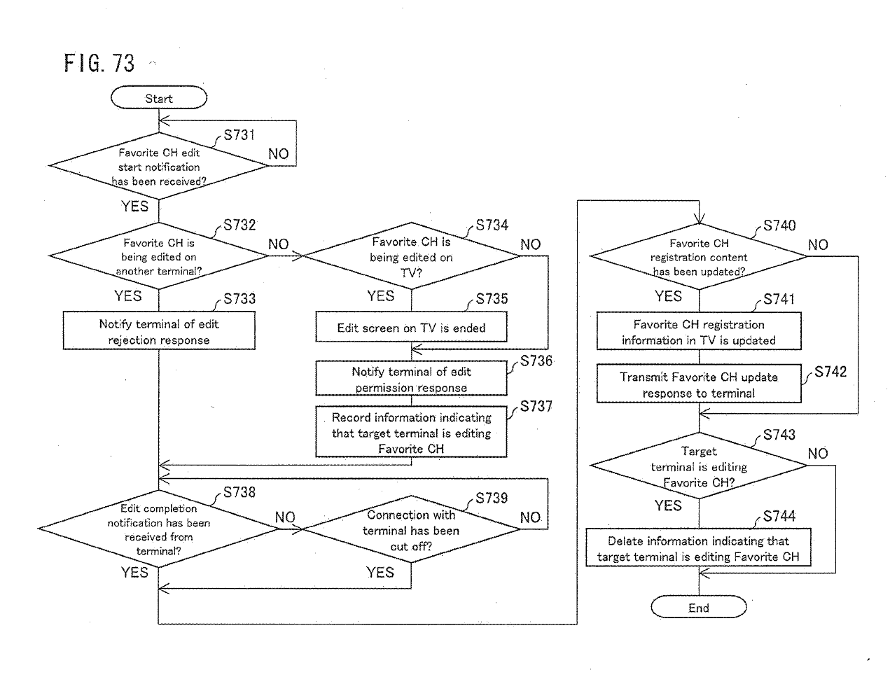

Next, with reference to FIG. 72 and FIG. 73, the following describes how to edit favorite channels which have been set in the television 1. FIG. 72 is a flow chart illustrating a flow of processes that are carried out by the smartphone 2 when favorite channels set in the television 1 are edited on the smartphone 2. FIG. 73 is a flow chart illustrating a flow of processes that are carried out by the television 1 when favorite channels set in the television 1 are edited on the smartphone 2.

As shown in FIG. 72, the control section 220 of the smartphone 2 checks whether or not the GUI display section 221 has changed the screen of the smartphone 2 to the favorite channel edit screen (S720). In a case where the screen of the smartphone 2 has not been changed to the favorite channel edit screen (NO in S720), the control section 220 repeats S720. In a case where the screen of the smartphone 2 has been changed to the favorite channel edit screen (YES in S720), the control section 220 transmits, to the television 1, a notification (edit start notification) notifying the television 1 of start of editing of favorite programs (S721).

Then, the control section 220 checks whether or not to have received a response from the television 1 (S722). In a case where no response has been received from the television 1 (NO in S722), the control section 220 judges whether or not a time-out period has passed (S723). In a case where the time-out period has not passed (NO in S723), the control section 220 returns to the process of S722. In a case where the time-out period has passed (YES in S723), the smartphone 2 ends the process. Note that such an arrangement is also possible in which even in a case where the time-out period has passed in S723, the control section 220 returns to S722 again so as to check whether or not to have received a response from the television 1.

In a case where a response has been received from the television 1 (YES in S722), the control section 220 checks whether or not the response thus received is an edit permission response (S724) transmitted from the television 1 in S736 (described later). In a case where the response thus received is the edit permission response (YES in S724), the control section 220 checks whether or not the edit screen has been ended (S725). In a case where the edit screen has not been ended (NO in S725), the control section 220 repeats S725.

In a case where the edit screen has been ended (YES in S725), the control section 220 checks whether or not the edit screen was ended by pressing “OK” (S726). In a case where the edit screen was ended by pressing “OK” (YES in S726), the command transmitting section 222 of the control section 220 transmits an editing content to the television 1 together with an edit completion notification (S727). By thus transmitting an editing content together with the edit completion notification in a case where the favorite channels have been updated, the control section 220 notifies the television 1 that the favorite channels have been updated.

Then, the control section 220 checks whether or not to have received an update response from the television 1 (S728). In a case where no update response has been received from the television 1 (NO in S728), the control section 220 repeats S728. In a case where the update response has been received from the television 1 (YES in S728), the control section 220 ends the process. On the other hand, in a case where the response transmitted from the television 1 is not the edit permission response (NO in S724), the smartphone 2 causes information indicative of an uneditable state to be displayed on the screen (S729). Note that such an arrangement is also possible in which the information indicative of an uneditable state is displayed on the television 1.

After S729 or in a case where the edit screen was not ended by pressing “OK” (NO in S726), the command transmitting section 222 of the control section 220 transmits an edit completion notification to the television 1 (S730), and the process is ended. By thus transmitting only the edit completion notification in a case where the favorite channels have not been updated, the control section 220 notifies the television 1 that the favorite channels have not been updated.

Next, the following describes processes carried out in the television 1 in a case where favorite channels set in the television 1 are edited on the smartphone 2. As shown in FIG. 73, the control section 120 of the television 1 checks whether or not to have received the notification (the edit start notification) of start of editing of favorite channels (S731) which notification was transmitted by the smartphone 2 in S721. In a case where no edit start notification has been received (NO in S731), the control section 120 repeats S731. On the other hand, in a case where the edit start notification has been received (YES in S731), the control section 120 checks whether or not a mobile terminal (another mobile terminal) other than the smartphone 2 is editing (currently editing) the favorite channels (S732).

In a case where another mobile terminal is editing the favorite channels (YES in S732), the control section 120 notifies the smartphone 2 of a response (edit rejection response) indicating rejection of start of editing (S733). In a case where another mobile terminal is not editing the favorite channels (NO in S732), the control section 120 checks whether or not the favorite channels are being edited on the television 1 (S734).

In a case where the favorite channels are being edited on the television 1 (YES in S734), the control section 120 ends a favorite channel edit screen on the television 1 (S735). After S735 or in a case where the favorite channels are not being edited on the television 1 (NO in S734), the control section 120 notifies the smartphone 2 of an edit permission response (S736). Then, the television 1 records information indicating that the smartphone 2 is editing the favorite channels (S737).

After S733 or after S737, the control section 120 checks whether or not to have received an edit completion notification from the smartphone 2 (S738). In a case where no edit completion notification has been received (NO in S738), the control section 120 judges whether or not connection with the smartphone 2 has been cut off (S739). In a case where connection with the smartphone 2 has not been cut off (NO in S739), the control section 120 returns to the process of S738.

In a case where connection with the smartphone 2 has been cut off (YES in S739) or in a case where the edit completion notification has been received (YES in S738), the control section 120 checks whether or not a favorite channel editing content (registration content) has been updated. Specifically, the control section 120 checks the editing content (S740) transmitted by the smartphone 2 in S727. In a case where the editing content has been updated (YES in S740), the control section 120 updates favorite channel registration information managed in the television 1. Specifically, the control section 120 updates a favorite channel DB illustrated in FIG. 67 (S741). Then, the control section 120 transmits, to the television 1, a response (update response) indicating that the favorite channels have been updated (S742).

After S742 or in a case where the editing content has not been updated (NO in S740), the control section 120 checks whether or not a terminal (the smartphone 2 in this example) which is supposed to update the favorite channels is editing the favorite channels (S743). In a case where the smartphone 2 is not editing the favorite channels (NO in S743), the process is ended.

In a case where the smartphone 2 is editing the favorite channels (YES in S743), the control section 120 deletes the information, recorded in S737, indicating that the smartphone 2 is editing the favorite channels (S744), and the process is ended.

By updating the favorite channel registration information, the television 1 changes to a screen (Update favorite CH list screen) indicative of completion of editing of the favorite channels (see FIG. 65).

<Modification of Favorite Channel Display Screen>

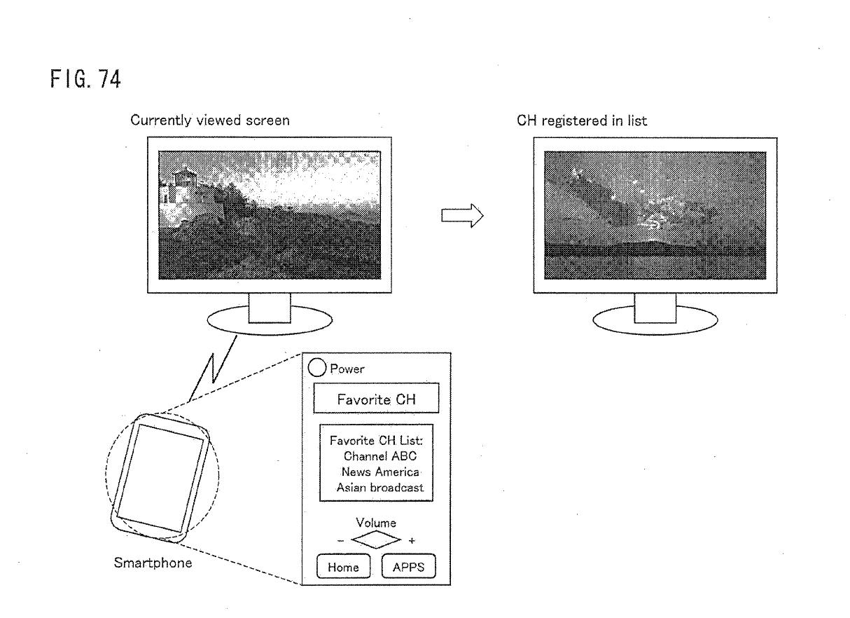

The favorite channel display screen is not limited to the one illustrated in FIG. 64, and can be, for example, displayed as illustrated in FIG. 74. As illustrated in FIG. 74, a Favorite CH key can be selected on the smartphone 2, as with the Favorite CH key on the remote control or the like. In this case, when a user selects the Favorite CH key, the smartphone 2 obtains, from the television 1, a list (Favorite CH List) of favorite channels registered in the television 1, and causes the list to be displayed on the screen. Then, when the user selects a channel from channels registered in the favorite channel list, the television 1 switches the screen to the channel thus selected.

By thus allowing a user to check, on the smartphone 2, the favorite channels registered in the television 1, it is possible to present, to the user, which channels are registered ones even if the user does not remember the registration content. Further, by thus allowing the favorite channels to be displayed in a list, a user can easily select a desired program.

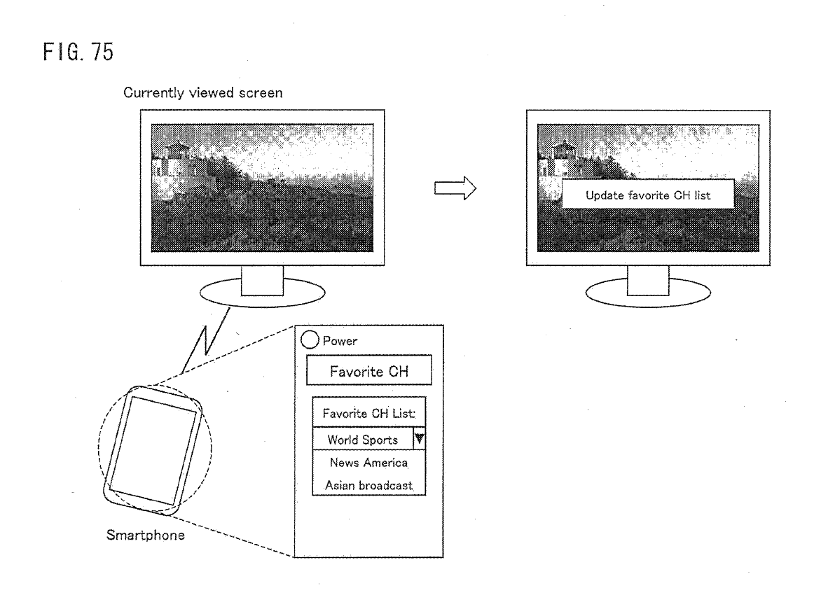

Further, the favorite channel edit screen is not limited to the one illustrated in FIG. 65, and can be, for example, displayed as illustrated in FIG. 75. As illustrated in FIG. 75, when any one of the channels included in the favorite channel list is selected, the smartphone 2 changes to the favorite channel edit screen. When a pull-down key (downward triangle) displayed besides a channel name is selected, the channel list is displayed on the pull-down menu of the smartphone 2. This allows the user to select a new favorite channel from the pull-down menu. When the user selects the new favorite channel and ends editing, favorite channel update information is transmitted from the smartphone 2 to the television 1. Upon receipt of the favorite channel update information, the television 1 updates the favorite channels set in the television 1 on the basis of the favorite channel update information thus received. Then, a message indicating that the favorite channels have been updated is displayed on the display of the television 1.

According to the arrangement, a user can more easily update favorite channels as compared with a case of updating favorite channels by opening the setting screen of the television 1.

(Favorite Application Function)

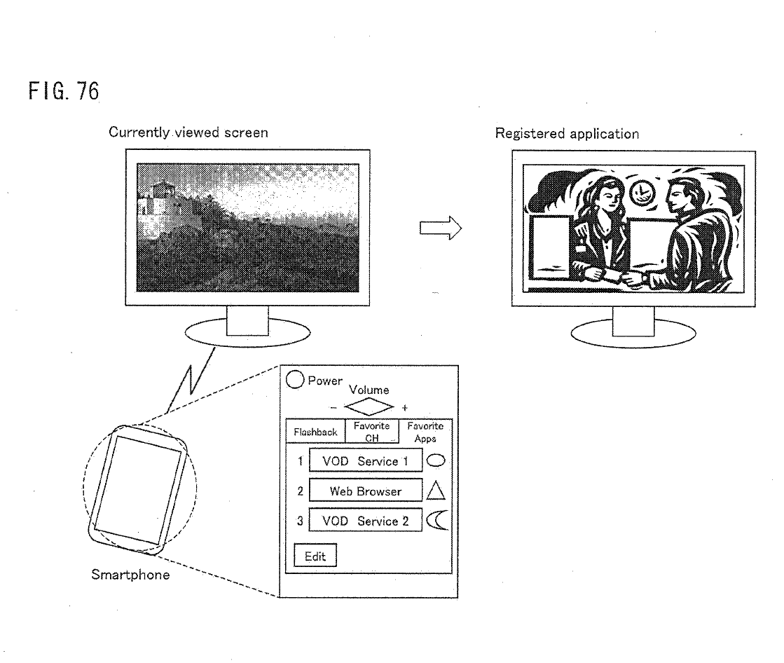

With reference to FIGS. 76 through 79, the following describes a favorite application function of the smartphone (mobile terminal) 2 of the present invention. The favorite application function is a function of causing an application (service) preset as a favorite application by a user to be displayed on the screen of the smartphone 2.

FIG. 76 is a view schematically illustrating an example of the favorite application function using the smartphone 2. As illustrated in FIG. 76, the smartphone 2 displays a list of favorite applications upon selection of a favorite application (Favorite Apps) tab for executing the favorite application function. Note that although three favorite applications are displayed on the smartphone 2 of FIG. 76, the number of favorite applications is not limited to this. When a user selects any one of application names of the favorite applications, the screen of the television 1 is switched from a currently viewed screen to a screen for the application thus selected.

As illustrated in FIG. 76, the smartphone 2 may display, besides the application names (service names), icons (an oval icon, a triangular icon, and a moon-shaped icon in FIG. 76) representing the respective applications. Alternatively, the smartphone 2 may display the icons instead of the application names.

The smartphone 2 can thus display user's favorite applications set in the television 1. This allows the user to easily select an application registered in the favorite applications.

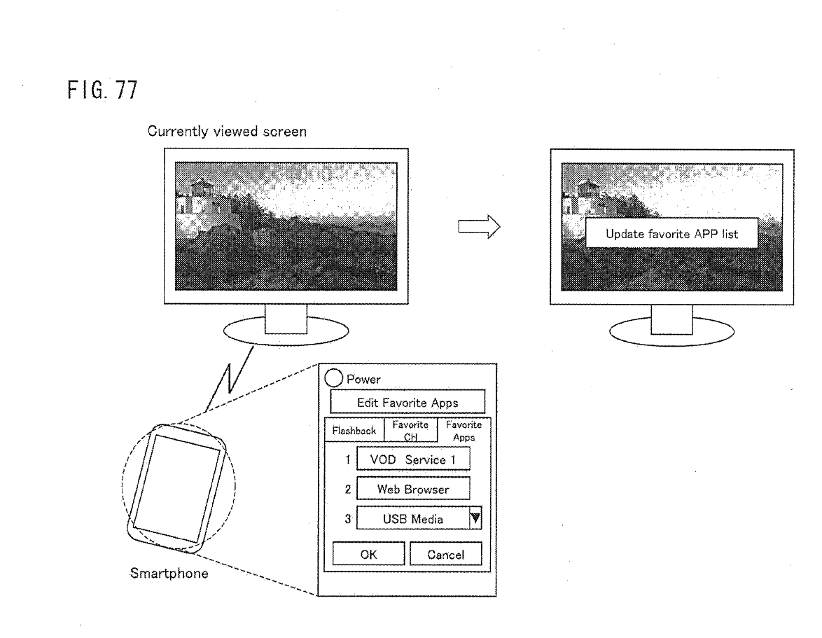

The smartphone 2 can also be used to edit the user's favorite applications set in the television 1. As illustrated in FIG. 76, an “Edit” key for editing the favorite applications is displayed on the screen of the smartphone 2. When a user selects the “Edit” key, the smartphone 2 changes to a favorite application edit screen (Edit Favorite Apps screen) as illustrated in FIG. 77.

Upon selection of any one (e.g., “USB Media”) of the registered favorite applications, an application list is displayed on the pull-down menu of the smartphone 2. This allows the user to select a new favorite application from the pull-down menu. When the user selects the new favorite application and presses an OK button, favorite application update information is transmitted from the smartphone 2 to the television 1. Upon receipt of the favorite application update information, the television 1 updates the favorite applications set in the television 1 on the basis of the favorite application update information thus received. Then, a message indicating that the favorite applications have been updated is displayed on the display of the television 1.

When the television 1 edits the favorite applications, the television 1 can reduce, by the edit screen, a size of a screen which is currently being viewed by a user or can superimpose the edit screen on the screen which is currently being viewed by the user. Note, however, that the screen which is currently being viewed by the user may become difficult to view. In such a case, the above arrangement allows the favorite applications set in the television 1 to be set on the screen of the smartphone 2. This allows user to easily edit the favorite applications on the smartphone 2 while maintaining the screen of the television 1 which is currently being viewed by the user.

While the favorite applications are being edited on the smartphone 2, a message indicating that the favorite applications are being edited may be displayed on the display of the television 1. This makes it possible to prevent another user from simultaneously editing the favorite applications.

<Method for Transmitting Favorite Application>

Next, the following describes how the television 1 transmits the favorite applications set in the television 1 to the smartphone 2. Note that this method is similar to the method for transmitting favorite channels (see FIG. 66) except for that the favorite channels are replaced with favorite applications.

The control section 120 of the television 1 checks whether or not to have received a favorite application (Favorite Apps) obtaining request transmitted from the smartphone 2. In a case where no favorite application obtaining request has been received, the control section 120 repeats the checking process. On the other hand, in a case where a favorite application obtaining request has been received, the control section 120 extracts a time from a transmission parameter included in the favorite application obtaining request.

Next, the control section 120 checks whether or not the extracted time is before a time and date of updating a favorite application DB. Here, the favorite application DB is a database managed by the control section 120 (favorite application managing means). Note that the favorite application DB can be managed by a member other than the control section 120.

In a case where the extracted time is before the time and date of updating the favorite application DB, the state notifying section 122 of the control section 120 transmits a favorite application list to the smartphone 2, and the process is ended. In a case where the extracted time is on or later than the time and date of updating the favorite application DB, the state notifying section 122 of the control section 120 transmits, to the smartphone 2, a response (update unnecessary response) indicating that the favorite application does not need to be updated, and the process is ended.

<Method for Receiving Favorite Application>

Next, the following describes how the smartphone 2 receives favorite applications which have been set in the television 1. Note that this method is similar to the method for transmitting favorite channels (see FIG. 68) except for that the favorite channels are replaced with favorite applications.

The control section 220 of the smartphone 2 checks whether or not a favorite application operating screen is being displayed. In a case where the favorite application operating screen is not being displayed, the control section 220 repeats the checking process. On the other hand, in a case where the favorite application operating screen is being displayed, the control section 220 checks whether or not a favorite application list has been obtained from the television 1 before.

In a case where a favorite application list has been obtained, the control section 220 sets, as a transmission parameter, last update time and date of information on favorite applications which is held by the smartphone 2. On the other hand, in a case where no favorite application list has been obtained, the control section 220 sets the transmission parameter to a predetermined time (e.g., Jan. 1, 2001, 0 minute and 0 second past 0 o'clock). Next, the command transmitting section 222 of the control section 220 transmits, together with the transmission parameter thus set, a favorite application obtaining request to the television 1.

Subsequently, the control section 220 checks whether or not to have received a response from the television 1. In a case where no response has been received from the television 1, the control section 220 judges whether or not a time-out period has passed. In a case where the time-out period has not passed, the control section 220 checks again whether or not to have received a response from the television 1. On the other hand, in a case where the time-out period has passed, the smartphone 2 ends the process. Note that, even in the case where the time-out period has passed, it is possible that the control section 220 check again whether or not to have received a response from the television 1.

In a case where a response has been received from the television 1, the control section 220 checks whether or not the response is an update unnecessary response transmitted from the television 1. In a case where the response is an update unnecessary response, the process is ended. On the other hand, in a case where the received response is not an update unnecessary response, the control section 220 updates, based on the received favorite application list, the favorite application information managed in the smartphone 2, and the process is ended.

By receiving the favorite application list from the television 1 with the method above described, the GUI display section 221 of the smartphone 2 can control the screen of the smartphone 2 to display a list of favorite applications as illustrated in FIG. 76.

<Method for Transmitting Application List>

Next, the following describes how the television 1 transmits, to the smartphone 2, a list of applications available for the television 1. Note that this method is similar to the method for transmitting a list of channels that can be received by the television 1 (see FIG. 69) except for that the channels that can be received by the television are replaced with the applications available for the television 1.

The control section 120 of the television 1 checks whether or not to have received an application list obtaining request which has been transmitted from the smartphone 2. In a case where an application list obtaining request has not been received, the control section 120 repeats the checking process. On the other hand, in a case where an application list obtaining request has been received, the control section 120 extracts a time from a transmission parameter included in the application list obtaining request.

Next, the control section 120 checks whether or not the extracted time is before a time and date of updating an available application list DB. Here, the available application list DB is a database of applications available for the television 1 and is managed by the control section 120. Note that the receivable channel list DB can be managed by a member other than the control section 120.

In a case where an extracted time is before the time and date of updating the available application list DB, the state notifying section 122 of the control section 120 transmits the available application list to the smartphone 2, and the process is ended.

In a case where an extracted time is on or later than the time and date of updating the available application list DB, the state notifying section 122 of the control section 120 transmits, to the smartphone 2, a response indicating that the available application list does not need to be updated (update unnecessary response), and the process is ended.

### <Method for Receiving Application List>

Next, the following describes how the smartphone 2 receives, from the television 1, a list of applications available for the television 1. Note that this method is similar to the method for receiving a list of channels that can be received by the television 1 (see FIG. 71) except for that the channels that can be received by the television 1 are replaced with applications available for the television 1.

The control section 220 of the smartphone 2 checks whether or not a favorite application edit screen is being displayed. In a case where the favorite application edit screen is not being displayed, the control section 220 repeats the checking process. In a case where the favorite application edit screen is being displayed, the control section 220 checks whether or not a list of applications available for the television 1 has been obtained from the television 1 before.

In a case where the application list has been obtained before, the control section 220 sets, as a transmission parameter, a last update time and date of the application list which is held by the smartphone 2. On the other hand, in a case where the application list has not been obtained before, the control section 220 sets the transmission parameter to a predetermined time (e.g., Jan. 1, 2001, 0 minute and 0 second past 0 o'clock)

(S714).

Next, the command transmitting section 222 of the control section 220 transmits, together with the transmission parameter thus set, an application list obtaining request to the television 1.

Subsequently, the control section 220 checks whether or not to have received a response from the television 1. In a case where no response has been received from the television 1, the control section 220 judges whether or not a time-out period has passed. In a case where the time-out period has not passed, the control section 220 checks again whether or not to have received a response from the television 1. In a case where the time-out period has passed, the smartphone 2 ends the process. Note that such an arrangement is also possible in which even in a case where the time-out period has passed, the control section 220 checks again whether or not to have received a response from the television 1.

In a case where a response has been received from the television 1, the control section 220 checks whether or not the response is the update unnecessary response transmitted from the television 1. In a case where the response is the update unnecessary response, the process is ended. In a case where the response is not the update unnecessary response, the control section 220 updates, based on the received application list, the application list managed in the smartphone 2, and the process is ended.

By receiving, from the television 1, a list of applications available for the television 1 with the method above described, the GUI display section 221 of the smartphone 2 can cause the list of applications available for the television 1 to be displayed on a favorite application edit screen.

<Method for Editing Favorite Application>

Next, the following describes how to edit favorite applications which have been set in the television 1. Note that this method is similar to the method for editing favorite channels (see FIG. 72 and FIG. 73) except for that the channels are replaced with applications.

The control section 220 of the smartphone 2 checks whether or not the GUI display section 221 has changed the screen of the smartphone 2 to the favorite channel edit screen. In a case where the screen of the smartphone 2 has not been changed to the favorite application edit screen, the control section 220 repeats the checking process. In a case where the screen of the smartphone 2 has been changed to the favorite application edit screen, the control section 220 transmits, to the television 1, a notification (edit start notification) notifying the television 1 of start of editing of favorite applications.

Then, the control section 220 checks whether or not to have received a response from the television 1. In a case where no response has been received from the television 1, the control section 220 judges whether or not a time-out period has passed. In a case where the time-out period has not passed, the control section 220 checks again whether or not to have received a response from the television 1. In a case where the time-out period has passed, the smartphone 2 ends the process. Note that such an arrangement is also possible in which even in a case where the time-out period has passed, the control section 220 checks again whether or not to have received a response from the television 1.

In a case where a response has been received from the television 1, the control section 220 checks whether or not the response thus received is an edit permission response transmitted from the television 1. In a case where the response thus received is the edit permission response, the control section 220 checks whether or not the edit screen has been ended. In a case where the edit screen has not been ended, the control section 220 repeats the checking process.

In a case where the edit screen has been ended, the control section 220 checks whether or not the edit screen was ended by pressing “OK”. In a case where the edit screen was ended by pressing “OK”, the command transmitting section 222 of the control section 220 transmits an editing content to the television 1 together with an edit completion notification. By thus transmitting an editing content together with the edit completion notification in a case where the favorite applications have been updated, the control section 220 notifies the television 1 that the favorite applications have been updated.

Then, the control section 220 checks whether or not to have received an update response from the television 1. In a case where no update response has been received from the television 1, the control section 220 repeats the checking process. In a case where the update response has been received from the television 1, the control section 220 ends the process.

On the other hand, in a case where the response transmitted from the television 1 is not the edit permission response, the smartphone 2 causes information indicative of an uneditable state to be displayed on the screen. Note that such an arrangement is also possible in which the information indicative of an uneditable state is displayed on the television 1.

After the uneditable state is displayed or in a case where the edit screen was not ended by pressing “OK”, the command transmitting section 222 of the control section 220 transmits an edit completion notification to the television 1, and the process is ended. By thus transmitting only the edit completion notification in a case where the favorite applications have not been updated, the control section 220 notifies the television 1 that the favorite applications have not been updated.

Next, the following describes processes carried out in the television 1 in a case where favorite applications set in the television 1 are edited on the smartphone 2. The control section 120 of the television 1 checks whether or not to have received the notification (the edit start notification) of start of editing of favorite applications which notification was transmitted by the smartphone 2. In a case where no edit start notification has been received, the control section 120 repeats the checking process. On the other hand, in a case where the edit start notification has been received, the control section 120 checks whether or not a mobile terminal (another mobile terminal) other than the smartphone 2 is editing (currently editing) the favorite applications.

In a case where another mobile terminal is editing the favorite channels, the control section 120 notifies the smartphone 2 of a response (edit rejection response) indicating rejection of start of editing. In a case where another mobile terminal is not editing the favorite channels, the control section 120 checks whether or not the favorite applications are being edited on the television 1.

In a case where the favorite applications are being edited on the television 1, the control section 120 ends a favorite application edit screen on the television 1. After the favorite application edit screen is ended or in a case where the favorite applications are not being edited on the television 1, the control section 120 notifies the smartphone 2 of an edit permission response. The television 1 records information indicating that the smartphone 2 is editing the favorite applications.

After the smartphone 2 is notified of the edit rejection response or after the information indicating that the smartphone 2 is editing the favorite applications is recorded, the control section 120 checks whether or not to have received an edit completion notification from the smartphone 2. In a case where no edit completion notification has been received, the control section 120 judges whether or not connection with the smartphone 2 has been cut off. In a case where connection with the smartphone 2 has not been cut off, the control section 120 checks again whether or not to have received a response completion notification from the television 1.

In a case where connection with the smartphone 2 has been cut off or in a case where the edit completion notification has been received, the control section 120 checks whether or not a favorite application editing content (registration content) has been updated. Specifically, the control section 120 checks the editing content transmitted by the smartphone 2. In a case where the editing content has been updated, the control section 120 updates favorite application registration information managed in the television 1. Specifically, the control section 120 updates a favorite application DB. Then, the control section 120 transmits, to the television 1, a response (update response) indicating that the favorite applications have been updated.

After the update response is transmitted or in a case where the editing content has not been updated, the control section 120 checks whether or not a terminal (the smartphone 2 in this example) which is supposed to update the favorite applications is editing the favorite applications. In a case where the smartphone 2 is not editing the favorite applications, the process is ended.

In a case where the smartphone 2 is editing the favorite applications, the control section 120 deletes the information indicating that the smartphone 2 is editing the favorite applications, and the process is ended.

By updating the favorite application registration information, the television 1 changes to a screen (Update favorite App list screen) indicative of completion of editing of the favorite applications (see FIG. 77).

<Modification of Favorite Application Display Screen>

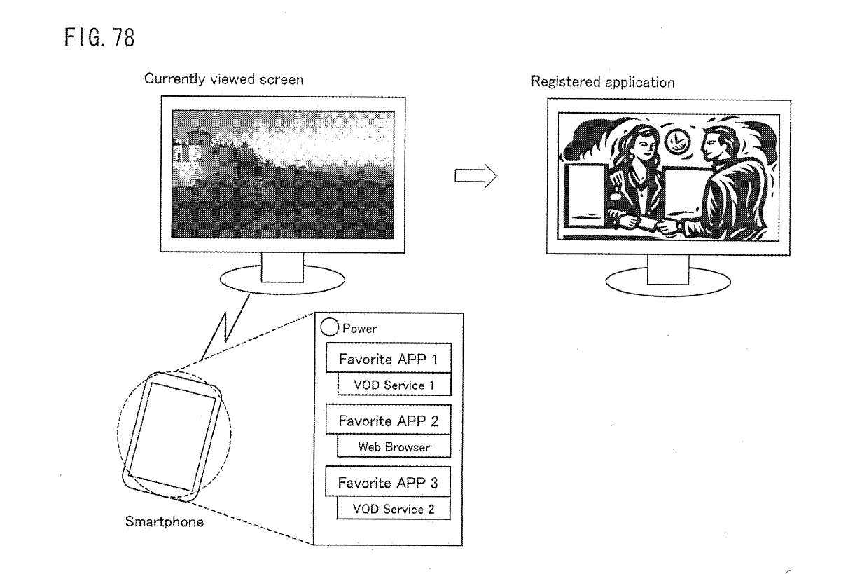

The favorite application display screen is not limited to the one illustrated in FIG. 76, and can be, for example, displayed as illustrated in FIG. 78. As illustrated in FIG. 78, a Favorite APP key can be selected on the smartphone 2, as with the Favorite APP key on the remote control or the like. In this case, when a user selects the Favorite APP key, the smartphone 2 obtains, from the television 1, a list of favorite applications registered in the television 1, and causes the list to be displayed on the screen. Then, when the user selects an application from applications registered as the favorite applications, the television 1 switches the screen to the application thus selected.

By thus allowing a user to check, on the smartphone 2, the favorite applications registered in the television 1, it is possible to present, to the user, which applications are registered ones even if the user does not remember the registration content. Further, by thus allowing the favorite applications to be displayed in a list, a user can easily select a desired application.

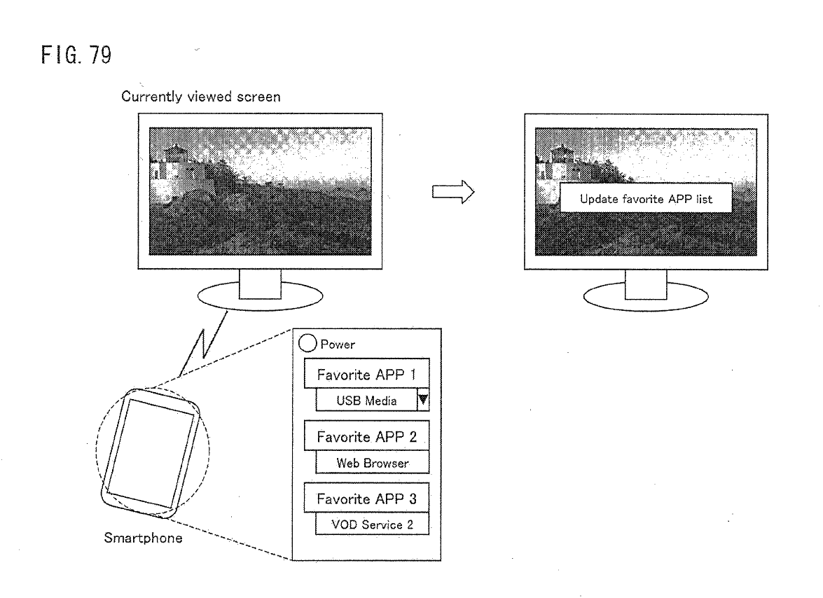

Further, the favorite application edit screen is not limited to the one illustrated in FIG. 77, and can be, for example, displayed as illustrated in FIG. 79. As illustrated in FIG. 79, when any one of the applications included in the favorite application list is selected, the smartphone 2 changes to the favorite application edit screen. When a pull-down key (downward triangle) displayed besides an application name is selected, the application list is displayed on the pull-down menu of the smartphone 2. This allows a user to select a new favorite application from the pull-down menu. When the user selects the new favorite application and ends editing, favorite application update information is transmitted from the smartphone 2 to the television 1. Upon receipt of the favorite application update information, the television 1 updates the favorite applications set in the television 1 on the basis of the favorite application update information thus received. Then, a message indicating that the favorite applications have been updated is displayed on the display of the television 1.

According to the arrangement, a user can more easily update favorite applications as compared with a case of updating favorite applications by opening the setting screen of the television 1.

(Function of Channel Selection from Channel List)

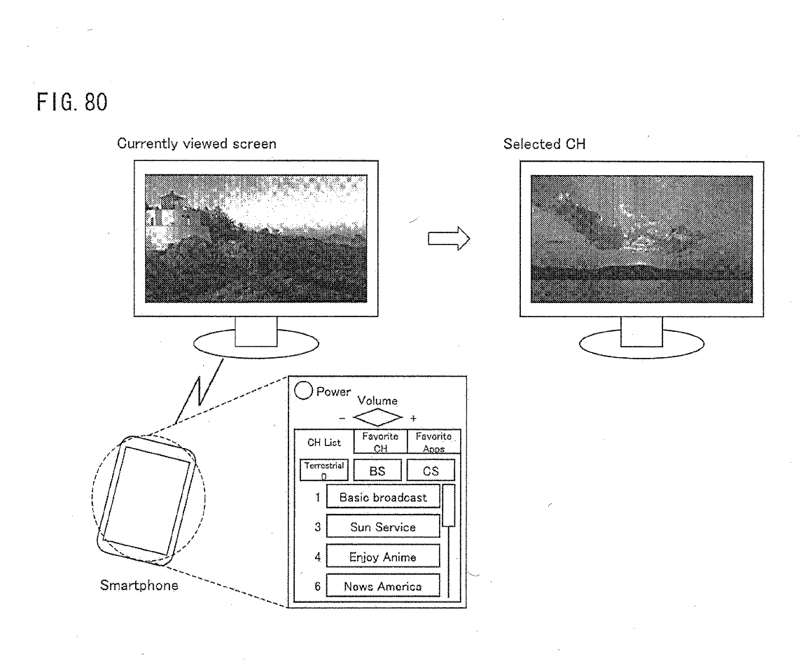

With reference to FIG. 80, the following describes a function of channel selection from a channel list on the smartphone (mobile terminal) 2 of the present invention. The function of channel selection from a channel list is a function of causing a list of channels that can be received by the television 1 to be displayed on the screen of the smartphone 2 and causing a channel selected from the list to be displayed on the television 1.

FIG. 80 is a view schematically illustrating an example of the function of channel selection from a channel list with the use of the smartphone 2. As illustrated in FIG. 80, the smartphone 2 displays a list of channels that can be received by the television 1, upon selection of a channel list (CH List) tab for displaying the list of channels that can be received by the television 1. The present embodiment provides a configuration in which channel lists of terrestrial D, BS, and CS are selectively displayed, as illustrated in FIG. 80. Note, however, that the present invention is not limited to this. Alternatively, these channel lists may be displayed seamlessly while all the channels in the channel lists are not grouped under terrestrial D, BS, and CS.

As illustrated in FIG. 80, the channels that can be received by the television 1 are displayed in a list that can be scrolled. Through a user's flicking or dragging operation in a top-to-bottom direction, channels on next and subsequent pages can be displayed on the smartphone 2. When a user selects an item (channel name) in the channel list, the screen of the television 1 is switched from a currently viewed screen to a screen of the channel thus selected.

<Method for Transmitting Channel List>

A method for transmitting, to the smartphone 2, a list of channels that can be received by the television 1 in this function is identical to the method for transmitting a channel list in the favorite channel function, and therefore is not described repeatedly.

<Method for Receiving Channel List>

Next, the following describes how the smartphone 2 receives, from the television 1, a list of channels that can be received by the television 1. First, the control section 220 checks whether the channel list (CH List) screen is being displayed. In a case where the channel list (CH List) screen is not being displayed, the checking process is repeated. In a case where the channel list (CH List) screen is being displayed, the control section 220 executes the processes in S712 and subsequent steps in the method for receiving a channel list in the favorite channel function described with reference to FIG. 71. This allows the smartphone 2 to receive, from the television 1, a list of channels that can be received by the television 1.

(Function of Application Switching Using Application List (DOCK))

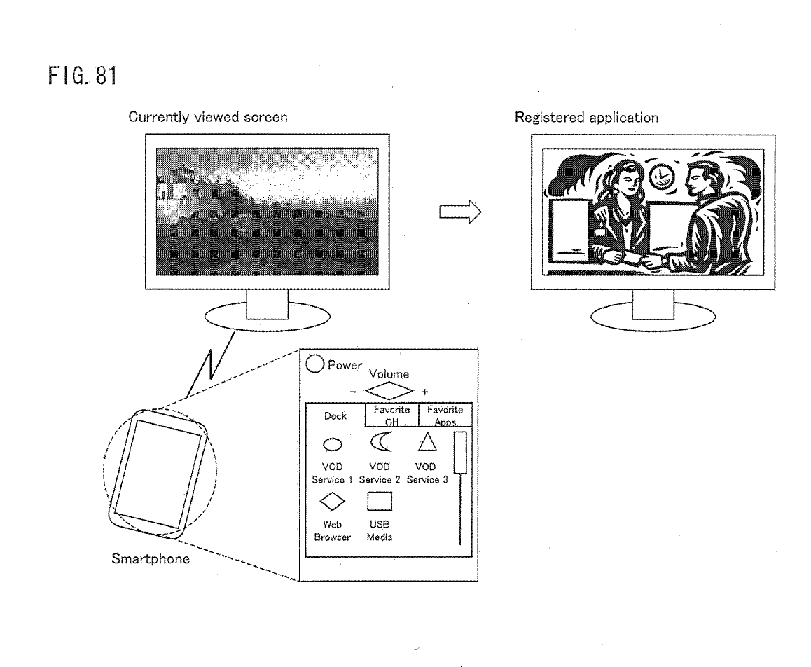

With reference to FIG. 81, the following describes a function of application switching using an application list (DOCK) in the smartphone (mobile terminal) 2 of the present invention. The function of application switching using an application list (DOCK) is a function of causing a list of applications available for the television 1 to be displayed on the screen of the smartphone 2 and causing an application selected from the list to be displayed on the television 1.

FIG. 81 is a view schematically illustrating an example of the function of application switching using an application list (DOCK) with the use of the smartphone 2. As illustrated in FIG. 81, the smartphone 2 displays a list of applications available for the television 1, upon selection of a DOCK tab for displaying the list of applications available for the television 1. As illustrated in FIG. 81, the applications available for the television 1 are displayed so that application names (service names) and icons (an oval icon, a triangular icon, and a moon-shaped icon in FIG. 76) corresponding to the respective applications are displayed. Note that either the application names or the icons corresponding to the respective applications may be displayed in the application list. The application list is displayed so as to be scrollable. Through a user's flicking or dragging operation in a top-to-bottom direction, applications on next and subsequent pages can be displayed on the smartphone 2. When a user selects an item (application name or an icon) in the application list, the screen of the television 1 is switched from the currently viewed screen to the screen for the application thus selected.

<Method for Transmitting Application List>

A method for transmitting, to the smartphone 2, a list of applications available for the television 1 in this function is identical to the method for transmitting an application list in the favorite application function, and therefore is not described repeatedly.

<Method for Receiving Application List>

Next, the following describes how the smartphone 2 receives, from the television 1, a list of application available for the television 1. First, the control section 220 of the smartphone 2 checks whether or not a DOCK screen is being displayed. In a case where the DOCK screen is not being displayed, the checking process is repeated. In a case where the DOCK screen is being displayed, the control section 220 executes the favorite application edit screen checking process and the subsequent processes in the method for receiving an application list in the favorite application function. This allows the smartphone 2 to receive, from the television 1, a list of applications available for the television 1.

<Modification of Application List Display Screen>

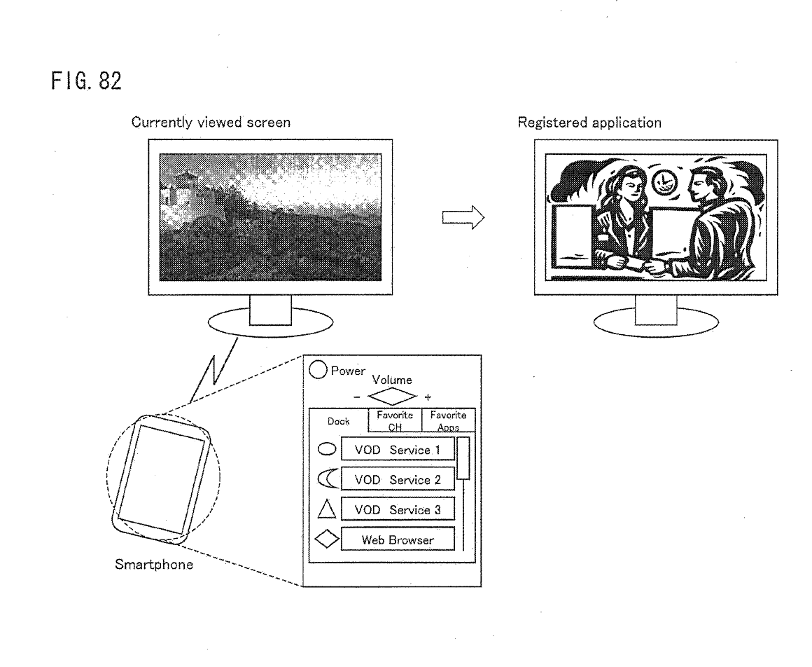

The application list display screen is not limited to the one illustrated in FIG. 81, and can be, for example, displayed as illustrated in FIG. 82. As illustrated in FIG. 82, the list of applications available for the television 1 may be displayed in a column on the smartphone 2. As in the case of FIG. 81, the smartphone 2 displays at least one of (i) the application names indicative of the applications available for the television 1 and (ii) icons representing the respective applications.

Through a user's flicking or dragging operation in a top-to-bottom direction, applications on next and subsequent pages can be displayed on the smartphone 2. When a user selects an item (an application name or an icon) in the application list, the screen of the television 1 is switched from a currently viewed screen to a screen for the application thus selected.

In a case where the application list is displayed on the screen of the television 1, the application list is displayed on an OSD screen or the like. This sometimes hides the currently viewed screen. However, by displaying the application list on the screen of the smartphone 2 as illustrated in FIG. 81 and FIG. 82, a desired application can be selected by a user without hiding the currently viewed screen.

(Service List Displaying Function)

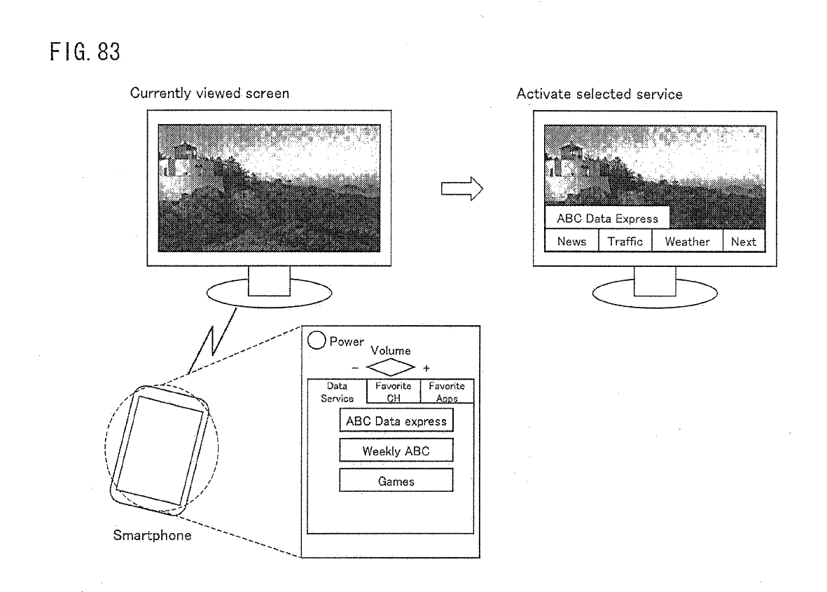

With reference to FIGS. 83 through 85, the following describes a service list displaying function in the smartphone (mobile terminal) 2 of the present invention. The service list displaying function is a function of causing a list (service list) of data broadcast content available for the television 1 to be displayed on the screen of the smartphone 2.

FIG. 83 is a view schematically illustrating an example of the service list function using the smartphone 2. As illustrated in FIG. 83, upon receipt of a data service from the television 1, the smartphone 2 causes a list of data broadcast content available for the television 1 to be displayed on a data service (Data Service) tab for executing the service list function. Note that although three pieces of data broadcast content are displayed on the smartphone 2 of FIG. 83, the number of pieces of data broadcast content displayed on the smartphone 2 is not limited to this.

In a case where each of a plurality of pieces of content included in the data broadcast content is content that can be displayed by itself, the television 1 sequentially transmits each of the plurality of pieces of content to the smartphone 2 when loading of that piece of content is completed. Meanwhile, in a case where the data broadcast content is data broadcast content that cannot be displayed on the television 1 unless all of a plurality of pieces of content included in the data broadcast content are loaded, the television 1 transmits the plurality of pieces of content collectively to the smartphone 2 when loading of all of the plurality of pieces of content is completed.

When a user selects any one piece of data broadcast content from the data broadcast content list displayed on the smartphone 2, the television 1 causes the data broadcast content thus selected to be displayed on a currently viewed screen. As illustrated in FIG. 83, in a case where “ABC Data express” is selected, the television 1 causes “ABC Data express” thus selected to be displayed on the currently viewed screen.

Note that the smartphone 2 may be set by a user so as to automatically change to a screen for displaying a list of data broadcast content after reception of the data broadcast content from the television 1 or may be set by a user so as not to automatically change to a screen for displaying a list of data broadcast content after reception of the data broadcast content from the television 1. Note that smartphone 2 may be set before shipment so as to automatically change to a screen for displaying a list of data broadcast content after reception of the data broadcast content from the television 1.

<Method for Transmitting Service List>

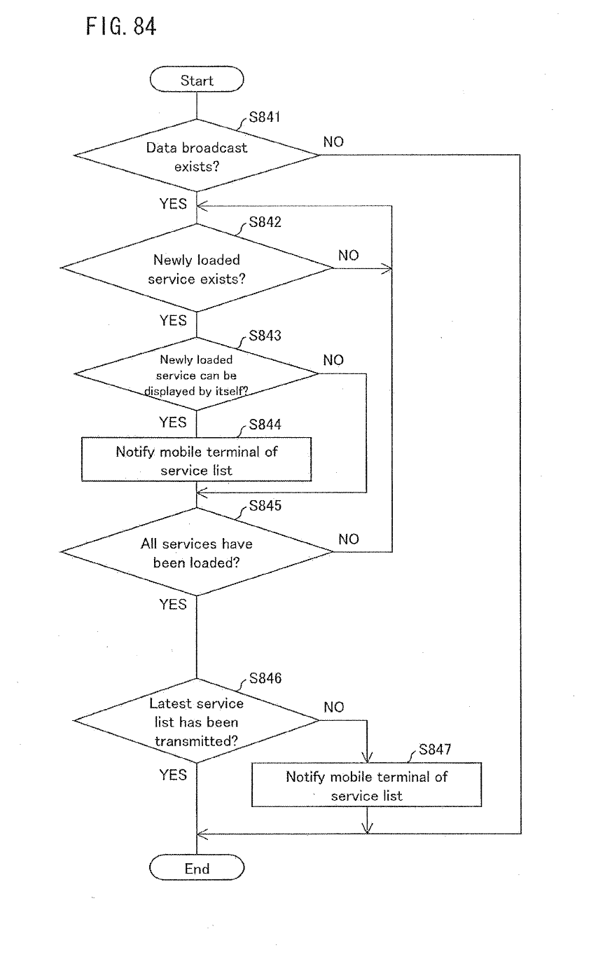

Next, with reference to FIG. 84, the following describes how a list of data broadcast content available for the television 1 is transmitted to the smartphone 2. FIG. 84 is a flow chart illustrating an example of how a list (service list) of data broadcast content available for the television 1 is transmitted to the smartphone 2. Note that in the following flow chart, the data broadcast content is referred to as a service.

As shown in FIG. 84, the control section 120 of the television 1 checks whether or not there is data broadcast content (S841). In a case where there is no data broadcast content (NO in S841), the process is ended. In a case where there is data broadcast content (YES in S841), the control section 120 checks whether or not there is a newly loaded service (S842).

In a case where there is no newly loaded service (NO in S842), the control section 120 repeats S842. In a case where there is a newly loaded service (YES in S842), the control section 120 checks whether or not the newly loaded service is available in the television 1 by itself (S843).

In a case where the newly loaded service is available in the television 1 by itself (YES in S843), the state notifying section 122 of the control section 120 notifies (transmits) the smartphone 2 of a service list (list of data broadcast content) including the newly loaded service (S844). After S844 or in a case where the newly loaded service is not available in the television 1 by itself (NO in S843), the control section 120 checks whether or not all of the services have been loaded (S845).

In a case where not all of the services have been loaded (NO in S845), the control section 120 returns to the process of S842. In a case where all of the services have been loaded (YES in S845), the control section 120 checks whether or not a latest service list has been transmitted (S846).

In a case where the latest service list has been transmitted (YES in S846), the television 1 ends the process. In a case where the latest service list has not been transmitted (NO in S846), the state notifying section 122 of the control section 120 notifies (transmits) the smartphone 2 of the service list (S847), and ends the process.

<Method for Receiving Service List>

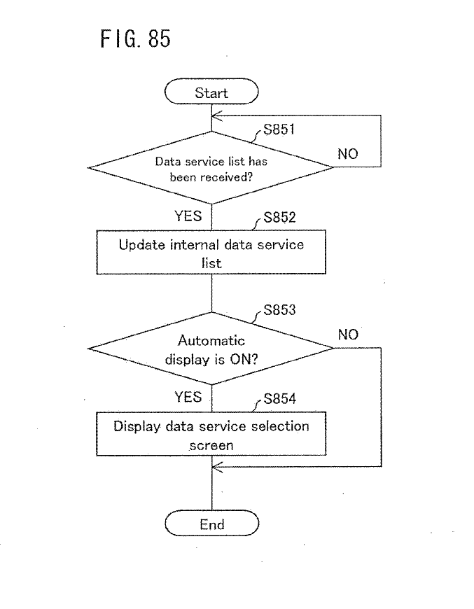

Next, with reference to FIG. 85, the following describes how the smartphone 2 receives, from the television 1, a list of data broadcast content available for the television 1. FIG. 85 is a flow chart showing an example of how the smartphone 2 receives a list (service list) of data broadcast content available for the television 1. Note that in the following flow chart, the data broadcast content is referred to as a service.

As shown in FIG. 85, the smartphone 2 checks whether or not to have received a service list (data service list) from the television 1 (S851). In a case where no data service list has been received (NO in S851), the control section 220 repeats S851. In a case where the data service list has been received (YES in S851), the control section 220 updates the data service list managed in the smartphone 2 (S852).

Then, the control section 220 checks whether or not the smartphone 2 is set so as to automatically change to a data service list selection screen (automatic display) (S853). In a case where the automatic display is not set (NO in S853), the process is ended. Note that in a case where the automatic display is not set, a pop-up indicating that the data service has been updated may be displayed on the screen of the smartphone 2.

In a case where the automatic display is set (YES in S853), the data service selection screen is displayed on the screen of the smartphone 2 (S854), and the process is ended.

By receiving, from the television 1, a list of data broadcast content available for the television 1 with the method described above, the GUI display section 221 of the smartphone 2 can display the list of the data broadcast content available for the television 1. Further, since the smartphone 2 displays only the data broadcast content available for the television 1, a user can promptly use the data broadcast content displayed on the smartphone 2. It is also possible to reduce a risk of an erroneous operation of selecting data broadcast content unavailable for the television 1.

[Other Applications]

Although the above description has described a remote control application for causing the smartphone 2 to operate as a conventional infrared remote control, the control method of the television 1 described above can be applied also to other applications. The following describes some examples of such application.

(Browser Application)

The television 1 and the smartphone 2 are provided with a web browser for viewing web content. The following describes a method for controlling a web browser operating in the television 1 with the use of a web browser operating in the smartphone 2. To be more specific, the following describes a method for causing the web browser operating in the television 1 to access a web page which is being viewed with the web browser operating in the smartphone 2.

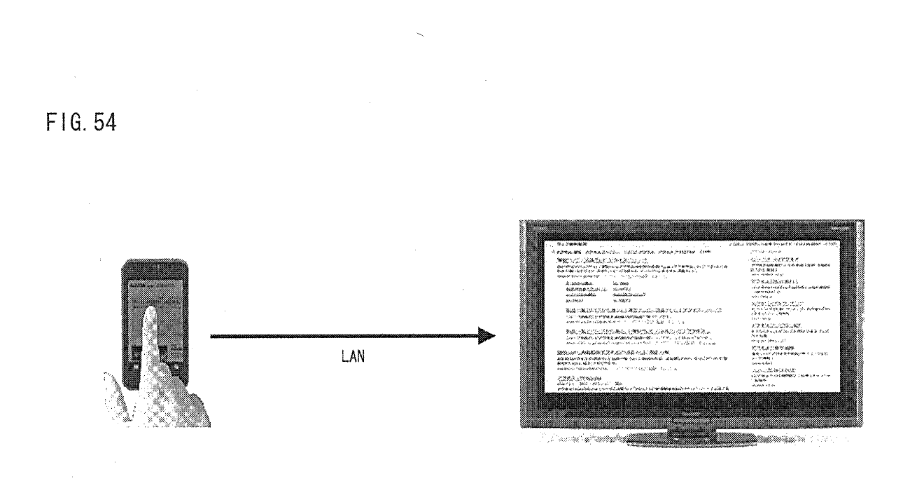

FIG. 54 is a view schematically illustrating a method for causing the web browser operating in the television 1 to access a web page which is being viewed with the web browser operating in the smartphone 2.

When a user executes a predetermined specific operation while viewing a web page A, the smartphone 2 transmits, to the television 1, a control command instructing access to the web page A and containing a URL of the web page A. Upon receipt of the control command, the television 1 activates a web browser if it is not activated. Then, the web browser operating in the television 1 obtains, via the Internet, a resource (HTML file and the like) designated by the URL contained in the control command, and reproduces the web page A with the use of the resource thus obtained. This allows the web page A which is being viewed on the smartphone 2 to be viewed also on the television 1.

Note that some websites have web pages for PC, television, and smartphone and assign these web pages different URLs. In preparation for this, the method by which the web browser operating in the television 1 accesses the web page A may be modified as follows.

Specifically, the web browser operating in the television 1 transmits the URL contained in the control command to a predetermined redirect server. The redirect server has a database in which a URL of a web page for smartphone and a URL of a web page for television are registered so as to be associated with each other. The redirect server translates the URL of the web page A for smartphone obtained from the television 1 into a URL of a webpage A′ for television, and returns it to the television 1. The television 1 obtains, via the Internet, a resource designated by the URL obtained from the redirect server, and reproduces the web page A′ with the use of the resource thus obtained. This allows the web page A′ for television corresponding to the web page A which is being viewed on the smartphone 2 to be viewed on the television 1.

(DLNA Application)

The television 1 functions as a DNLA media player for reproducing content accumulated in a media server 4. The smartphone 2 functions as a DNLA media player for reproducing the content accumulated in the media server 4 and as a DLNA media controller for controlling the television 1 functioning as the DLNA media player. Use of these makes it possible to achieve organic cooperation between the television 1 and the smartphone 2 on a moving and still image reproduction scene.

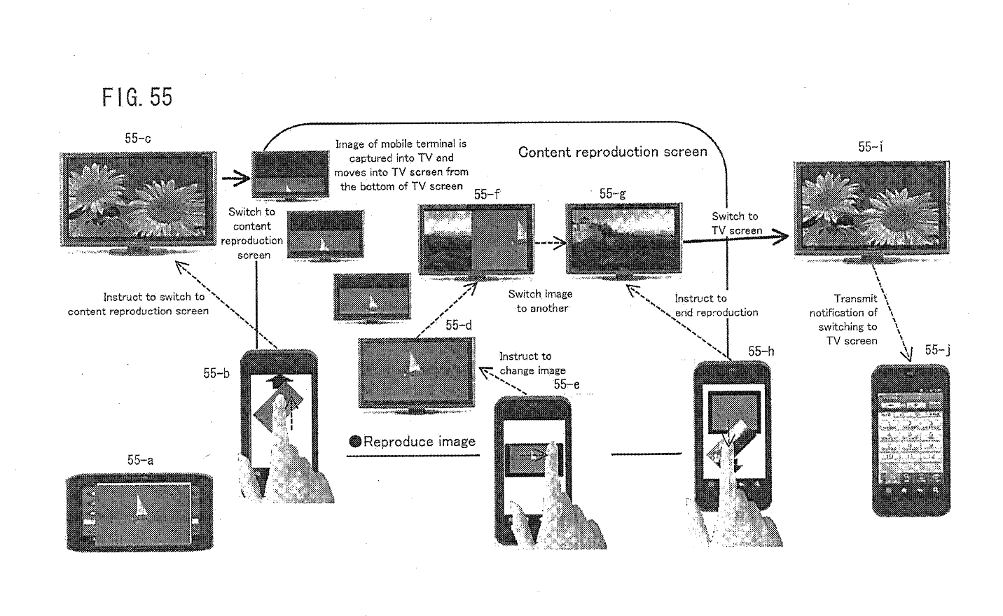

FIG. 55 is a view illustrating a cooperative operation between the television 1 and the smartphone 2 on a still image reproduction scene.

When a user carries out an operation of dragging an image obtained from the media server 4 upward while reproducing it on the smartphone 2 (55-a), the smartphone 2 transmits, to the television 1, a command instructing reproduction of the image. At the same time, the smartphone 2 displays animation of this image moving upward and out of the screen while being tilted (55-b). Upon receipt of this command (55-c), the television 1 obtains an image designated by the command from the media server 4 and reproduces it. In starting reproduction of the image, the television 1 displays animation of this still image moving into the screen from a bottom of the screen as illustrated in FIGS. 55 (55c and 55d).

By thus displaying, on the smartphone 2, animation of an image moving upward and out of the screen and displaying, on the television 1, animation of an image moving into the screen from the bottom of the screen, it is possible to give a user a fresh impression, i.e., make the user feel as if an image has jumped from the smartphone 2 to the television 1.

When a user carries out, on the smartphone 2, an operation of flicking an image being reproduced rightward, the smartphone 2 switches a displayed image by causing the image being reproduced to move rightward and out of the screen and causing a new image obtained from the media server 4 to move into the screen from the left side. At the same time, the smartphone 2 transmits, to the television 1, a command instructing reproduction of the new image (55-e). Upon receipt of this command, the television 1 obtains an image designated by the command from the media server 4 and reproduces it. In starting reproduction of the image, the television 1 causes an image being reproduced to fade out of the screen and causes the new image thus obtained from the media server 4 to fade into the screen (55-d through 55-g).

By thus causing an image to fade into/fade out of the screen of the television 1 at a same timing as when an image is moved into/out of the screen of the smartphone 2, it is possible to make a user feel as if the user is operating the image displayed on the television 1 by touching it.

When a user carries out, on the smartphone 2, an operation of dragging an image being reproduced downward, the smartphone 2 transmits, to the television 1, a command instructing stop of reproduction of the image. At the same time, the smartphone 2 displays an animation of the image moving into the screen from the top of the screen while being tilted (55-h). Upon receipt of this command (55-g), the television 1 stops reproduction of the image and switches a reproduction target to broadcasting content. Having completed the switching, the television 1 notifies the smartphone 2 that the reproduction target has been switched to the broadcasting content (55-i). Upon receipt of this notification, the smartphone 2 displays a remote control top screen (55-j).

(State Notification from Smartphone)

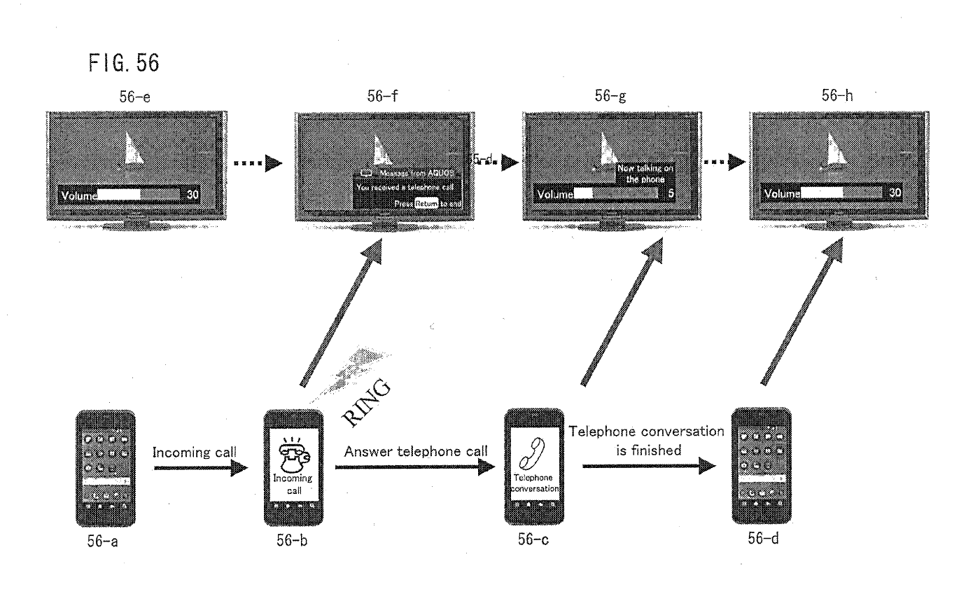

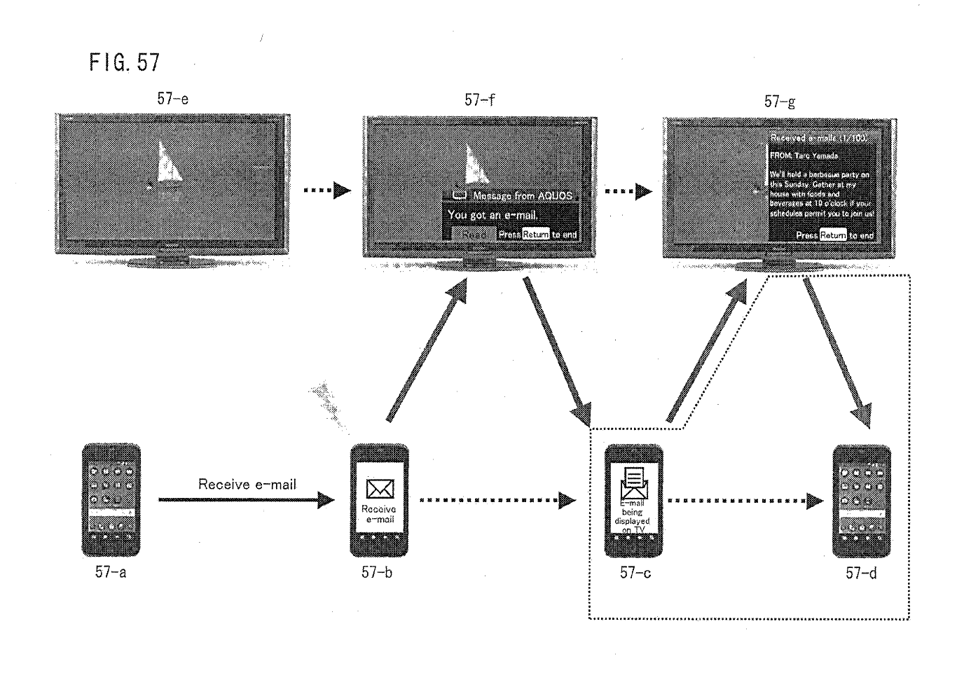

Next, with reference to FIGS. 56 through 57, the following describes use of state notification from the smartphone 2.

FIG. 56 is a view illustrating a method for controlling a volume level of the television 1 with the use of incoming call notification from the smartphone 2.

Upon receipt of a telephone call, the smartphone 2 notifies the television 1 of such an incoming call (56-b). Upon receipt of this notification, the television 1 displays, on its display, a message indicating the receipt of the telephone call (56-f), and lowers the volume level (56-g). This makes it less likely that conversation using the smartphone 2 is hindered by audio outputted from the television 1. When the telephone call is ended, the smartphone 2 notifies the television 1 of the end of the telephone call. Upon receipt of this notification, the television 1 increases the volume level to the original level.

FIG. 57 is a view illustrating a method for displaying, on the television 1, an e-mail received by the smartphone 2.

Upon receipt of an e-mail, the smartphone 2 displays a message indicating the receipt of the e-mail, and notifies the television 1 of the receipt of the e-mail (57-b). Upon receipt of this notification, the television 1 displays, on its display, a message indicating the receipt of the e-mail (57-f). This message contains an option for allowing the content of the e-mail to be displayed on the television 1. When a user selects this option, the television 1 notifies the smartphone 2 of the selection of this option (57-f). Upon receipt of this notification, the smartphone 2 displays a message indicating that the main body of the e-mail will be displayed on the television 1 and transmits the main body of the e-mail to the television 1 (57-c). The television 1 displays the main body of the e-mail thus received (57-g). After display of the e-mail is ended, the television 1 notifies the smartphone 2 of the end of display of the e-mail (57-g). Upon receipt of this notification, the smartphone 2 deletes the message indicating that the main body of the e-mail will be displayed on the television 1, and returns to a standby mode.

Note that although the above description has dealt with an arrangement in which the smartphone 2 returns to a standby mode upon receipt of notification from the television 1 indicating the end of display of an e-mail (see the part surrounded by the dotted line in FIG. 57), it is also possible to employ an arrangement in which the smartphone 2 returns to a standby mode immediately after transmitting the main body of the e-mail to the television 1.

(Other Applicabilities)

The television 1 may include individual identifying means so that a special GUI is displayed only in a case where a user of the smartphone 2 is a user, such as a serviceman, who satisfies a predetermined condition. A special GUI displayed only in a case where a user of the smartphone 2 is a serviceman is, for example, a GUI including a self-diagnostic function executing button, an analysis screen display button, a setting reset button, or the like. This makes it easy for the serviceman to repair troubles without the need for use of special equipment. Note that, instead of the arrangement in which a special GUI available only for a serviceman is displayed, it is also possible to employ an arrangement in which a special GUI (having, for example, a button corresponding to a function necessary only at a production stage) available only for a manufacturer is displayed.

The television 1 may include means for obtaining external information from an outside via a network so that a special GUI is displayed only in a case where specific external information, such as planned blackout information, is obtained. A special GUI displayed only in a case where planned blackout information is obtained is, for example, a GUI having a button for switching the television 1 from driving using a commercial power source to driving using a battery. Such an arrangement is effective also for application to operation target devices other than the television 1. For example, in a case of operation of a solar electric generating system, a GUI having a button for switching to an autonomous operation mode may be displayed. In a case of operation of an air conditioner, restriction may be placed on settable target temperature on the basis of power consumption information supplied from a power company.

As used herein, the television receiver refers to a device which receives a broadcast image, and encompasses both of a device having a function of displaying the image and a device not having a function of displaying the image. For example, in a system constituted by a tuner and a monitor, the tuner, the monitor, and the system are all deemed as a television receiver. This is because the tuner has a function of receiving a broadcast image, the monitor has both of a function of receiving a broadcast image via a tuner and a function of displaying the image, and the system has both of a function of receiving a broadcast image and a function of displaying the image. As used herein, “broadcast” is not limited to radio broadcast such as terrestrial digital broadcast, and encompasses wired broadcast such as a cable television and IPTV (Internet Protocol Television).

(Preferable Mode of the Present Invention)

As described above, a system according to the present invention is a system including: a television receiver; and an information terminal, the television receiver including: state switching means configured to switch a state of the television receiver to another state corresponding to a command having been transmitted from the information terminal; and state notifying means configured to provide, with the information terminal, one of (i) a notification of the state of the television receiver to which state the state switching means has switched over and (ii) an instruction to perform switching of a GUI (Graphical User Interface) to another GUI corresponding to the state of the television receiver to which state the state switching means has switched over, the information terminal including: command transmitting means configured to transmit, to the television receiver, a command corresponding to a user operation performed on the GUI, which is displayed on a touch panel provided in the information terminal; and GUI switching means configured to switch the GUI to be displayed on the touch panel to one of (a) another GUI corresponding to a state of the television receiver which state has been notified from the television receiver and (b) another GUI corresponding to the instruction having been provided by the television receiver.

Further, a control method according to the present invention is a control method for controlling a television receiver with use of an information terminal, the control method comprising: a command transmission step of the information terminal transmitting, to the television receiver, a command corresponding to a user operation performed on a GUI (Graphical User Interface), which is displayed on a touch panel provided in the information terminal; a state switching step of the television receiver switching a state of the television receiver to another state corresponding to a command having been transmitted from the information terminal; a state notifying step of the television receiver providing, with the information terminal, one of (i) a notification of the state of the television receiver to which state the state switching step has switched over and (ii) an instruction to perform switching of the GUI to another GUI corresponding to the state of the television receiver to which state the state switching step has switched over; and a GUI switching step of the information terminal switching the GUI to be displayed on the touch panel to one of (a) another GUI corresponding to a state of the television receiver which state has been notified from the television receiver and (b) another GUI corresponding to the instruction having been provided by the television receiver.

According to the above arrangement, the GUI to be displayed on the touch panel of the information terminal is automatically switched over to another GUI corresponding to the state of the television receiver. This makes it possible to obviate the trouble of switching, when there occurs a change in the state of the television receiver, the GUI to be displayed on the touch panel of the information terminal to another GUI corresponding to the post-change state of the television receiver. Alternatively, it is possible to reduce a risk of an erroneous operation resulting from the impossibility of grasping that the state of the information terminal has changed.

The system according to the present invention is preferably arranged such that the state notifying means has a function of providing a notification of a power status of the television receiver, and the GUI switching means has a function of switching an indication color of an indicator provided on a toggle switch, which is a GUI element for switching the power status of the television receiver, to another indication color corresponding to the notification from the state notifying means.

According to the above arrangement, the event that acts as a trigger for switching of the indication color of the indicator is switching of the power status of the television receiver, rather than a user operation performed with respect to the toggle switch. This makes it possible to reduce a risk of an erroneous operation intended to switch the state of the television receiver to an ON state even in a situation where the television receiver is in the ON state, and a risk of an erroneous operation intended to switch the state of the television receiver to a standby state even in a situation where the television receiver is in the standby state.

The system according to the present invention is preferably arranged such that the state notifying means has a function of providing a notification of a volume level of the television receiver, and the GUI switching means has a function of switching an indication position of a slider, which is a GUI element for performing switching of the volume level of the television receiver, to a position corresponding to the notification from the state notifying means.

According to the above arrangement, it is possible to reliably synchronize the indication position of the slider to a volume level of the television receiver. This makes it possible to reduce a risk of an unintentional user operation performed with respect to the slider.

The system according to the present invention is preferably arranged such that the state notifying means has a function of providing a notification that the television receiver is displaying an electronic program guide, and the GUI switching means has a function of switching the GUI to be displayed on the touch panel to another GUI specialized for moving a cursor in the electronic program guide.

According to the above arrangement, it is possible to obviate the trouble of switching, when the electronic program guide is displayed on the television receiver, the GUI to be displayed on the touch panel of the information terminal to another GUI specialized for moving a cursor. In addition, since the GUI to be displayed on the touch panel of the information terminal is a GUI specialized for moving a cursor, it is possible to reduce a risk that the user may accidentally perform an operation which is not accepted by the television receiver in the situation where the television receiver is displaying the electronic program guide.

The system according to the present invention is preferably arranged such that the state notifying means has a function of providing a notification of a broadcast station name being selected as a channel set, and the GUI switching means has a function of switching a broadcast station name to be displayed together with a corresponding button, which is a GUI element for designating a display target channel, to another broadcast station name corresponding to the notification from the state notifying means.

According to the above arrangement, it is possible to let the user know about which of the buttons should be tapped to display a broadcasting program of which of the broadcast stations. This makes it possible to reduce a risk of an erroneous operation resulting from the impossibility of grasping such correspondence.

The system according to the present invention is preferably arranged such that the state notifying means has a function of providing a notification of a channel being selected as a display target channel, and the GUI switching means has a function of switching a broadcast station name to be displayed together with a corresponding button, which is a GUI element for switching a display target channel up or down, to another broadcast station name corresponding to the notification from the state notifying means.

According to the above arrangement, it is possible to let the user know about which of the broadcast stations offers a broadcasting program being displayed. This makes it possible to reduce a risk of an erroneous operation resulting from the impossibility of grasping such correspondence.

The system according to the present invention is preferably arranged such that the state notifying means has a function of providing a notification of a device name of a source device being connected to the television receiver, and the GUI switching means has a function of switching a device name to be displayed on a list, which is a GUI element for selecting an input source, to another device name corresponding to the notification from the state notifying means.

According to the above arrangement, it is possible to let the user know about which of items in the list should be tapped to select which of source devices. This makes it possible to reduce a risk of an erroneous operation resulting from the impossibility of grasping such correspondence.

The system according to the present invention is preferably arranged such that the state notifying means has a function of providing a notification of a source device being selected as an input source, and the GUI switching means has a function of switching the GUI to be displayed on the touch panel to another GUI specialized for performing an operation of a source device having been notified from the state notifying means.

According to the above arrangement, it is possible to obviate the trouble of switching, when a certain source device is being selected as the input source, the GUI to be displayed on the touch panel of the information terminal to another GUI specialized for performing an operation of that source device. In addition, since the GUI to be displayed on the touch panel of the information terminal is a GUI specialized for performing an operation of that source device, it is possible to reduce the risk that the user may accidentally perform an operation which is not accepted by the television receiver in the situation where that source device is being selected as the input source.

The system according to the present invention is preferably arranged such that the state notifying means has a function of providing a notification of a character string having been entered in a text field which the television receiver displays on a display thereof and having been confirmed as being an entered character string, and the GUI switching means has a function of switching a character string to be shown in a text field which the information terminal displays on the touch panel thereof to another character string corresponding to the notification from the state notifying means.

According to the above arrangement, it is possible to reduce a risk of information terminal's misoperation of entering other character string over the character string having been already confirmed as being the entered character string on the television receiver and a risk of information terminal's misoperation of eliminating entry of a character string not having been confirmed yet as being the entered character string on the television receiver.

The system according to the present invention is preferably arranged such that the information terminal has a function of providing, to the television receiver, a notification of a character string having been entered in a text field which the information terminal displays on the touch panel thereof and having been confirmed as being an entered character string, and the television receiver has a function of switching a character string to be shown in the text field which the television receiver displays on the display thereof to another character string corresponding to the notification from the information terminal.

According to the above arrangement, it is possible to reduce a risk of television receiver's misoperation of entering other character string over the character string having been already confirmed as being the entered character string on the information terminal and a risk of television receiver's misoperation of eliminating entry of a character string not having been confirmed yet as being the entered character string on the information terminal.

The system according to the present invention is preferably arranged such that the command transmitting means has a function of transmitting a command instructing to perform a search, together with a search character string, and the state notifying means has a function of providing a notification that display of a search result has been completed, and the GUI switching means has a function of switching the GUI displayed on the touch panel to another GUI specialized for moving a cursor in the search result.

According to the above arrangement, it is possible to obviate the trouble of switching, when the search result is displayed on the television receiver, the GUI to be displayed on the touch panel of the information terminal to another GUI specialized for moving a cursor. In addition, since the GUI to be displayed on the touch panel of the information terminal is a GUI specialized for moving a cursor, it is possible to reduce a risk that the user may accidentally perform an operation which is not accepted by the television receiver in the situation where that search result is being displayed on the television receiver.

The system according to the present invention is preferably arranged such that the search is a seamless search in which a search for a content matching the search character string is made through a web content(s) stored in a web server, a VOD content(s) stored in a VOD server, a broadcast program(s) listed in the electronic program guide, and a recorded content(s) recorded on the television receiver or on a recorder connected with the television receiver.

According to the above arrangement, an entry of a single search character string is all that is required to carry out a global search through a web content(s), a VOD content(s), a broadcast content(s), and a recorded content(s).

The system according to the present invention is preferably arranged such that the state notifying means has a function of providing a notification of a friendly name having been set as a device name of the television receiver by a user, and the GUI switching means has a function of switching a device name to be displayed on a list, which is a GUI element for selecting a television receiver as a destination for the command, to another device name corresponding to the notification from the state notifying means.

According to the above arrangement, it is possible to let the user know, with use of an easy-to-understand friendly name, about which of the items in the list should be tapped to set which television receiver as the operation target device. This makes it possible to reduce a risk of an erroneous operation resulting from the impossibility of grasping such correspondence.

The system according to the present invention is preferably arranged such that the command transmitting means has a function of transmitting a command instructing to end reproduction of an image or the like, the state notifying means has a function of providing a notification that reproduction of the image or the like has been ended, and the GUI switching means switches the GUI to be displayed on the touch panel from a GUI specialized for reproducing an image or the like to another GUI having been displayed before the reproduction of the image or the like starts.

According to the above arrangement, it is possible to prevent a risk of an erroneous operation intended to reproduce the image or the like even though the reproduction of the image or the like has been ended. Note that the “image or the like” recited in the accompanying claims refers to a content such as a moving image, a still image, music, and video image.

The system according to the present invention is preferably arranged such that the command transmitting means transmits a command instructing to end reproduction of the image, in response to a drag-down operation performed with respect to a corresponding image displayed on the touch panel, the corresponding image being identical to the image being reproduced on the television receiver.

According to the above arrangement, it is possible to end the reproduction of the image on the television receiver, with an operation of dragging down the image on the touch panel, which operation looks as if the user pulls the image being reproduced on the television receiver toward the user. That is, it is possible to end the reproduction of the image on the television receiver, with an operation extremely intuitive for the user.

The system according to the present invention is preferably arranged such that the command transmitting means has a function of transmitting a command instructing to perform switching a reproduction target image to another, the state notifying means has a function of providing a notification that switching of the reproduction target image has been completed, and the GUI switching means switches an image to be displayed on the touch panel from a pre-switching reproduction target image to a post-switching reproduction target image.

According to the above arrangement, it is possible to ensure coincidence of the display target image displayed on the television receiver with the display target image displayed on the information terminal. This makes it possible to avoid the occurrence of an unintentional image switching resulting from an operation performed by the information terminal side.

The system according to the present invention is preferably arranged such that the command transmitting means transmits a command instructing to perform switching of the reproduction target image, in response to a flick operation performed with respect to the pre-switching reproduction target image displayed on the touch panel.

According to the above arrangement, it is possible to perform switching of an image to be reproduced on the television receiver, with a simple operation like a flick of the image.

It is preferable that the GUI switching means has a function of switching a state of a channel button corresponding to a channel having been notified from the state notifying means from a state in which a tap operation with respect to the channel button is enabled to a state in which a tap operation with respect to the channel button is disabled.

According to the above arrangement, it is possible to prevent an erroneous operation of re-selecting, a channel already being selected as a display target, as the display target.

The system according to the present invention is preferably arranged such that the television receiver further includes history information managing means configured to, in response to switching of a channel or a source device being selected on the television receiver, manage, a channel or a source device having been selected before the switching, as history information, the command transmitting means has a function of transmitting a command for obtaining the history information, the state notifying means has a function of, upon receipt of the command from the command transmitting means, providing a notification of the history information, and the GUI switching means has a function of switching history information to be displayed on the touch panel to another history information corresponding to the notification from the state notifying means.

According to the above arrangement, it is possible to let the user know, on the information terminal, about history information on which of the channels was previously selected on the television receiver or which of the input source(s) was previously selected on the television receiver. This makes it possible for the user to easily check, on the information terminal, the history information, while maintaining a screen which the user is currently viewing.

The system according to the present invention is preferably arranged such that the television receiver further comprises favorite channel managing means configured to manage favorite channel information indicative of a channel(s) having been set as a favorite channel(s) by a user, the command transmitting means has a function of transmitting a command for obtaining the favorite channel information, the state notifying means has a function of, upon receipt of the command from the command transmitting means, providing a notification of the favorite channel information, and the GUI switching means has a function of switching a list, which is a GUI element for selecting a viewing target channel from among channel(s) having been set as a favorite channel(s), to another list corresponding to the notification from the state notifying means.

According to the above arrangement, it is possible to ensure coincidence of the channel having been set as the favorite channel by the user on the television receiver with the channel displayed on the information terminal. This allows the user to easily switch a channel reproduced on the television receiver to a channel having been set as the favorite channel, with an operation performed on the information terminal side by the user.

The system according to the present invention is preferably arranged such that the GUI switching means has a function of switching the GUI to be displayed on the touch panel to another GUI for editing the favorite channel(s), the command transmitting means has a function of transmitting information indicative of a favorite channel(s) edited by the user, and the favorite channel managing means has a function of updating the favorite channel information, in response to a command having been transmitted from the command transmitting means.

According to the above arrangement, it is possible to set, on the information terminal, a favorite channel to be set for the television receiver. This allows the user to easily edit the favorite channel on the information terminal, while maintaining a screen which the user is currently viewing.

The system according to the present invention is preferably arranged such that the television receiver further comprises favorite application managing means configured to manage favorite application information indicative of an application(s) having been set as a favorite application(s) by the user, the command transmitting means has a function of transmitting a command for obtaining the favorite application information, the state notifying means has a function of, upon receipt of the command from the command transmitting means, providing a notification of the favorite application information, and the GUI switching means has a function of switching a list, which is a GUI element for selecting an available application from among an application(s) having been set as the favorite application(s), to another list corresponding to the notification from the state notifying means.

According to the above arrangement, it is possible to ensure coincidence of the application having been set as the favorite application by the user on the television receiver with the application displayed on the information terminal. This allows the user to easily switch an application to be executed on the television receiver to an application having been set as the favorite application, with an operation performed on the information terminal side by the user.

The system according to the present invention is preferably arranged such that the GUI switching means has a function of switching the GUI to be displayed on the touch panel to another GUI for editing the favorite application(s), the command transmitting means has a function of transmitting information indicative of a favorite application(s) having been edited by the user, and the favorite application managing means has a function of updating favorite application information in response to the command having been transmitted from the command transmitting means.

According to the above arrangement, it is possible to set, on the information terminal, a favorite application to be set for the television receiver. This allows the user to easily edit the favorite application on the information terminal, while maintaining a screen which the user is currently viewing.

The system according to the present invention is preferably arranged such that the state notifying means has a function of providing a notification of the list of an application(s) available on the television receiver, and the GUI switching means has a function of switching a list, which is a GUI element for selecting an application to be executed on the television receiver from among the available application(s), to another list corresponding to the notification from the state notifying means.

According to the above arrangement, it is possible to let the user know about which of items in the list should be tapped to select which of the applications. This makes it possible to reduce a risk of an erroneous operation resulting from the impossibility of grasping such correspondence.

The system according to the present invention is preferably arranged such that the state notifying means has a function of providing a notification of a list of data broadcast content available on the television receiver, and the GUI switching means has a function of switching a list, which is a GUI element for selecting a piece of data broadcast content to be displayed on the television receiver from among available pieces of data broadcast content, to another list corresponding to the notification from the state notifying means.

According to the above arrangement, it is possible to let the user know about which of items in the list should be tapped to select which of the data broadcast contents. This makes it possible to reduce a risk of an erroneous operation resulting from the impossibility of grasping such correspondence.

The present invention encompasses a television receiver (single unit) which is included in the system described above. The present invention also encompasses an information terminal (single unit) which is included in the system described above. Moreover, the present invention encompasses a program for operating such an information terminal and a storage medium having such a program stored thereon.

### INDUSTRIAL APPLICABILITY

The present invention is applicable to (i) an information terminal, such as a smartphone, which can operate a television receiver and (ii) a television which can be operated by an information terminal such as a smartphone. Note that the present invention has its applicability to not only the smartphone but also any information terminals, such as a tablet PC and an electronic book reader, having a touch panel provided therein.

### REFERENCE SIGNS LIST

1 Television
101 Tuner
102 Video decoder
103 Video processing section
104 LCD controller
105 LCD
106 Audio decoder
107 Sound processing section
108 Amplifier
109 Speaker
110 HDMI receiver
111 Power supply section
112 LAN interface
120 Control section
121 State controlling section
122 State notifying section
2 Smartphone (information terminal)
201 Touch panel
202 Touch panel controller
203 Speaker
204 Amplifier
205 Wireless LAN interface
206 Wireless LAN antenna
207 Microphone
208 ADC
209 3G interface
210 3G antenna
220 Control section
221 GUI display section
222 Command transmitting section

1.-39. (canceled)

40. A system comprising:
a television receiver; and
an information terminal,
the television receiver comprising:
state switching means configured to switch a state of the television receiver to another state corresponding to a command having been transmitted from the information terminal; and
state notifying means configured to provide, with the information terminal, one of (i) a notification of the state of the television receiver to which state the state switching means has switched over and (ii) an instruction to perform switching of a GUI (Graphical User Interface) to another GUI corresponding to the state of the television receiver to which state the state switching means has switched over,
the information terminal comprising:
command transmitting means configured to transmit, to the television receiver, a command corresponding to a user operation performed on the GUI, which is displayed on a touch panel provided in the information terminal; and
GUI switching means configured to switch the GUI to be displayed on the touch panel to one of (a) another GUI corresponding to a state of the television receiver which state has been notified from the television receiver and (b) another GUI corresponding to the instruction having been provided by the television receiver,
the state notifying means having a function of providing a notification of a broadcast station name being selected as a channel set,
the GUI switching means having a function of switching a broadcast station name to be displayed together with a corresponding button, which is a GUI element for designating a display target channel, to another broadcast station name corresponding to the notification from the state notifying means,
the state notifying means further having a function of providing a notification of a character string having been entered in a text field which the television receiver displays on a display thereof and having been confirmed as being an entered character string, and
the GUI switching means further having a function of switching a character string to be shown in a text field which the information terminal displays on the touch panel thereof to another character string corresponding to the notification from the state notifying means.

41. The system according to claim 40, wherein
the state notifying means has a function of providing a notification of a power status of the television receiver, and
the GUI switching means has a function of switching an indication color of an indicator provided on a toggle switch, which is a GUI element for switching the power status of the television receiver, to another indication color corresponding to the notification from the state notifying means.

42. The system according to claim 40, wherein
the state notifying means has a function of providing a notification of a volume level of the television receiver, and
the GUI switching means has a function of switching an indication position of a slider, which is a GUI element for performing switching of the volume level of the television receiver, to a position corresponding to the notification from the state notifying means.

43. The system according to claim 40, wherein
the state notifying means has a function of providing a notification that the television receiver is displaying an electronic program guide, and
the GUI switching means has a function of switching the GUI to be displayed on the touch panel to another GUI specialized for moving a cursor in the electronic program guide.

44. The system according to claim 40, wherein
the state notifying means has a function of providing a notification of a channel being selected as a display target channel, and
the GUI switching means has a function of switching a broadcast station name to be displayed together with a button, which is a GUI element for switching a display target channel up or down, to another broadcast station name corresponding to the notification from the state notifying means.

45. The system according to claim 40, wherein
the state notifying means has a function of providing a notification of a device name of a source device being connected to the television receiver, and
the GUI switching means has a function of switching a device name to be displayed on a list, which is a GUI element for selecting an input source, to another device name corresponding to the notification from the state notifying means.

46. The system according to claim 40, wherein
the state notifying means has a function of providing a notification of a source device being selected as an input source, and
the GUI switching means has a function of switching the GUI to be displayed on the touch panel to another GUI specialized for performing an operation of a source device having been notified from the state notifying means.

47. The system according to claim 40, wherein
the information terminal has a function of providing, to the television receiver, a notification of a character string having been entered in a text field which the information terminal displays on the touch panel thereof and having been confirmed as being an entered character string, and
the television receiver has a function of switching a character string to be shown in the text field which the television receiver displays on the display thereof to another character string corresponding to the notification from the information terminal.

48. The system according to claim 40, wherein
the command transmitting means has a function of transmitting a command instructing to perform a search, together with a search character string, and
the state notifying means has a function of providing a notification that display of a search result has been completed, and
the GUI switching means has a function of switching the GUI to be displayed on the touch panel to another GUI specialized for moving a cursor in the search result.

49. The system according to claim 48, wherein
the search is a seamless search in which a search for a content matching the search character string is made through a web content(s) stored in a web server, a VOD content(s) stored in a VOD server, a broadcast program(s) listed in the electronic program guide, and a recorded content(s) recorded on the television receiver or on a recorder connected with the television receiver.

50. The system according to claim 40, wherein
the state notifying means has a function of providing a notification of a friendly name having been set as a device name of the television receiver by a user, and
the GUI switching means has a function of switching a device name to be displayed on a list, which is a GUI element for selecting a television receiver as a destination for the command, to another device name corresponding to the notification from the state notifying means.

51. The system according to claim 40, wherein
the command transmitting means has a function of transmitting a command instructing to end reproduction of an image or the like,
the state notifying means has a function of providing a notification that reproduction of the image or the like has been ended, and
the GUI switching means switches the GUI to be displayed on the touch panel from a GUI specialized for reproducing an image or the like to another GUI having been displayed before the reproduction of the image or the like starts.

52. The system according to claim 51, wherein
the command transmitting means transmits a command instructing to end reproduction of the image, in response to a drag-down operation performed with respect to a corresponding image displayed on the touch panel, the corresponding image being identical to the image being reproduced on the television receiver.

53. The system according to claim 40, wherein
the command transmitting means has a function of transmitting a command instructing to perform switching a reproduction target image to another,
the GUI switching means has a function of providing a notification that switching of the reproduction target image has been completed, and
the GUI switching means switches an image to be displayed on the touch panel from a pre-switching reproduction target image to a post-switching reproduction target image.

54. The system according to claim 53, wherein
the command transmitting means transmits a command instructing to perform switching of the reproduction target image, in response to a leftward or rightward flick operation performed with respect to the pre-switching reproduction target image displayed on the touch panel.

55. The system according to claim 44, wherein
the GUI switching means has a function of switching a state of a channel button corresponding to a channel having been notified from the state notifying means from a state in which a tap operation with respect to the channel button is enabled to a state in which a tap operation with respect to the channel button is disabled.

56. The system according to claim 40, wherein
the television receiver further comprises history information managing means configured to, in response to switching of a channel or a source device being selected on the television receiver, manage, a channel or a source device having been selected before the switching, as history information,
the command transmitting means has a function of transmitting a command for obtaining the history information,
the state notifying means has a function of, upon receipt of the command from the command transmitting means, providing a notification of the history information, and
the GUI switching means has a function of switching history information to be displayed on the touch panel to another history information corresponding to the notification from the state notifying means.

57. The system according to claim 40, wherein
the television receiver further comprises favorite channel managing means configured to manage favorite channel information indicative of a channel(s) having been set as a favorite channel(s) by a user,
the command transmitting means has a function of transmitting a command for obtaining the favorite channel information,
the state notifying means has a function of, upon receipt of the command from the command transmitting means, providing a notification of the favorite channel information, and
the GUI switching means has a function of switching a list, which is a GUI element for selecting a viewing target channel from among channel(s) having been set as a favorite channel(s), to another list corresponding to the notification from the state notifying means.

58. The system according to claim 57, wherein
the GUI switching means has a function of switching the GUI to be displayed on the touch panel to another GUI for editing the favorite channel(s),
the command transmitting means has a function of transmitting information indicative of a favorite channel(s) edited by the user, and
the favorite channel managing means has a function of updating the favorite channel information, in response to a command having been transmitted from the command transmitting means.

59. The system according to claim 40, wherein
the television receiver further comprises favorite application managing means configured to manage favorite application information indicative of an application(s) having been set as a favorite application(s) by the user,
the command transmitting means has a function of transmitting a command for obtaining the favorite application information,
the state notifying means has a function of, upon receipt of the command from the command transmitting means, providing a notification of the favorite application information, and
the GUI switching means has a function of switching a list, which is a GUI element for selecting an available application from among an application(s) having been set as the favorite application(s), to another list corresponding to the notification from the state notifying means.

60. The system according to claim 59, wherein
the GUI switching means has a function of switching the GUI to be displayed on the touch panel to another GUI for editing the favorite application(s),
the command transmitting means has a function of transmitting information indicative of a favorite application(s) having been edited by the user, and
the favorite application managing means has a function of updating favorite application information in response to the command having been transmitted from the command transmitting means.

61. The system according to claim 40, wherein
the state notifying means has a function of providing a notification of the list of an application(s) available on the television receiver, and
the GUI switching means has a function of switching a list, which is a GUI element for selecting an application to be executed on the television receiver from among the available application(s), to another list corresponding to the notification from the state notifying means.

62. The system according to claim 40, wherein
the state notifying means has a function of providing a notification of a list of data broadcast content available on the television receiver, and
the GUI switching means has a function of switching a list, which is a GUI element for selecting a piece of data broadcast content to be displayed on the television receiver from among available pieces of data broadcast content, to another list corresponding to the notification from the state notifying means.

63. A television receiver comprising:
state switching means configured to switch a state of the television receiver to another state corresponding to a command having been transmitted from an information terminal; and
state notifying means configured to provide, with the information terminal, one of (i) a notification of the state of the television receiver to which state the state switching means has switched over and (ii) an instruction to perform switching of a GUI (Graphical User Interface) to another GUI corresponding to the state of the television receiver to which state the state switching means has switched over,
the state notifying means having a function of providing a notification of a broadcast station name being selected as a channel set, and
the state notifying means further having a function of providing a notification of a character string having been entered in a text field which the television receiver displays on a display thereof and having been confirmed as being an entered character string.

64. An information terminal comprising:
command transmitting means configured to transmit, to a television receiver, a command corresponding to a user operation performed on a GUI (Graphical User Interface), which is displayed on a touch panel provided in the information terminal; and
GUI switching means configured to switch the GUI to be displayed on the touch panel to one of (a) another GUI corresponding to a state of the television receiver which state has been notified from the television receiver and (b) another GUI corresponding to an instruction having been provided by the television receiver,
the GUI switching means having a function of switching a broadcast station name to be displayed together with a corresponding button, which is a GUI element for designating a display target channel, to another broadcast station name corresponding to the notification from the television receiver, and
the GUI switching means further having a function of switching a character string to be shown in a text field which the information terminal displays on the touch panel thereof to another character string corresponding to the notification from the television receiver.

65. A non-transitory computer-readable storage medium having a program for operating an information terminal according to claim 64 stored therein, the program causing a computer included in the information terminal to function as foregoing means of the information terminal.
